(19) United States
(12) Patent Application Publication
(10) Pub. No.: US 2024/0147544 A1
(43) Pub. Date: May 2, 2024

(54) NR AIR-TO-GROUND SIGNALING ENHANCEMENT FOR INITIAL ACCESS WITH MULTIPLE NUMEROLOGIES OR WAVEFORMS

(71) Applicant: QUALCOMM Incorporated, San Diego, CA (US)

(72) Inventors: Qiaoyu LI, Beijing (CN); Yu ZHANG, San Diego, CA (US); Chao WEI, Beijing (CN); Hao XU, Beijing (CN)

(21) Appl. No.: 18/547,988

(22) PCT Filed: May 28, 2021
(86) PCT No.: PCT/CN2021/096661

§ 371 Date: Aug. 25, 2023

(51) Int. Cl. H04W 74/0833; H04W 74/00

(52) U.S. Cl. CPC H04W 74/0833; H04W 74/006

(57) ABSTRACT

Various aspects of the present disclosure generally relate to wireless communication. In some aspects, a user equipment (UE) may receive a synchronization signal block (SSB) associated with a first numerology. The UE may receive, from a base station and based at least in part on the SSB associated with the first numerology, information identifying time domain and frequency domain locations of one or more SSBs associated with a second numerology. Numerous other aspects are described.

### FIELD OF THE DISCLOSURE

Aspects of the present disclosure generally relate to wireless communication and to techniques and apparatuses for air-to-ground (ATG) signaling enhancement for initial access with multiple numerologies or waveforms.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a user equipment (UE) for wireless communication includes a memory; and one or more processors, coupled to the memory, configured to: receive a synchronization signal block (SSB) associated with a first numerology; receive, from a base station and based at least in part on the SSB, system information transmitted using the first numerology; and transmit, to the base station, an indication of a second numerology that is a preferred numerology for the UE.

In some aspects, a UE for wireless communication includes a memory; and one or more processors, coupled to the memory, configured to: receive an SSB associated with a first numerology; receive, from a base station and based at least in part on the SSB, system information transmitted using the first numerology; and transmit, to the base station, an indication of a second numerology that is a preferred numerology for the UE.

In some aspects, a method of wireless communication performed by a UE includes receiving an SSB associated with a first numerology; and receiving, from a base station and based at least in part on the SSB associated with the first numerology, information identifying time domain and frequency domain locations of one or more SSBs associated with a second numerology.

In some aspects, a method of wireless communication performed by a UE includes receiving an SSB associated with a first numerology; receiving, from a base station and based at least in part on the SSB, system information transmitted using the first numerology; and transmitting, to the base station, an indication of a second numerology that is a preferred numerology for the UE.

In some aspects, a non-transitory computer-readable medium storing a set of instructions for wireless communication includes one or more instructions that, when executed by one or more processors of a UE, cause the UE to: receive an SSB associated with a first numerology; and receive, from a base station and based at least in part on the SSB associated with the first numerology, information identifying time domain and frequency domain locations of one or more SSBs associated with a second numerology.

In some aspects, a non-transitory computer-readable medium storing a set of instructions for wireless communication includes one or more instructions that, when executed by one or more processors of an UE, cause the UE to: receive an SSB associated with a first numerology; receive, from a base station and based at least in part on the SSB, system information transmitted using the first numerology; and transmit, to the base station, an indication of a second numerology that is a preferred numerology for the UE.

In some aspects, an apparatus for wireless communication includes means for receiving an SSB associated with a first numerology; and means for receiving, from a base station and based at least in part on the SSB associated with the first numerology, information identifying time domain and frequency domain locations of one or more SSBs associated with a second numerology.

In some aspects, an apparatus for wireless communication includes means for receiving an SSB associated with a first numerology; means for receiving, from a base station and based at least in part on the SSB, system information transmitted using the first numerology; and means for transmitting, to the base station, an indication of a second numerology that is a preferred numerology for the UE.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, radio frequency (RF) chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of an air-to-ground (ATG) network, in accordance with the present disclosure.

FIG. 4 is a diagram illustrating an example of numerologies for orthogonal frequency division multiplexing (OFDM) based communications, in accordance with the present disclosure.

FIGS. 5-6 are diagrams illustrating examples associated with ATG signaling enhancement for initial access with multiple numerologies, in accordance with the present disclosure.

FIGS. 7-8 are diagrams illustrating examples associated with ATG signaling enhancement for initial access with multiple waveforms, in accordance with the present disclosure.

FIG. 9 is a diagram illustrating an example associated with ATG signaling enhancement for initial access with multiple numerologies, in accordance with the present disclosure.

FIG. 10 is a diagram illustrating an example associated with ATG signaling enhancement for initial access with multiple waveforms, in accordance with the present disclosure.

FIG. 11 is a diagram illustrating an example associated with ATG signaling enhancement for initial access with multiple numerologies, in accordance with the present disclosure.

FIG. 12 is a diagram illustrating an example associated with ATG signaling enhancement for initial access with multiple waveforms, in accordance with the present disclosure.

FIGS. 13-18 are diagrams illustrating example processes associated with ATG signaling enhancement for initial access with multiple numerologies, in accordance with the present disclosure.

FIGS. 19-24 are diagrams illustrating example processes associated with ATG signaling enhancement for initial access with multiple waveforms, in accordance with the present disclosure.

FIGS. 25-26 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

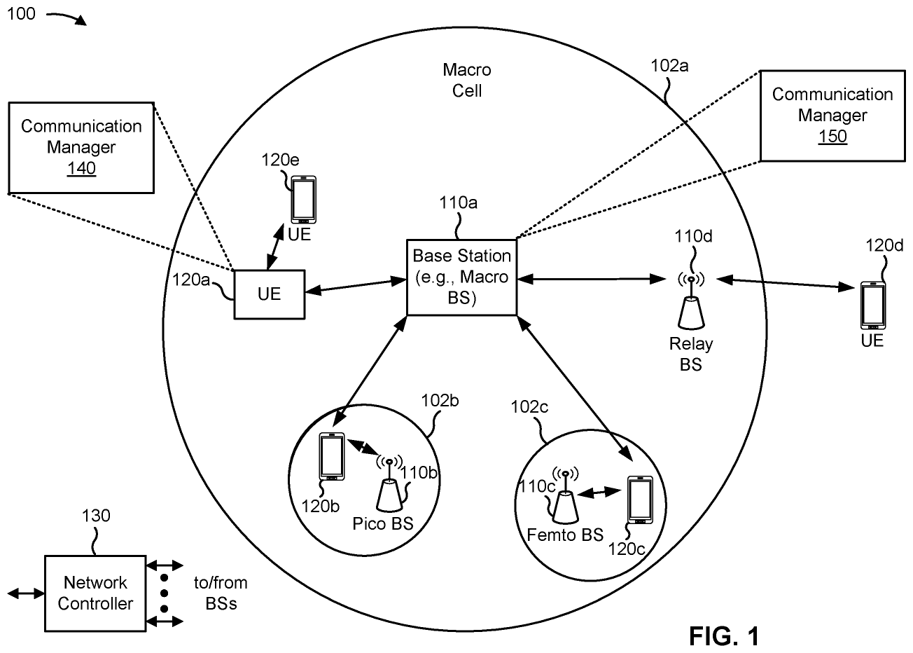

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In some aspects, some UEs may be air-to-ground (ATG) UEs. An ATG UE is an onboard terminal on an aircraft that communicates with a ground-based ATG base station. Such an ATG UE may also be referred to as an “ATG terminal.” In some aspects, an ATG UE may be considered a CPE for an aircraft and may provide network connectivity (e.g., via Wi-Fi or a small cell network) to other UEs on the aircraft, such as UEs belonging to passengers of the aircraft. In some aspects, some base stations may be ATG base stations. An ATG base station is a base station (e.g., an NR gNB) that performs ATG communications with an ATG UE.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

In some aspects, the UE 120 may include a communication manager 140. As described in more detail elsewhere herein, the communication manager 140 may receive a synchronization signal block (SSB) associated with a first numerology; and receive, from a base station and based at least in part on the SSB associated with the first numerology, information identifying time domain and frequency domain locations of one or more SSBs associated with a second numerology. Additionally, or alternatively, the communication manager 140 may perform one or more other operations described herein.

In some aspects, as described in more detail elsewhere herein, the communication manager 140 may receive an SSB associated with a first numerology; receive, from a base station and based at least in part on the SSB, system information transmitted using the first numerology; and transmit, to the base station, an indication of a second numerology that is a preferred numerology for the UE. Additionally, or alternatively, the communication manager 140 may perform one or more other operations described herein.

In some aspects, as described in more detail elsewhere herein, the communication manager 140 may receive an SSB; receive, from a base station and based at least in part on the SSB, information identifying type 0 control resource sets (CORESET #0s) and/or type 0 search spaces associated with different numerologies; and receive, from the base station, a type 0 physical downlink control channel (PDCCH) communication in a selected CORESET #0 and/or type 0 search space from the multiple CORESET #0s and/or type 0 search spaces, wherein the selected CORESET #0 and/or type 0 search space is associated with a selected numerology for the UE. Additionally, or alternatively, the communication manager 140 may perform one or more other operations described herein.

In some aspects, as described in more detail elsewhere herein, the communication manager 140 may receive an SSB associated with a first waveform; and receive, from a base station and based at least in part on the SSB associated with the first waveform, information identifying time domain and frequency domain locations of one or more SSBs associated with a second waveform. Additionally, or alternatively, the communication manager 140 may perform one or more other operations described herein.

In some aspects, as described in more detail elsewhere herein, the communication manager 140 may receive an SSB associated with a first waveform; receive, from a base station and based at least in part on the SSB, system information transmitted using the first waveform; and transmit, to the base station, an indication of a second waveform that is a preferred waveform for the UE. Additionally, or alternatively, the communication manager 140 may perform one or more other operations described herein.

In some aspects, as described in more detail elsewhere herein, the communication manager 140 may receive an SSB; receive, from a base station and based at least in part on the SSB, information identifying multiple CORESET #0s and/or type 0 search spaces associated with different waveforms; and receive, from the base station, a type 0 PDCCH communication in a selected CORESET #0 and/or type 0 search space from the multiple CORESET #0s and/or type 0 search spaces, wherein the selected CORESET #0 and/or type 0 search space is associated with a selected waveform for the UE. Additionally, or alternatively, the communication manager 140 may perform one or more other operations described herein.

In some aspects, the base station 110 may include a communication manager 150. As described in more detail elsewhere herein, the communication manager 150 may transmit first SSBs associated with a first numerology and second SSBs associated with a second numerology; and transmit information associated with the first SSBs that identifies time domain and frequency domain locations of one or more of the second SSBs. Additionally, or alternatively, the communication manager 150 may perform one or more other operations described herein.

In some aspects, as described in more detail elsewhere herein, the communication manager 150 may transmit an SSB associated with a first numerology; transmit system information using the first numerology; and receive, from a UE, an indication of a second numerology that is a preferred numerology for the UE. Additionally, or alternatively, the communication manager 150 may perform one or more other operations described herein.

In some aspects, as described in more detail elsewhere herein, the communication manager 150 may transmit an SSB; transmit information associated with the SSB that identifies multiple CORESET #0s and/or type 0 search spaces associated with different numerologies; and transmit, in each CORESET #0 and/or type 0 search space of the multiple CORESET #0s and/or type 0 search spaces, a respective type 0 PDCCH communication that schedules transmission of system information based at least in part on a numerology associated with that CORESET #0 and/or type 0 search space. Additionally, or alternatively, the communication manager 150 may perform one or more other operations described herein.

In some aspects, as described in more detail elsewhere herein, the communication manager 150 may transmit first SSBs associated with a first waveform and second SSBs associated with a second waveform; and transmit information associated with the first SSBs that identifies time domain and frequency domain locations of one or more of the second SSBs. Additionally, or alternatively, the communication manager 150 may perform one or more other operations described herein.

In some aspects, as described in more detail elsewhere herein, the communication manager 150 may transmit an SSB associated with a first waveform; transmit system information using the first waveform; and receive, from a UE, an indication of a second waveform that is a preferred waveform for the UE. Additionally, or alternatively, the communication manager 150 may perform one or more other operations described herein.

In some aspects, as described in more detail elsewhere herein, the communication manager 150 may transmit an SSB; transmit information associated with the SSB that identifies multiple CORESET #0s and/or type 0 search spaces associated with different waveforms; and transmit, in each CORESET #0 and/or type 0 search space of the multiple CORESET #0s and/or type 0 search spaces, a respective type 0 PDCCH communication that schedules transmission of system information based at least in part on a waveform associated with that CORESET #0 and/or type 0 search space. Additionally, or alternatively, the communication manager 150 may perform one or more other operations described herein.

As indicated above, FIG. 1 is provided as an example. Other examples may differ from what is described with regard to FIG. 1.

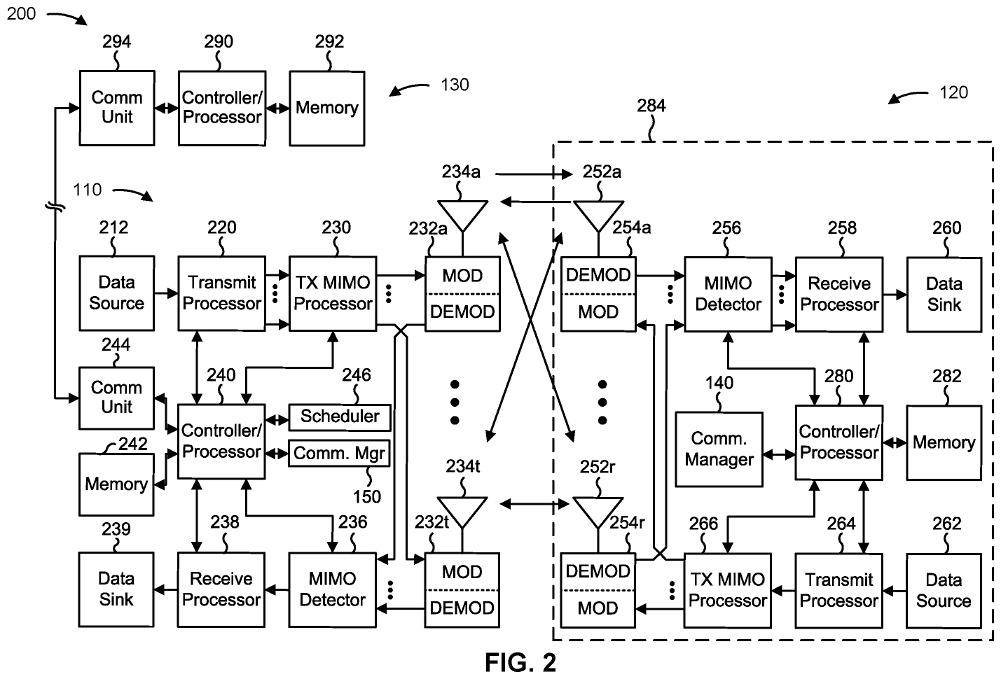

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to Tmodulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

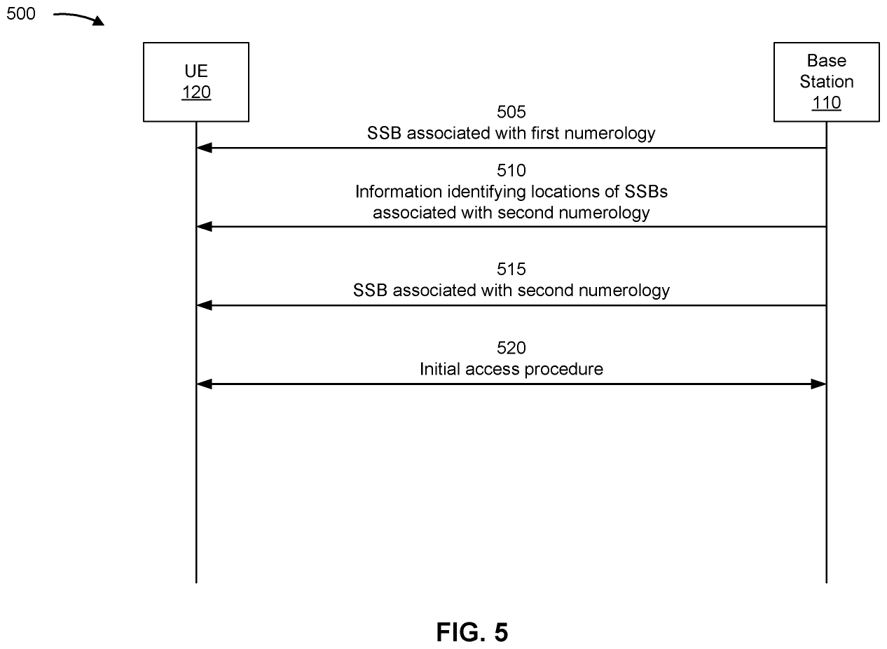

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 5-24.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 5-24.

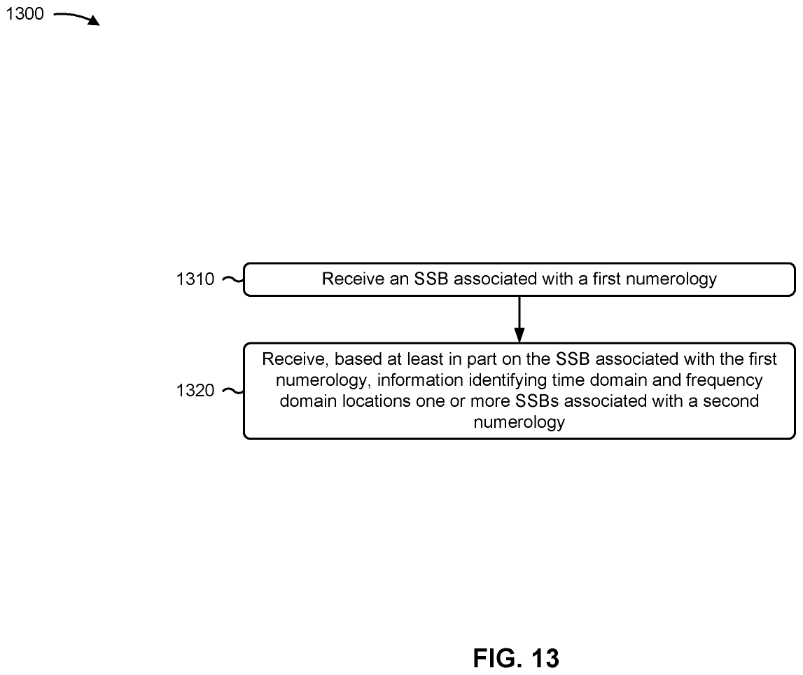

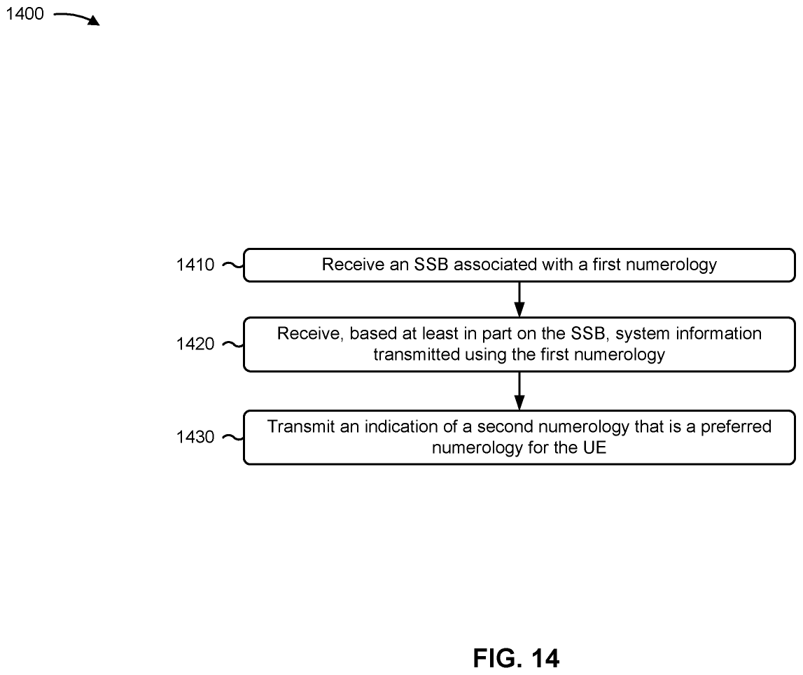

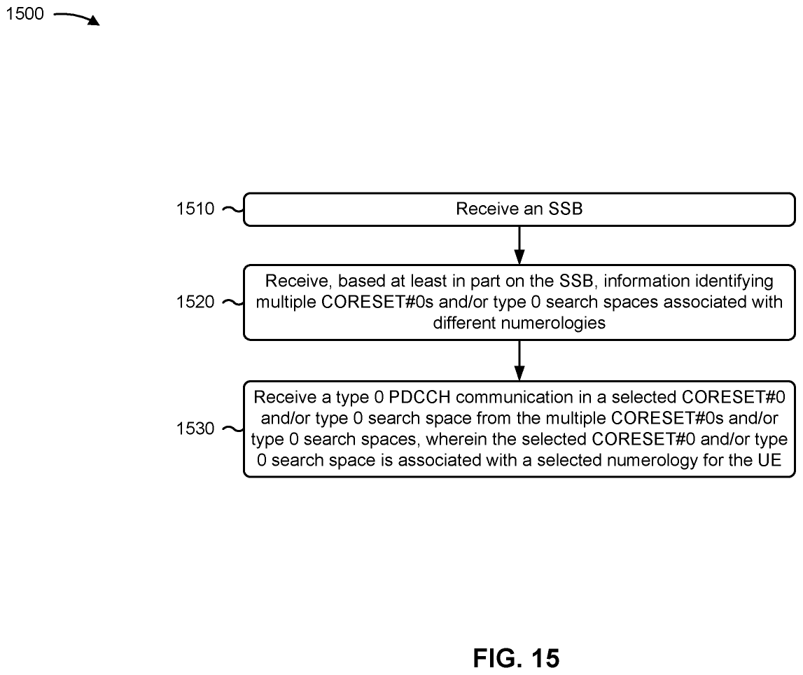

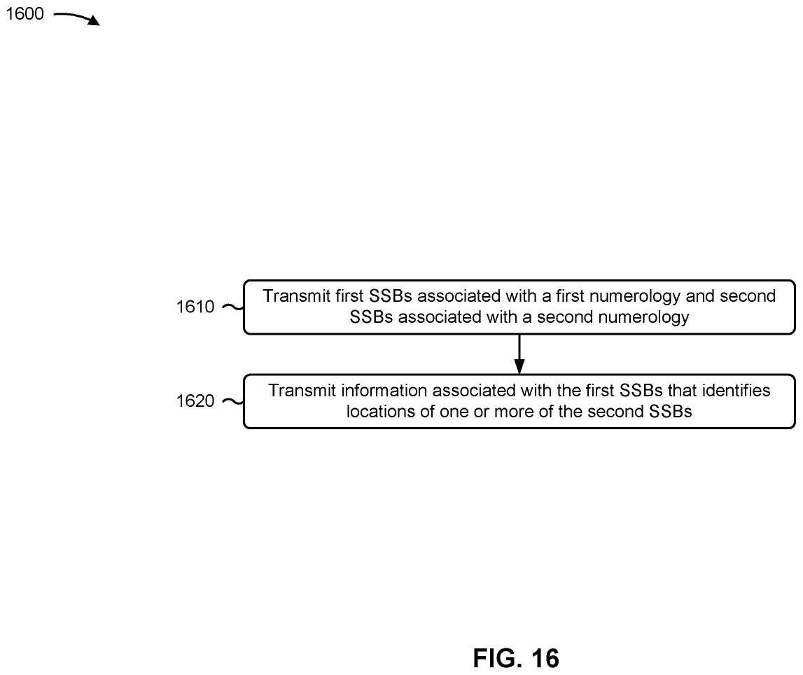

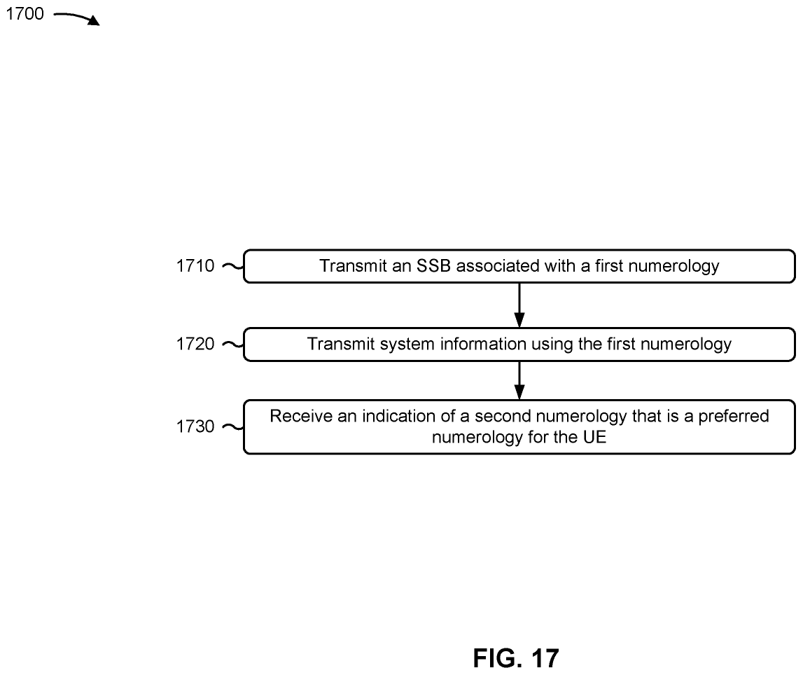

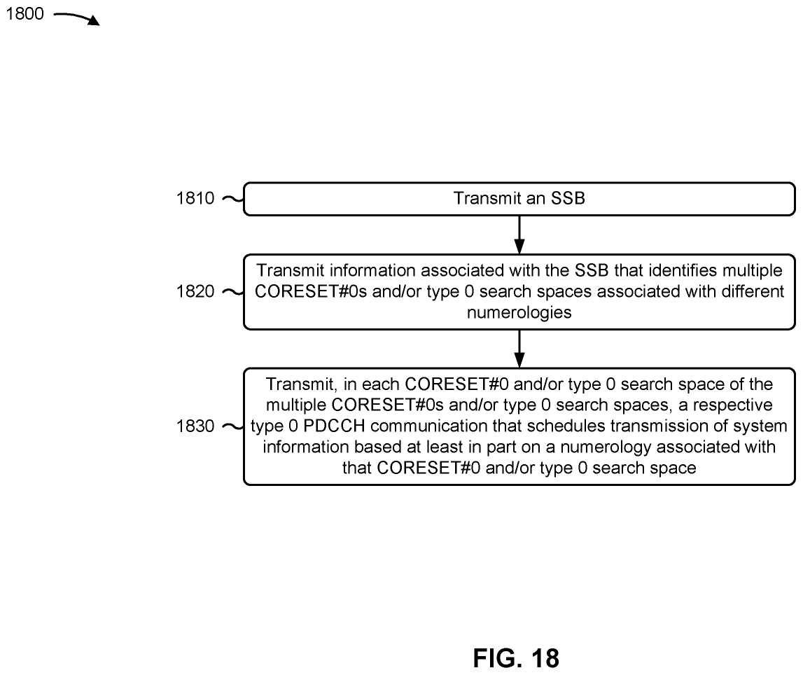

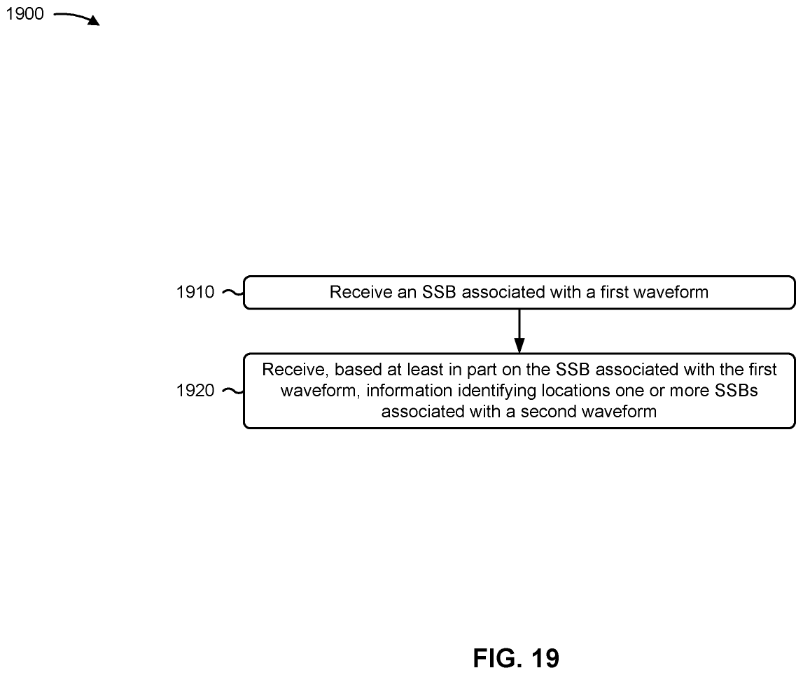

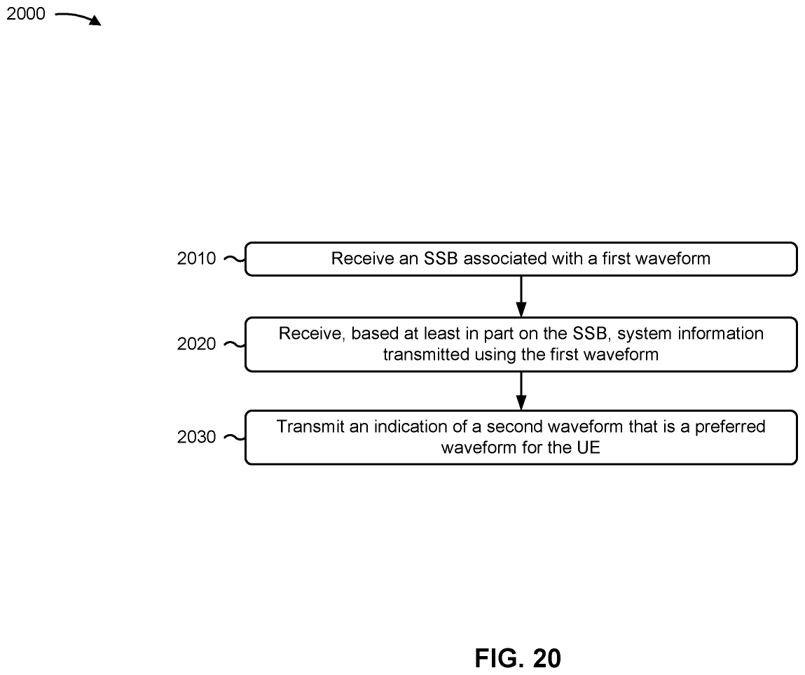

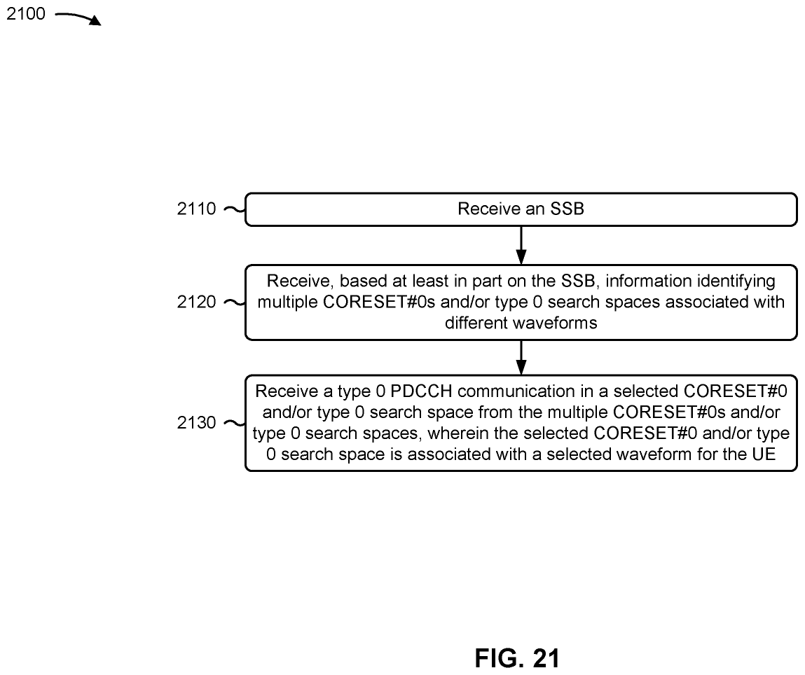

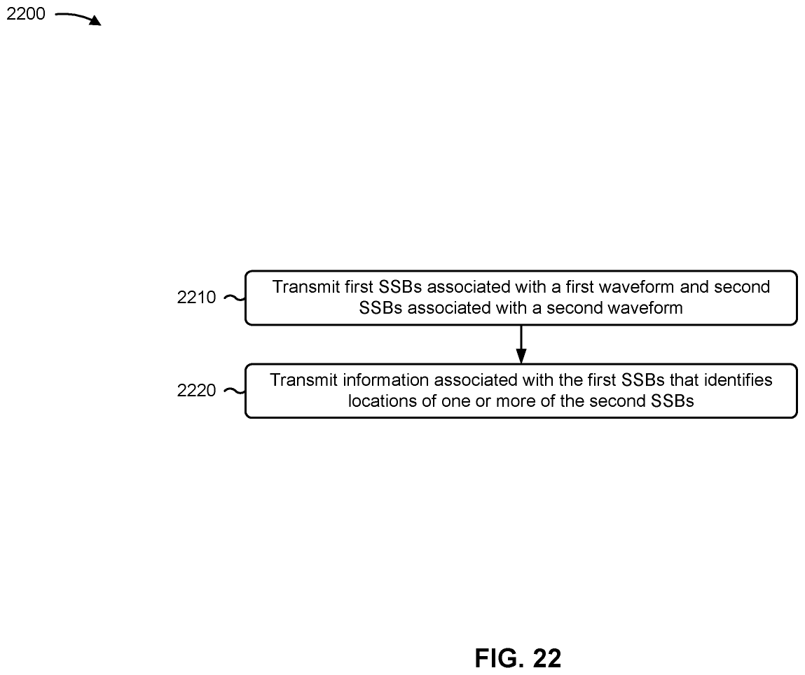

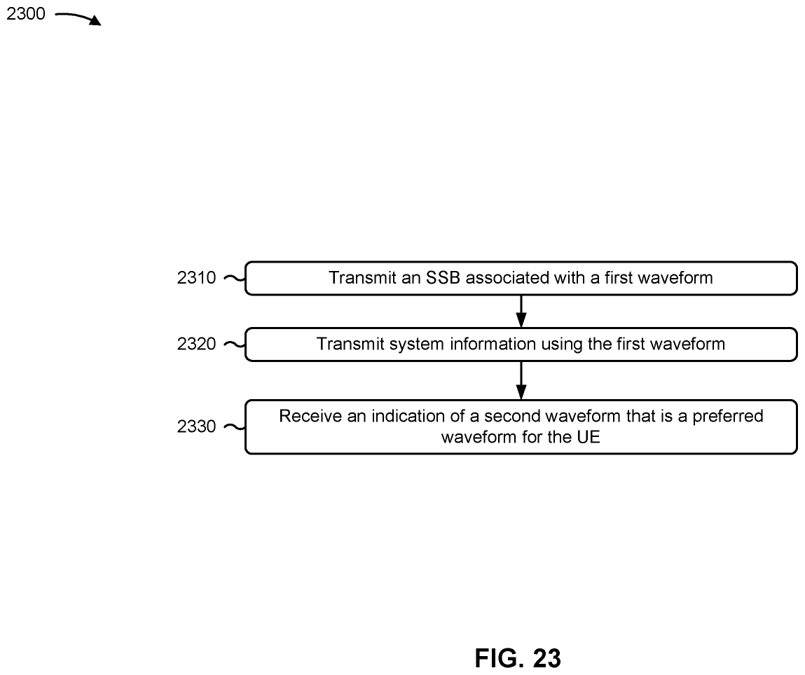

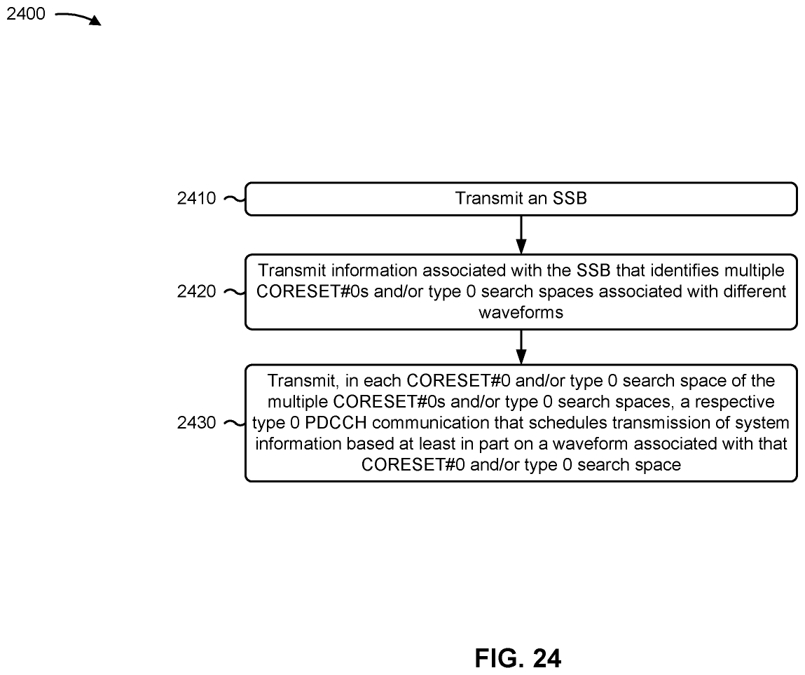

Controller/processor 240 of base station 110, controller/processor 280 of UE 120, and/or any other component(s) of FIG. 2 may perform one or more techniques associated with ATG signaling enhancement for initial access with multiple numerologies or waveforms, as described in more detail elsewhere herein. For example, controller/processor 240 of base station 110, controller/processor 280 of UE 120, and/or any other component(s) of FIG. 2 may perform or direct operations of, for example, process 1300 of FIG. 13, process 1400 of FIG. 14, process 1500 of FIG. 15, process 1600 of FIG. 16, process 1700 of FIG. 17, process 1800 of FIG. 18, process 1900 of FIG. 19, process 2000 of FIG. 20, process 2100 of FIG. 21, process 2200 of FIG. 22, process 2300 of FIG. 23, process 2400 of FIG. 24, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1300 of FIG. 13, process 1400 of FIG. 14, process 1500 of FIG. 15, process 1600 of FIG. 16, process 1700 of FIG. 17, process 1800 of FIG. 18, process 1900 of FIG. 19, process 2000 of FIG. 20, process 2100 of FIG. 21, process 2200 of FIG. 22, process 2300 of FIG. 23, process 2400 of FIG. 24, and/or other processes as described herein. In some aspects, executing instructions may include running the instructions, converting the instructions, compiling the instructions, and/or interpreting the instructions, among other examples.

In some aspects, the UE 120 includes means for receiving an SSB associated with a first numerology; and/or means for receiving, from a base station and based at least in part on the SSB associated with the first numerology, information identifying time domain and frequency domain locations of one or more SSBs associated with a second numerology. The means for the UE 120 to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

In some aspects, the UE 120 includes means for receiving an SSB associated with a first numerology; means for receiving, from a base station and based at least in part on the SSB, system information transmitted using the first numerology; and/or means for transmitting, to the base station, an indication of a second numerology that is a preferred numerology for the UE. The means for the UE 120 to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

In some aspects, the UE 120 includes means for receiving an SSB; means for receiving, from a base station and based at least in part on the SSB, information identifying multiple CORESET #0s and/or type 0 search spaces associated with different numerologies; and/or means for receiving, from the base station, a type 0 PDCCH communication in a selected CORESET #0 and/or type 0 search space from the multiple CORESET #0s and/or type 0 search spaces, wherein the selected CORESET #0 and/or type 0 search space is associated with a selected numerology for the UE. The means for the UE 120 to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

In some aspects, the UE 120 includes means for receiving an SSB associated with a first waveform; and/or means for receiving, from a base station and based at least in part on the SSB associated with the first waveform, information identifying time domain and frequency domain locations of one or more SSBs associated with a second waveform. The means for the UE 120 to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

In some aspects, the UE 120 includes means for receiving an SSB associated with a first waveform; means for receiving, from a base station and based at least in part on the SSB, system information transmitted using the first waveform; and/or means for transmitting, to the base station, an indication of a second waveform that is a preferred waveform for the UE. The means for the UE 120 to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

In some aspects, the UE 120 includes means for receiving an SSB; means for receiving, from a base station and based at least in part on the SSB, information identifying multiple CORESET #0s and/or type 0 search spaces associated with different waveforms; and/or means for receiving, from the base station, a type 0 PDCCH communication in a selected CORESET #0 and/or type 0 search space from the multiple CORESET #0s and/or type 0 search spaces, wherein the selected CORESET #0 and/or type 0 search space is associated with a selected waveform for the UE. The means for the UE 120 to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

In some aspects, the base station 110 includes means for transmitting first SSBs associated with a first numerology and second SSBs associated with a second numerology; and/or means for transmitting information associated with the first SSBs that identifies time domain and frequency domain locations of one or more of the second SSBs. The means for the base station 110 to perform operations described herein may include, for example, one or more of communication manager 150, transmit processor 220, TX MIMO processor 230, modulator 232, antenna 234, demodulator 232, MIMO detector 236, receive processor 238, controller/processor 240, memory 242, or scheduler 246.

In some aspects, the base station 110 includes means for transmitting an SSB associated with a first numerology; means for transmitting system information using the first numerology; and/or means for receiving, from a UE, an indication of a second numerology that is a preferred numerology for the UE. The means for the base station 110 to perform operations described herein may include, for example, one or more of communication manager 150, transmit processor 220, TX MIMO processor 230, modulator 232, antenna 234, demodulator 232, MIMO detector 236, receive processor 238, controller/processor 240, memory 242, or scheduler 246.

In some aspects, the base station 110 includes means for transmitting an SSB; means for transmitting information associated with the SSB that identifies multiple CORESET #0s and/or type 0 search spaces associated with different numerologies; and/or means for transmitting, in each CORESET #0 and/or type 0 search space of the multiple CORESET #0s and/or type 0 search spaces, a respective type 0 PDCCH communication that schedules transmission of system information based at least in part on a numerology associated with that CORESET #0 and/or type 0 search space. The means for the base station 110 to perform operations described herein may include, for example, one or more of communication manager 150, transmit processor 220, TX MIMO processor 230, modulator 232, antenna 234, demodulator 232, MIMO detector 236, receive processor 238, controller/processor 240, memory 242, or scheduler 246.

In some aspects, the base station 110 includes means for transmitting first SSBs associated with a first waveform and second SSBs associated with a second waveform; and/or means for transmitting information associated with the first SSBs that identifies time domain and frequency domain locations of one or more of the second SSBs. The means for the base station 110 to perform operations described herein may include, for example, one or more of communication manager 150, transmit processor 220, TX MIMO processor 230, modulator 232, antenna 234, demodulator 232, MIMO detector 236, receive processor 238, controller/processor 240, memory 242, or scheduler 246.

In some aspects, the base station 110 includes means for transmitting an SSB associated with a first waveform; means for transmitting system information using the first waveform; and/or means for receiving, from a UE, an indication of a second waveform that is a preferred waveform for the UE. The means for the base station 110 to perform operations described herein may include, for example, one or more of communication manager 150, transmit processor 220, TX MIMO processor 230, modulator 232, antenna 234, demodulator 232, MIMO detector 236, receive processor 238, controller/processor 240, memory 242, or scheduler 246.

In some aspects, the base station 110 includes means for transmitting an SSB; means for transmitting information associated with the SSB that identifies multiple CORESET #0s and/or type 0 search spaces associated with different waveforms; and/or means for transmitting, in each CORESET #0 and/or type 0 search space of the multiple CORESET #0s and/or type 0 search spaces, a respective type 0 PDCCH communication that schedules transmission of system information based at least in part on a waveform associated with that CORESET #0 and/or type 0 search space. The means for the base station 110 to perform operations described herein may include, for example, one or more of communication manager 150, transmit processor 220, TX MIMO processor 230, modulator 232, antenna 234, demodulator 232, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

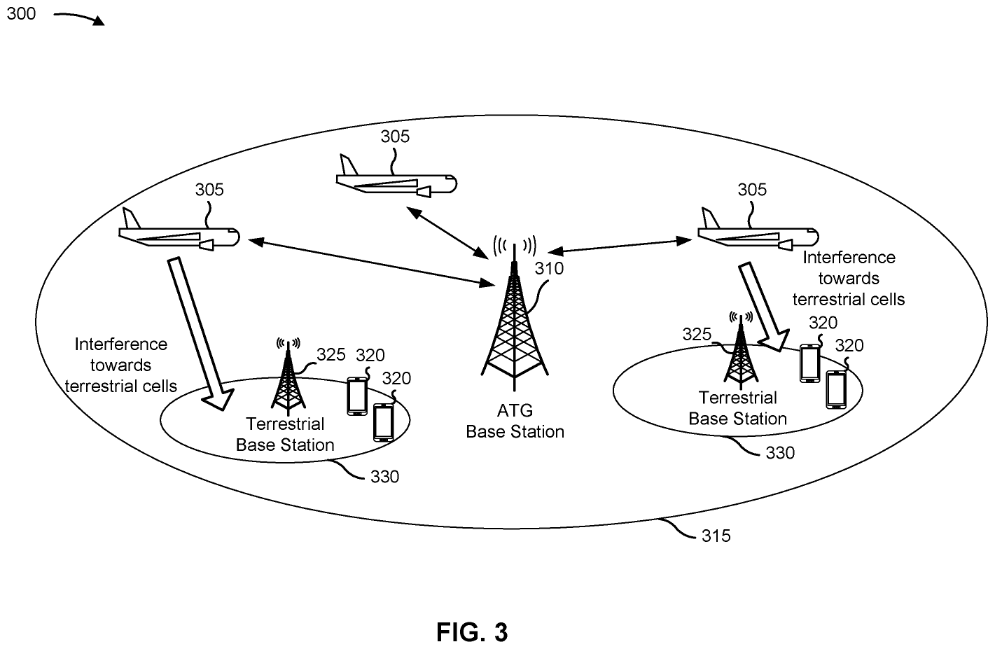

FIG. 3 is a diagram illustrating an example 300 of an ATG network, in accordance with the present disclosure. In some aspects, the ATG network may be a 5G/NR network.

As shown in FIG. 3, the ATG network may include one or more ATG UEs 305 and an ATG base station 310. The ATG UE 305 may be, may include, or may be included in an onboard terminal and/or CPE on an aircraft. The ATG UE 305 may include components of UE 120 described elsewhere herein. The ATG base station 310 may be a ground-based base station (e.g., a 5G/NR gNB) that transmits signals to and receives signals from the ATG UEs 305. The ATG base station 310 may include components of base station 110 described elsewhere herein. In some aspects, the ATG UE 305 may communicate with the ATG base station 310 to provide network connectivity (e.g., via Wi-Fi or a small cell network) to other UEs on the aircraft, such as UEs belonging to passengers of the aircraft.

In some aspects, a cell 315 associated with the ATG base station may have an extremely large coverage range, such as up to 300 km. In some cases, the ATG UEs 305 and ATG base station 310, in the ATG network, may communicate using a same frequency band as terrestrial UEs 320 and terrestrial base stations 325 in terrestrial networks. As used herein, “terrestrial UE” may refer to any UE that is not an ATG UE, and “terrestrial base station” may refer to any base station that is not an ATG base station. In some aspects, an ATG UE 305 may be more powerful than a terrestrial UE 320. For example, the ATG UE 305 may transmit with a higher effective isotropic radiated power (EIRP), via a larger transmission power and/or a larger on-board antenna gain, as compared with the terrestrial UE 320.

ATG channel power delay profile (PDP) and Doppler measurements may be significantly higher than such measurements in a terrestrial network. In some cases, due to such large ATG channel PDP and Doppler measurements, the ATG UEs 305 and the ATG base station 310 may use different numerologies for OFDM communications, as compared to terrestrial networks. “Numerology” for OFDM refers to a configuration of waveform parameters, such as subcarrier spacing (SCS), OFDM symbol duration, cyclic prefix (CP), total symbol duration, and/or number of OFDM symbols per slot. Different numerologies may correspond to different sets of configured OFDM waveform parameters.

The PDP for an ATG UE 305 may vary due to a flight stage (e.g., en route cruise, climb and descent, or takeoff and landing), terrain (e.g., mountains), or the presence of other obstacles (e.g., buildings) that may affect line of sight (LoS) between the ATG UE 305 and the ATG base station 310. For example, mountains may cause a large multipath delay for an ATG UE 305. In some examples, a distinctive delay for an ATG UE 305 may approach 2.5 km (or 8.33 μs). In some aspects, for OFDM communications, a numerology with a CP that is greater than the delay may be used to avoid inter-symbol interference. Doppler measurements may be based at least in part on a speed of the aircraft. In some examples, an aircraft including an ATG UE 305 may travel at speeds up to 1200 km/hour. In some aspects, a numerology with a large SCS may be used to compensate for large a Doppler spread (e.g., due to multipath Doppler measurements) for an ATG UE 305.

In cases in which an ATG network and a terrestrial network co-exist, a possible way to multiplex ATG communications and terrestrial network communications is using frequency division multiplexing (FDM). However, multiplexing ATG communications and terrestrial network communications using FDM may suffer from spectral inefficiency. Another more spectral-efficient way to multiplex ATG communications and terrestrial network communications is to allow non-orthogonal use of radio frequencies among ATG communications and terrestrial network communications. However, as shown in FIG. 3, interference from ATG UEs 305 toward terrestrial cells 330 may adversely affect communications between terrestrial UEs 320 and terrestrial base stations 325. In time division duplexing (TDD), the ATG UE 305 may cause interference to uplink reception by the terrestrial base station 325 and/or interference to downlink reception by the terrestrial UEs 320. In frequency division duplexing (FDD), the ATG UE 305 may cause interference to uplink reception by the terrestrial base station 325, or, in a case in which the uplink and downlink frequency bands are used in reverse for ATG communications, may cause interference to downlink reception by the terrestrial UEs 320. Such interference, from the ATG UEs 305, may not be synchronized to the communications in the terrestrial cells 330. For example, interference from different space division multiplexed ATG UEs 305 may be asynchronized due to different propagation delays. Furthermore, the ATG communications may use different numerologies or waveforms from the terrestrial network communications.

As indicated above, FIG. 3 is provided as an example. Other examples may differ from what is described with respect to FIG. 3.

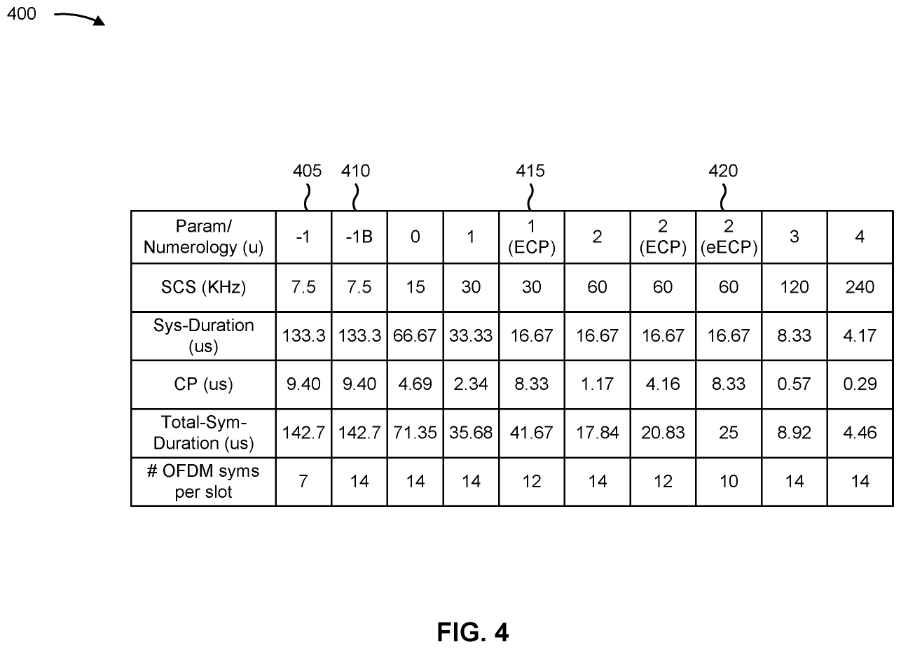

FIG. 4 is a diagram illustrating an example 400 of numerologies for orthogonal OFDM-based communications, in accordance with the present disclosure.

As shown in FIG. 4, each numerology may correspond to a respective set of OFDM waveform parameters, and each numerology may be identified using a respective numerology parameter (u). As described above, in some aspects, ATG communications may use different numerologies than terrestrial network communications. As shown in FIG. 4, reference numbers 405, 410, 415, and 420 show example numerologies configured for ATG communications. In some aspects, a numerology for ATG communications with SCS=7.5 kHz at a frequency of 700 MHz may be determined by doubling the OFDM waveform parameters in the numerology u=0 (SCS=15 kHz), resulting in a CP of 9.40 μs. As shown by reference number 405, a first numerology (e.g., u=−1) may be configured for SCS=7.5 kHz at 700 MHz with a slot that occupies 1 ms with 7 symbols. As shown by reference number 410, a second numerology (e.g., u=−1B) may be configured for SCS=7.5 at 700 kHz with a slot that occupies 2 ms with 14 symbols. As shown by reference number 415, a numerology (e.g., u=1 (ECP)) may be configured for SCS=30 kHz at a frequency of 3.5 GHz with an extended CP (ECP) of 8.33 μs and 12 symbols per slot. As shown by reference number 420, a numerology (e.g., u=2 (eECP)) may be configured for SCS=60 kHz at a frequency of 4.8 GHz with an extended ECP (eECP) of 8.33 μs and 10 symbols per slot.

As indicated above, FIG. 4 is provided as an example. Other examples may differ from what is described with respect to FIG. 4.

As described above, a numerology for ATG communications may be selected to compensate for ATG channel PDP and Doppler measurements. In some cases, a waveform (e.g., OFDM or Orthogonal Time Frequency Space (OTFS)) for ATG communications may be selected to compensate for ATG channel PDP and Doppler measurements. Different flight scenarios, such as flight stages, terrain, or other obstacles to LoS between an ATG UE and an ATG base station may cause large changes in the ATG channel PDP profile and Doppler measurements. Accordingly, a preferred numerology or waveform for ATG communications may change based at least in part on changing flight scenarios for an ATG UE. However, a UE may not be able to select from multiple numerologies or waveforms when performing an initial access procedure with a base station. For example, in an ATG cell, a single numerology with eECP may be used, for all UEs, for initial access and an initial bandwidth part (BWP) to support a least extreme multipath, and then UEs may be later switched to smaller CP BWPs. This may result in poor spectral efficiency, which may lead to increased latency and decreased throughput of network traffic for ATG UEs.

Some techniques and apparatuses described herein enable initial access for UEs using multiple numerologies and/or waveforms. In some aspects, a base station may transmit SSBs associated multiple different numerologies (or multiple different waveforms). A UE may receive an SSB associated with a first numerology (or first waveform), and based at least in part on the SSB, the UE may receive, from the base station, information identifying time domain and frequency domain locations of SSBs associated with a second numerology (or second waveform). In some aspects, a base station may transmit SSBs using a single numerology (or waveform), and as part of an initial access procedure, a UE may transmit, to the base station, an indication of a preferred numerology (or preferred waveform) for the UE. In some aspects, a base station may transmit SSBs using a single numerology (or waveform), and based at least in part on receiving an SSB, a UE may receive, from the base station, information identifying multiple CORESET #0s associated with different numerologies (or waveforms). The UE may monitor a selected CORESET #0 associated with a selected numerology (or waveform), and the UE may receive, in the selected CORESET #0, a type 0 PDCCH communication that schedules transmission of system information associated with the selected numerology (or waveform). As a result, a UE may perform initial access using a preferred numerology or a preferred waveform. This may improve spectral efficiency, for UEs, such as ATG UEs in an ATG cell, which may lead to decreased latency and increased throughput of network traffic.

FIG. 5 is a diagram illustrating an example 500 associated with ATG signaling enhancement for initial access with multiple numerologies, in accordance with the present disclosure. As shown in FIG. 5, example 500 includes communication between a base station 110 and a UE 120. In some aspects, the base station 110 and the UE 120 may be included in a wireless network, such as wireless network 100. The base station 110 and the UE 120 may communicate via a wireless access link, which may include an uplink and a downlink. In some aspects, the UE 120 may be an ATG UE (e.g., ATG UE 305), and the base station 110 may be an ATG base station (e.g., ATG base station 110). In some aspects, the UE 120 may be a terrestrial UE (e.g., non-ATG UE), and the base station may be a terrestrial base station (e.g., non-ATG base station).

As described in FIG. 5, and by reference number 505, the UE 120 may receive an SSB associated with a first numerology. The base station 110 may transmit SSBs associated with multiple different numerologies. In some aspects, the base station 110 may transmit multiple SSBs (e.g., “first SSBs”) associated with the first numerology and multiple SSBs (e.g., “second SSBs”) associated with a second numerology that is different from the first numerology. The second numerology may have one or more different OFDM waveform parameters from the first numerology. For example, the second numerology may have at least one of a different SCS, a different CP length, a different OFDM symbol duration, a different total symbol duration, or a different number of symbols per slot from the first numerology. In some aspects, the base station 110 may transmit SSBs associated with one or more other numerologies in addition to the first numerology and the second numerology.

The base station 110 may transmit the SSBs associated with first numerology and the SSBs associated with the second numerology at different time and/or frequency locations in one or more SSB burst sets. In some aspects, for each numerology, the base station 110 may transmit multiple SSBs associated with that numerology on different beams in an SSB burst set. The UE 120 may detect and receive an SSB associated with the first numerology. For example, the UE 120 may search for SSBs associated with the first numerology and detect an SSB associated with the first numerology with a strongest signal strength for the UE 120. The detected SSB may include a PSS and an SSS, which the UE 120 may use to perform synchronization with the base station 110.

As further described in FIG. 5, and by reference number 510, the UE 120 may receive information identifying locations of the SSBs associated with the second numerology. The UE 120 may receive the information identifying the locations of the SSBs associated with the second domain based at least in part on the SSB associated with the first numerology. For example, the base station 110 may transmit the information in a communication during an initial access procedure that is initiated by the UE 120 detecting the SSB associated with the first numerology. The information may identify time domain and frequency domain locations of one or more SSBs associated with the second numerology. In some aspects, the information may indicate the time domain and frequency domain locations of one or more closest SSBs associated with the second numerology (e.g., one or more nearest available SSBs associated with the second numerology). In some aspects, in a case in which the base station 110 transmits SSBs associated with more than two numerologies, the information may identify the time domain and frequency domain locations for one or more SSBs associated with each of the numerologies other than the first numerology.

In some aspects, the information identifying the locations of the SSBs associated with the second numerology may be included in system information that is transmitted, by the base station 110, in a system information block (SIB). In this case, the base station 110 may transmit the SIB using the first numerology. In some aspects, the information identifying the locations of the SSBs associated with the second numerology may be included in remaining system information (RMSI). For example, the base station 110 may transmit an SIB type 1 (SIB1) including RMSI that includes the information identifying the locations of the SSBs associated with the second numerology. In this case, the UE 120 may receive the SIB1 including the RMSI that includes the information identifying the locations of the SSBs associated with the second numerology based at least in part on the SSB associated with the first numerology. For example, the UE 120 may receive and decode the SIB1 transmission based at least in part on a type 0 PDCCH communication received in a CORESET #0 associated with the detected SSB. “CORESET #0” refers to control resource set (CORESET) for a type 0 PDCCH common search space to be monitored by a UE.

In some aspects, the information identifying the locations of the SSBs associated with the second numerology may be included in other system information (OSI) that is transmitted by the base station 110 in an SIB. For example, the SIB including the OSI may be periodically broadcast by the base station 110. In this case, the UE 120 may receive the SIB including the OSI that includes the information identifying the locations of the SSBs associated with the second numerology based at least in part on scheduling information for the SIB that is included in SIB 1.

In some aspects, the UE 120 may initiate a random access channel (RACH) procedure based at least in part on receiving the SSB associated with the first numerology, and the base station 110 may transmit a message that includes the information identifying the locations of the SSBs associated with the second numerology to the UE 120 during the RACH procedure. In this case, uplink and downlink communications during the RACH procedure, including a downlink communication that includes the information, may be scheduled using the first numerology. The RACH procedure may be a four-step RACH procedure or a two-step RACH procedure. In some aspects, the base station 110 may include the information in any downlink communication transmitted to the UE 120 during the RACH procedure.

In some aspects, the information identifying the locations of the SSBs associated with the second numerology may be included in a message 2 (Msg2) communication (e.g., a random access response (RAR)) that is transmitted to the UE 120 by the base station 110 during a four-step RACH procedure. In this case, the UE 120 may transmit, to the base station 110, a message 1 (Msg1) communication that includes a random access preamble, and the base station 110 may transmit the Msg2 communication including the information identifying the locations of the SSBs associated with the second numerology to the UE 120 based at least in part on receiving the Msg1 communication from the UE 120.

In some aspects, the information identifying the locations of the SSBs associated with the second numerology may be included in a message B (MsgB) communication (e.g., an RAR) that is transmitted to the UE 120 by the base station 110 during a two-step RACH procedure. In this case, the UE 120 may transmit, to the base station 110, a message A (MsgA) communication that includes a random access preamble transmission and a physical uplink shared channel (PUSCH) communication, and the base station 110 may transmit the MsgB communication including the information identifying the locations of the SSBs associated with the second numerology to the UE 120 based at least in part on receiving the MsgA communication from the UE 120.

In some aspects, the base station 110 may transmit the information identifying the locations of the SSBs associated with the second numerology in at least one of a radio resource control (RRC) message or a medium access control (MAC) control element (MAC-CE). In this case, the base station 110 may transmit the RRC message or the MAC-CE using the first numerology.

As further described in FIG. 5, and by reference number 515, the UE 120 may detect and receive an SSB associated with the second numerology. The UE 120 may detect the SSB associated with the second numerology based at least in part on the information, received from the base station 110, that identifies the time domain and frequency domain locations of the SSBs associated with the second numerology.

As further described in FIG. 5, and by reference number 520, the UE 120 may perform an initial access procedure with the base station 110 based at least in part on the SSB associated with the second numerology. For example, the UE 120 may perform synchronization with the base station 110 for downlink communications using the second numerology based at least in part on the PSS and the SSS included in the SSB associated with the second numerology. The UE 120 may then perform a RACH procedure to establish an RRC connection with the base station 110. In this case, the communications between the base station 110 and the UE 120 (e.g., during and after the initial access/RACH procedure) may be scheduled and transmitted using the second numerology.

In some aspects, based at least in part on receiving the information identifying the locations of the SSBs associated with the second numerology, the UE 120 may stop an initial access procedure (e.g., during the RACH procedure) initiated in connection with the SSB associated with the first numerology in order to detect the SSB associated with the second numerology and perform the initial access procedure based at least in part on the SSB associated with the second numerology. In this way, the UE 120 may perform initial access using the second numerology, which may correspond to a preferred numerology for the UE 120.

In some aspects, when receiving a scheduled physical downlink shared channel (PDSCH) communication, the UE 120 may determine a PDSCH rate-matching pattern based at least in part on locations of SSBs associated with a numerology different from the numerology associated with the scheduled PDSCH communication. In this case, the UE 120 may perform rate-matching for the PDSCH communication using the rate-matching pattern. For example, the UE 120 may use the rate-matching pattern to rate-matcharound the SSB signals associated with different numerology.

In some aspects, the UE 120 may receive, from the base station 110, information identifying locations of SSBs associated with the first numerology based at least in part on the SSB associated with the second numerology. For example, the base station 110 may transmit the information similarly to as described above in connection with reference number 510. In this case, the UE 120 may perform rate matching for a PDSCH communication associated with the second numerology using a rate matching pattern determined based at least in part on the locations of the one or more SSBs associated with the first numerology.

In some aspects, such as in a case in which the first numerology is a preferred numerology for the UE 120, the UE 120 may perform the initial access procedure with the base station 110 based at least in part on the SSB associated with the first numerology. In this case, the UE 120 may use the information that identifies the locations of the SSBs associated with the second numerology to perform rate-matching for PDSCH communications scheduled using the first numerology. For example, the UE 120 may perform rate matching for a PDSCH communication associated with the first numerology using a rate matching pattern determined based at least in part on the locations of the one or more SSBs associated with the second numerology.

As described above in connection with FIG. 5, the base station 110 may transmit SSBs associated multiple different numerologies. The UE 120 may receive an SSB associated with a first numerology, and based at least in part, on the SSB, the UE 120 may receive, from the base station 110, information identifying time domain and frequency domain locations of SSBs associated with a second numerology. As a result, the UE 120 may perform initial access using a preferred numerology among the first numerology and the second numerology. This may improve spectral efficiency, for UEs, such as ATG UEs in an ATG cell, which may lead to decreased latency and increased throughput of network traffic.

As indicated above, FIG. 5 is provided as an example. Other examples may differ from what is described with respect to FIG. 5.

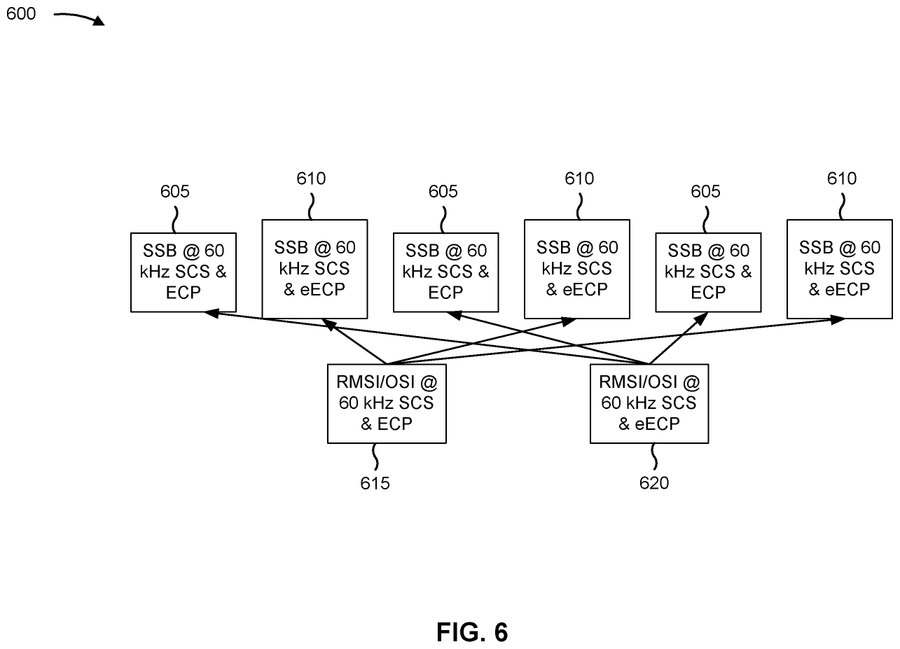

FIG. 6 is a diagram illustrating an example 600 associated with ATG signaling enhancement for initial access with multiple numerologies, in accordance with the present disclosure. As shown in FIG. 6, a base station (e.g., base station 110) may transmit first SSBs 605 associated with a first numerology and second SSBs 610 associated with a second numerology. For example, as shown in FIG. 6, the first numerology may be a numerology with SCS=60 kHz and ECP (e.g., a CP length of 4.16 μs) (e.g., u=2 (ECP) in FIG. 4), and the second numerology may be a numerology with SCS=60 kHz and eECP (e.g., a CP length of 8.33 μs) (e.g., u=2 (eECP) in FIG. 4).

As shown in FIG. 6, the base station may transmit information 615 associated with the first SSBs 605 that identifies time domain and frequency domain locations of the second SSBs 610. For example, the information 615 associated with the first SSBs 605 may include system information, such as RMSI and/or OSI, that is transmitted by the base station using the first numerology and may be received by a UE based at least in part on the UE receiving one of the first SSBs 605.

As further shown in FIG. 6, the base station may transmit information 620 associated with the second SSBs 610 that identifies time domain and frequency domain locations of the first SSBs 605. For example, the information 620 associated with the second SSBs 610 may include system information, such as RMSI and/or OSI, that is transmitted by the base station using the second numerology and may be received by a UE based at least in part on the UE receiving one of the second SSBs 610.

As indicated above, FIG. 6 is provided as an example. Other examples may differ from what is described with respect to FIG. 6.

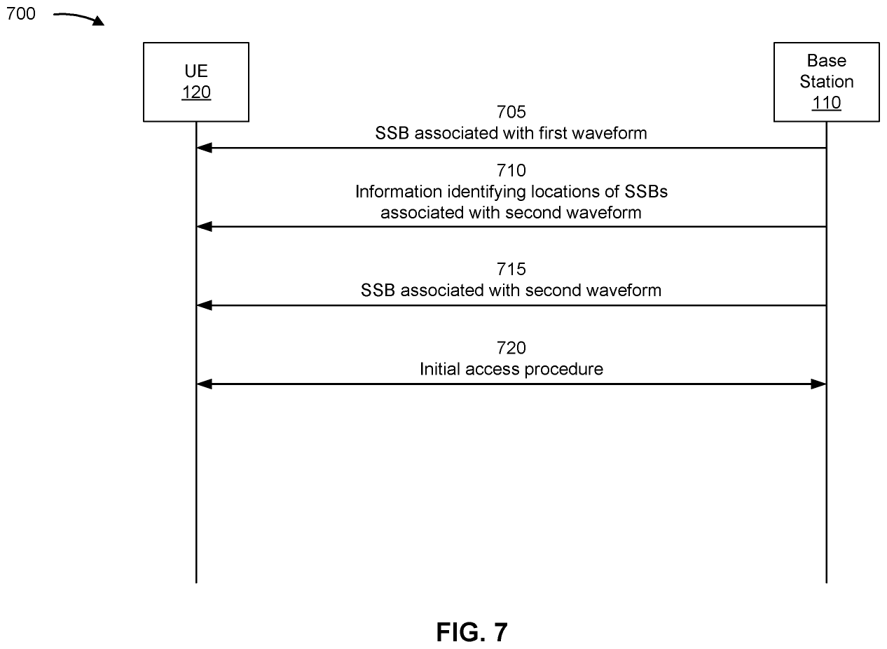

FIG. 7 is a diagram illustrating an example 700 associated with ATG signaling enhancement for initial access with multiple waveforms, in accordance with the present disclosure. As shown in FIG. 7, example 700 includes communication between a base station 110 and a UE 120. In some aspects, the base station 110 and the UE 120 may be included in a wireless network, such as wireless network 100. The base station 110 and the UE 120 may communicate via a wireless access link, which may include an uplink and a downlink. In some aspects, the UE 120 may be an ATG UE (e.g., ATG UE 305), and the base station 110 may be an ATG base station (e.g., ATG base station 110). In some aspects, the UE 120 may be a terrestrial UE (e.g., non-ATG UE), and the base station may be a terrestrial base station (e.g., non-ATG base station).

As described in FIG. 7, and by reference number 705, the UE 120 may receive an SSB associated with a first waveform. The base station 110 may transmit SSBs associated with multiple different waveforms. In some aspects, the base station 110 may transmit multiple SSBs (e.g., “first SSBs”) associated with the first waveform and multiple SSBs (e.g., “second SSBs”) associated with a second waveform that is different from the first waveform. In some aspects, the first waveform may be an OFDM waveform, and the second waveform may be an OTFS waveform. In some aspects, the first waveform may be an OTFS waveform, and the second waveform may be an OTFS waveform. In some aspects, the base station 110 may transmit SSBs associated with one or more other waveforms in addition to the first waveform and the second waveform.

The base station 110 may transmit the SSBs associated with first waveform and the SSBs associated with the second waveform at different time and/or frequency locations in one or more SSB burst sets. In some aspects, for each of the first and second waveforms, the base station 110 may transmit multiple SSBs associated with that waveform on different beams in an SSB burst set. The UE 120 may detect and receive an SSB associated with the first waveform. For example, the UE 120 may search for SSBs associated with the first waveform and detect an SSB associated with the first waveform with a strongest signal strength for the UE 120. The detected SSB may include a PSS and an SSS, which the UE 120 may use to perform synchronization with the base station 110.

As further described in FIG. 7, and by reference number 710, the UE 120 may receive information identifying locations of the SSBs associated with the second waveform. The UE 120 may receive the information identifying the locations of the SSBs associated with the second domain based at least in part on the SSB associated with the first waveform. For example, the base station 110 may transmit the information in a communication during an initial access procedure that is initiated by the UE 120 receiving the SSB associated with the first waveform. The information may identify time domain and frequency domain locations of one or more SSBs associated with the second waveform. In some aspects, the information may indicate the time domain and frequency domain locations of one or more closest SSBs associated with the second waveform (e.g., one or more nearest available SSBs associated with the second waveform). In some aspects, in a case in which the base station 110 transmits SSBs associated with more than two waveforms, the information may identify the time domain and frequency domain locations for one or more SSBs associated with each of the waveforms other than the first waveform.

In some aspects, the information identifying the locations of the SSBs associated with the second waveform may be included in system information that is transmitted, by the base station 110, in an SIB. In this case, the base station 110 may transmit the SIB using the first waveform. In some aspects, the information identifying the locations of the SSBs associated with the second waveform may be included in RMSI. For example, the base station 110 may transmit an SIB1 including RMSI that includes the information identifying the locations of the SSBs associated with the second waveform. In this case, the UE 120 may receive the SIB1 including the RMSI that includes the information identifying the locations of the SSBs associated with the second waveform based at least in part on the SSB associated with the first waveform. For example, the UE 120 may receive and decode the SIB1 transmission based at least in part on a type 1 PDCCH communication received in a CORESET #0 associated with the detected SSB.

In some aspects, the information identifying the locations of the SSBs associated with the second waveform may be included in OSI that is transmitted by the base station 110 in an SIB. For example, the SIB including the OSI may be periodically broadcast by the base station 110. In this case, the UE 120 may receive the SIB including the OSI that includes the information identifying the locations of the SSBs associated with the second waveform based at least in part on scheduling information for the SIB that is included in SIB 1.

In some aspects, the UE 120 may initiate a RACH procedure based at least in part on the SSB associated with the first waveform, and the base station 110 may transmit a message that includes the information identifying the locations of the SSBs associated with the second waveform to the UE 120 during the RACH procedure. In this case, uplink and downlink communications during the RACH procedure, including a downlink communication that includes the information, may be scheduled and transmitted with the first waveform. In some aspects, the base station 110 may include the information in any downlink communication transmitted to the UE 120 during the RACH procedure.

In some aspects, the information identifying the locations of the SSBs associated with the second waveform may be included in a Msg2 communication (e.g., an RAR) that is transmitted to the UE 120 by the base station 110 during a four-step RACH procedure. In this case, the UE 120 may transmit, to the base station 110, a Msg1 communication that includes a random access preamble, and the base station 110 may transmit the Msg2 communication including the information identifying the locations of the SSBs associated with the second waveform to the UE 120 based at least in part on receiving the Msg1 communication from the UE 120.

In some aspects, the information identifying the locations of the SSBs associated with the second waveform may be included in a MsgB communication (e.g., an RAR) that is transmitted to the UE 120 by the base station 110 during a two-step RACH procedure. In this case, the UE 120 may transmit, to the base station 110, a MsgA communication, and the base station 110 may transmit the MsgB communication including the information identifying the locations of the SSBs associated with the second waveform to the UE 120 based at least in part on receiving the MsgA communication from the UE 120.

In some aspects, the base station 110 may transmit the information identifying the locations of the SSBs associated with the second waveform in at least one of an RRC message or a MAC-CE. In this case, the base station 110 may transmit the RRC message or the MAC-CE using the first waveform.

As further described in FIG. 7, and by reference number 715, the UE 120 may detect and receive an SSB associated with the second waveform. The UE 120 may detect the SSB associated with the second waveform based at least in part on the information, received from the base station 110, that identifies the time domain and frequency domain locations of the SSBs associated with the second waveform.

As further described in FIG. 7, and by reference number 720, the UE 120 may perform an initial access procedure with the base station 110 based at least in part on the SSB associated with the second waveform. For example, the UE 120 may perform synchronization with the base station 110 for downlink communications using the second waveform based at least in part on the PSS and the SSS included in the SSB associated with the second waveform. The UE 120 may then perform a RACH procedure to establish an RRC connection with the base station 110. In this case, the communications between the base station 110 and the UE 120 (e.g., during and after the initial access/RACH procedure) may be transmitted using the second waveform.

In some aspects, based at least in part on receiving the information identifying the locations of the SSBs associated with the second waveform, the UE 120 may stop an initial access procedure initial access procedure (e.g., during the RACH procedure) initiated in connection with the SSB associated with the first waveform in order to detect the SSB associated with the second waveform and perform the initial access procedure based at least in part on the SSB associated with the second waveform. In this way, the UE 120 may perform initial access using the second waveform, which may correspond to a preferred waveform for the UE 120.

In some aspects, when receiving a scheduled PDSCH communication, the UE 120 may determine a PDSCH rate-matching pattern based at least in part on locations of SSBs associated with a waveform different from the waveform used for the scheduled PDSCH communication. In this case, the UE 120 may perform rate-matching for the PDSCH communication using the rate-matching pattern. For example, the UE 120 may use the rate-matching pattern to rate-match around the SSB signals associated with different waveform.

In some aspects, the UE 120 may receive, from the base station 110, information identifying locations of SSBs associated with the first waveform based at least in part on the SSB associated with the second waveform. For example, the base station 110 may transmit the information similarly to as described above in connection with reference number 710. In this case, the UE 120 may perform rate matching for a PDSCH communication associated with the second waveform using a rate matching pattern determined based at least in part on the locations of the one or more SSBs associated with the first waveform.

In some aspects, such as in a case in which the first waveform is a preferred waveform for the UE 120, the UE 120 may perform the initial access procedure with the base station 110 based at least in part on the SSB associated with the first waveform. In this case, the UE 120 may use the information that identifies the locations of the SSBs associated with the second waveform to perform rate-matching for PDSCH communications transmitted using the first waveform. For example, the UE 120 may perform rate matching for a PDSCH communication associated with the first waveform using a rate matching pattern determined based at least in part on the locations of the one or more SSBs associated with the second waveform.

In some aspects, once the UE 120 establishes an RRC connection with the base station 110, the UE 120 base station 110 may configure an initial BWP (e.g., an initial active BWP) for the UE 120. For example, the UE 120 may receive, from the base station 110 (e.g., via an RRC message), configuration information that indicates the initial BWP for the UE 120. In some aspects, the configuration information may indicate that multiple waveforms are supported by the initial BWP. In some aspects, the configuration for the initial BWP may separately configure an uplink BWP and a downlink BWP with different waveforms of the multiple waveforms supported by the initial BWP.

As described above in connection with FIG. 7, the base station 110 may transmit SSBs associated multiple different waveforms. The UE 120 may receive an SSB associated with a first waveform, and based at least in part on the SSB, the UE 120 may receive, from the base station 110, information identifying time domain and frequency domain locations of SSBs associated with a second waveform. As a result, the UE 120 may perform initial access using a preferred waveform among the first waveform and the second waveform. This may improve spectral efficiency for UEs, such as ATG UEs in an ATG cell, which may lead to decreased latency and increased throughput of network traffic.

As indicated above, FIG. 7 is provided as an example. Other examples may differ from what is described with respect to FIG. 7.

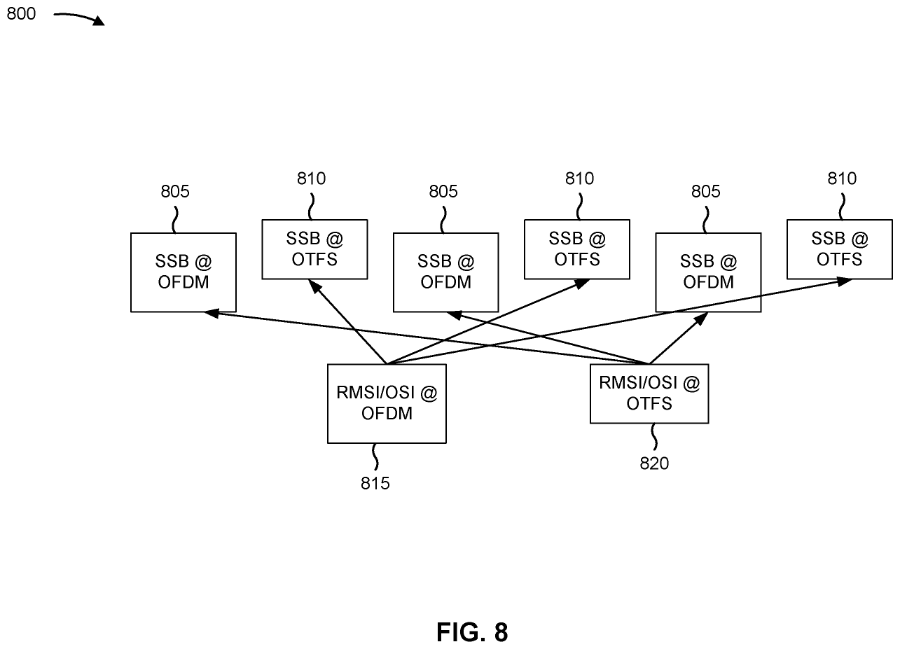

FIG. 8 is a diagram illustrating an example 800 associated with ATG signaling enhancement for initial access with multiple waveforms, in accordance with the present disclosure. As shown in FIG. 8, a base station (e.g., base station 110) may transmit first SSBs 805 associated with a first waveform and second SSBs 810 associated with a second waveform. For example, as shown in FIG. 8, the first waveform may be an OFDM waveform, and the second waveform may be an OTFS waveform.

As shown in FIG. 8, the base station may transmit information 815 associated with the first SSBs 805 that identifies time domain and frequency domain locations of the second SSBs 810. For example, the information 815 associated with the first SSBs 805 may include system information, such as RMSI and/or OSI, that is transmitted by the base station using the first waveform and may be received by a UE based at least in part on the UE receiving one of the first SSBs 805.

As further shown in FIG. 8, the base station may transmit information 820 associated with the second SSBs 810 that identifies time domain and frequency domain locations of the first SSBs 805. For example, the information 820 associated with the second SSBs 810 may include system information, such as RMSI and/or OSI, that is transmitted by the base station using the second waveform and may be received by a UE based at least in part on the UE receiving one of the second SSBs 810.

As indicated above, FIG. 8 is provided as an example. Other examples may differ from what is described with respect to FIG. 8.

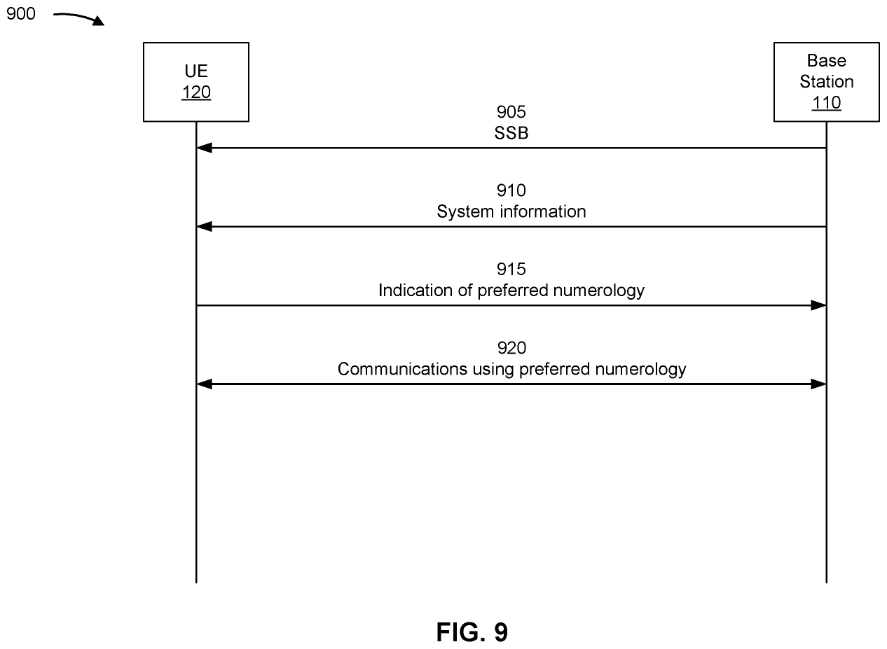

FIG. 9 is a diagram illustrating an example 900 associated with ATG signaling enhancement for initial access with multiple numerologies, in accordance with the present disclosure. As shown in FIG. 9, example 900 includes communication between a base station 110 and a UE 120. In some aspects, the base station 110 and the UE 120 may be included in a wireless network, such as wireless network 100. The base station 110 and the UE 120 may communicate via a wireless access link, which may include an uplink and a downlink. In some aspects, the UE 120 may be an ATG UE (e.g., ATG UE 305), and the base station 110 may be an ATG base station (e.g., ATG base station 110). In some aspects, the UE 120 may be a terrestrial UE (e.g., non-ATG UE), and the base station may be a terrestrial base station (e.g., non-ATG base station).

As shown in FIG. 9, and by reference number 905, the UE 120 may receive an SSB associated with a first numerology. In some aspects, the base station 110 may transmit SSBs associated with a single numerology (e.g., the first numerology). For example, the base station 110 may transmit multiple SSBs associated with the first numerology on multiple beams in an SSB burst set. The UE 120 may search for SSBs and detect the SSB with the strongest signal strength for the UE 120.

As further shown in FIG. 9, and by reference number 910, the base station 110 may transmit system information associated with the first numerology. The UE 120, based at least in part on the SSB, may receive the system information transmitted from the base station 110. The base station 110 may transmit the system information using the first numerology.

In some aspects, the system information may include RMSI and/or OSI. For example, based at least in part on the SIB, the UE 120 may receive, from the base station 110, a master information block (MIB) that includes a configuration of a CORESET #0. The UE 120 may monitor the CORESET #0 for a type 0 PDCCH communication that includes scheduling information for an SIB1 transmission from the base station 110. The UE 120 may receive the SIM based at least in part on the scheduling information included in the type 0 PDCCH communication. The SIB1 may include the RMSI, which may include scheduling information for one or more other SIBs that include the OSI. The UE 120 may receive the OSI in the one or more other SIBS based at least in part on the scheduling information included in the RMSI. In some aspects, the base station 110 may transmit the MIB and the SIBs including the RMSI and the OSI using the first numerology.

In some aspects, the system information (e.g., the RMSI and/or the OSI) may include parameters associated with a RACH procedure to be used by the UE 120. In some aspects, the system information (e.g., the RMSI and/or the OSI) may indicate one or more dedicated RACH occasions associated with respective numerologies. For example, the system information (e.g., the RMSI and/or the OSI) may indicate a mapping between each of the one or more dedicated RACH occasions and the respective numerology associated with that dedicated RACH occasion. In this case, each dedicated RACH occasion is a RACH occasion that may be used by the UE 120 to indicate that the respective numerology associated with that RACH occasion is a preferred numerology for the UE 120.

In some aspects, the system information (e.g., the RMSI and/or the OSI) may indicate one or more dedicated random access preambles associated with respective numerologies. For example, the system information (e.g., the RMSI and/or the OSI) may indicate a mapping between each of the one or more dedicated random access preambles and the respective numerology associated with that dedicated random access preamble. In this case, each dedicated random access preamble may be used by the UE 120 to indicate that the respective numerology associated with that random access preamble is a preferred numerology for the UE 120.

As further shown in FIG. 9, and by reference number 915, the UE 120 may transmit, to the base station 110, an indication of a preferred numerology. For example, the UE 120 may transmit, to the base station 110, an indication of a second numerology that is a preferred numerology for the UE 120. In this case, the second numerology may be different from the first numerology. For example, the second numerology may have at least one of a different SCS, a different CP length, a different OFDM symbol duration, a different total symbol duration, or a different number of symbols per slot from the first numerology.

In some aspects, the UE 120 may transmit the indication of the preferred numerology (e.g., the second numerology) during a RACH procedure. For example, the UE 120 may transmit, to the base station 110, a random access preamble communication (e.g., Msg1 or MsgA) that provides the indication of the preferred numerology. In some aspects, the system information (e.g., the RMSI and/or the OSI) may configure one or more dedicated RACH occasions associated with respective numerologies. In this case, the UE 120 may indicate that the second numerology is the preferred numerology for the UE 120 by transmitting the random access preamble communication (e.g., Msg1 or MsgA) in a dedicated RACH occasion associated with the second numerology. In some aspects, the system information (e.g., the RMSI and/or the OSI) may configure one or more dedicated random access preambles associated with respective numerologies. In this case, the UE 120 may indicate that the second numerology is the preferred numerology for the UE 120 by transmitting, in the random access preamble communication (e.g., Msg1 or MsgA), a dedicated random access preamble associated with the second numerology.

In some aspects, the UE 120 may transmit the indication of the preferred numerology (e.g., the second numerology), in a message 3 (Msg3) communication (e.g., a PUSCH communication scheduled by the Msg2 RAR) during a four-step RACH procedure. In this case, the Msg3 communication may be scheduled with the first numerology, and message 4 (Msg4) (e.g., a contention resolution PDCCH/PDSCH communication) and any subsequent messages during the RACH procedure may be scheduled with indicated preferred numerology (e.g., the second numerology).

In some aspects, the UE 120 may transmit the indication of the preferred numerology (e.g., the second numerology), in a MsgA PUSCH communication during a two-step RACH procedure. In this case, the MsgA PUSCH communication may be scheduled with the first numerology, and MsgB any subsequent messages during the RACH procedure may be scheduled with indicated preferred numerology (e.g., the second numerology).

In some aspects, the UE 120 may transmit the indication of the preferred numerology (e.g., the second numerology) to the base station 110 based at least in part on establishing an RRC connection with the base station 110 (e.g., via the RACH procedure). For example, once the UE 120 has established the RRC connection with the base station 110 via communications using the first numerology (e.g., during the RACH procedure), the UE 120 may transmit the indication of the preferred numerology (e.g., the second numerology) to the base station 110 in at least one of an RRC message or a MAC-CE. In this case, the RRC message or the MAC-CE that includes the indication may be scheduled and transmitted using the first numerology.

As further shown in FIG. 9, and by reference number 920, one or more communications between the base station 110 and the UE 120 may be scheduled and transmitted with the preferred numerology (e.g., the second numerology). For example, based at least in part on receiving the indication that the second numerology is the preferred numerology for the UE 120, the base station 110 may schedule one or more subsequent downlink communications and/or one or more subsequent uplink communications with the second numerology. The base station 110 may transmit, and the UE 120 may receive, the one or more downlink communications with the second numerology. The UE 120 may transmit, and the base station 110 may receive, the one or more uplink communications with the second numerology.

In some aspects, the UE 120 may transmit the indication of the preferred numerology (e.g., the second numerology) to the base station 110 during the RACH procedure. In this case, subsequent communications during the RACH procedure may be scheduled and transmitted using the preferred numerology (e.g., the second numerology), and communications subsequent to the RACH procedure may also be scheduled and transmitted using the preferred numerology (e.g., the second numerology). For example, based at least in part on the UE 120 transmitting the indication that the second numerology is the preferred numerology during the RACH procedure, the UE 120 and the base station 110 may complete the RACH procedure using communications with the second numerology. The UE 120 and base station 110 may then continue communicating using the second numerology once the RACH procedure is completed.

In some aspects, the UE 120 may indicate the preferred numerology (e.g., the second numerology) using the random access preamble communication (e.g., Msg1 or MsgA) in the RACH procedure. In this case, communications subsequent to the random access preamble communication in the RACH procedure (and after completion of the RACH procedure) may be scheduled and transmitted using the preferred numerology (e.g., the second numerology). For example, in a case in which the Msg1 communication is used to indicate that the second numerology is the preferred numerology, Msg2 (e.g., the RAR), Msg3 (e.g., the PUSCH communication scheduled by Msg2), Msg4 (e.g., the contention resolution PDCCH/PDSCH), and any other subsequent messages during the RACH procedure may be scheduled and transmitted using the second numerology. In a case in which the MsgA random access preamble communication is used to indicate that the second numerology is the preferred numerology, MsgB and any other subsequent messages during the RACH procedure may be scheduled and transmitted using the second numerology.

In some aspects, the UE 120 may transmit the indication of the preferred numerology (e.g., the second numerology) in the Msg3 communication during a four-step RACH procedure. In this case, Msg4 and any subsequent messages during the RACH procedure may be scheduled and transmitted using the indicated preferred numerology (e.g., the second numerology). In some aspects, the UE 120 may transmit the indication of the preferred numerology (e.g., the second numerology) in the MsgA PUSCH communication during a two-step RACH procedure. In this case, MsgB and any subsequent messages during the RACH procedure may be scheduled and transmitted using the indicated preferred numerology (e.g., the second numerology).

In some aspects, the UE 120 may transmit the indication of the preferred numerology (e.g., the second numerology) to the base station 110 via an RRC message or a MAC-CE. In this case, communications between the base station 110 and the UE 120 subsequent to the RRC message or MAC-CE that includes the indication may be scheduled and transmitted with the indicated preferred numerology (e.g., the second numerology).

As described above in connection with FIG. 9, the base station 110 may transmit SSBs using a single numerology, and as part of an initial access procedure, the UE 120 may transmit, to the base station 110, an indication of a preferred numerology for the UE 120. As a result, the UE 120 may complete the initial access procedure with the preferred numerology. This may improve spectral efficiency, for UEs, such as ATG UEs in an ATG cell, which may lead to decreased latency and increased throughput of network traffic.

As indicated above, FIG. 9 is provided as an example. Other examples may differ from what is described with respect to FIG. 9.

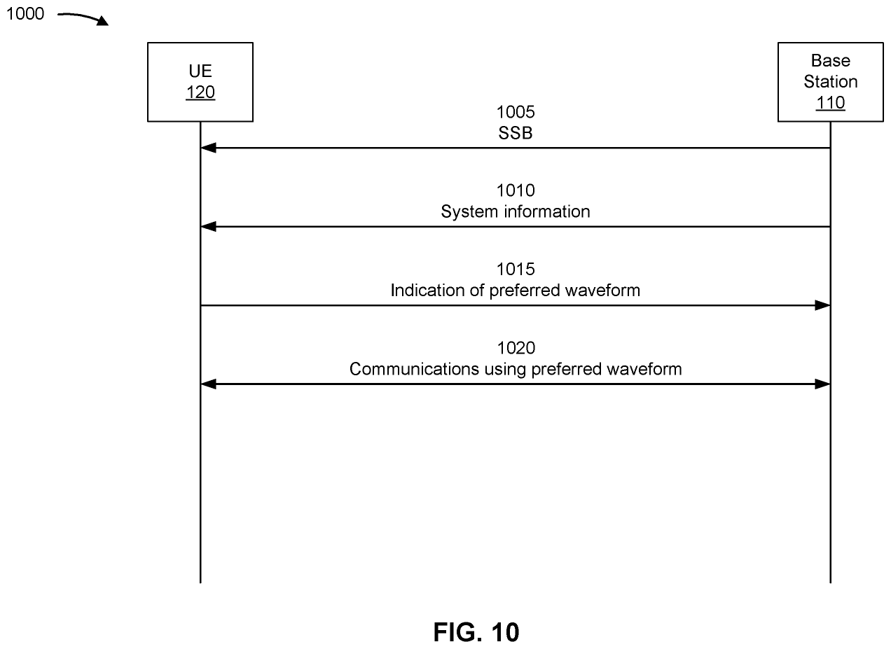

FIG. 10 is a diagram illustrating an example 1000 associated with ATG signaling enhancement for initial access with multiple waveforms, in accordance with the present disclosure. As shown in FIG. 10, example 1000 includes communication between a base station 110 and a UE 120. In some aspects, the base station 110 and the UE 120 may be included in a wireless network, such as wireless network 100. The base station 110 and the UE 120 may communicate via a wireless access link, which may include an uplink and a downlink. In some aspects, the UE 120 may be an ATG UE (e.g., ATG UE 305), and the base station 110 may be an ATG base station (e.g., ATG base station 110). In some aspects, the UE 120 may be a terrestrial UE (e.g., non-ATG UE) and the base station may be a terrestrial base station (e.g., non-ATG base station).

As shown in FIG. 10, and by reference number 1005, the UE 120 may receive an SSB associated with a first waveform. In some aspects, the base station 110 may transmit SSBs associated with a single waveform (e.g., the first waveform). For example, the first waveform may be an OFDM waveform or an OTFS waveform. In some aspects, such as in a case in which the base station 110 is an ATG base station, the first waveform may be an OFDM waveform with SCS=60 kHz and eECP (e.g., u=2 (eECP) in FIG. 4). The base station 110 may transmit multiple SSBs associated with the first waveform on multiple beams in an SSB burst set. The UE 120 may search for SSBs and detect the SSB with the strongest signal strength for the UE 120.

As further shown in FIG. 10, and by reference number 1010, the base station 110 may transmit system information associated with the first waveform. The UE 120, based at least in part on the SSB, may receive the system information transmitted from the base station 110. The base station 110 may transmit the system information using the first waveform.

In some aspects, the system information may include RMSI and/or OSI. For example, based at least in part on the SIB, the UE 120 may receive, from the base station 110, an MIB that includes a configuration of a CORESET #0. The UE 120 may monitor the CORESET #0 for a type 0 PDCCH communication that includes scheduling information for an SIB1 transmission from the base station 110. The UE 120 may receive the SIB1 based at least in part on the scheduling information included in the type 0 PDCCH communication. The SIB1 may include the RMSI, which may include scheduling information for one or more other SIBs that include the OSI. The UE 120 may receive the OSI in the one or more other SIBs based at least in part on the scheduling information included in the RMSI. In some aspects, the base station 110 may transmit the MIB and the SIBs including the RMSI and the OSI using the first waveform.

In some aspects, the system information (e.g., the RMSI and/or the OSI) may include parameters associated with a RACH procedure to be used by the UE 120. In some aspects, the system information (e.g., the RMSI and/or the OSI) may indicate one or more dedicated RACH occasions associated with respective waveforms. For example, the system information (e.g., the RMSI and/or the OSI) may indicate a mapping between each of the one or more dedicated RACH occasions and the respective waveform associated with that dedicated RACH occasion. In this case, each dedicated RACH occasion is a RACH occasion that may be used by the UE 120 to indicate that the respective waveform associated with that RACH occasion is a preferred waveform for the UE 120.

In some aspects, the system information (e.g., the RMSI and/or the OSI) may indicate one or more dedicated random access preambles associated with respective waveforms. For example, the system information (e.g., the RMSI and/or the OSI) may indicate a mapping between each of the one or more dedicated random access preambles and the respective waveform associated with that dedicated random access preamble. In this case, each dedicated random access preamble may be used by the UE 120 to indicate that the respective waveform associated with that random access preamble is a preferred waveform for the UE 120.

As further shown in FIG. 10, and by reference number 1015, the UE 120 may transmit, to the base station 110, an indication of a preferred waveform. For example, the UE 120 may transmit, to the base station 110, an indication of a second waveform that is a preferred waveform for the UE 120. In this case, the second waveform may be different from the first waveform. For example, the first waveform may be an OFDM waveform, and the second waveform may be an OTFS waveform. Alternatively, the first waveform may an OTFS waveform, and the second waveform may be an OFDM waveform.

In some aspects, the UE 120 may transmit the indication of the preferred waveform (e.g., the second waveform) during a RACH procedure. For example, the UE 120 may transmit, to the base station 110, a random access preamble communication (e.g., Msg1 or MsgA) that provides the indication of the preferred waveform. In some aspects, the system information (e.g., the RMSI and/or the OSI) may configure one or more dedicated RACH occasions associated with respective waveforms. In this case, the UE 120 may indicate that the second waveform is the preferred waveform for the UE 120 by transmitting the random access preamble communication (e.g., Msg1 or MsgA) in a dedicated RACH occasion associated with the second waveform. In some aspects, the system information (e.g., the RMSI and/or the OSI) may configure one or more dedicated random access preambles associated with respective waveforms. In this case, the UE 120 may indicate that the second waveform is the preferred waveform for the UE 120 by transmitting, in the random access preamble communication (e.g., Msg1 or MsgA), a dedicated random access preamble associated with the second waveform.

In some aspects, the UE 120 may transmit the indication of the preferred waveform (e.g., the second waveform), in a message 3 (Msg3) communication (e.g., a PUSCH communication scheduled by the Msg2 RAR) during a four-step RACH procedure. In this case, the Msg3 communication may be scheduled with the first waveform, and message 4 (Msg4) (e.g., a contention resolution PDCCH/PDSCH communication) and any subsequent messages during the RACH procedure may be scheduled with indicated preferred waveform (e.g., the second waveform).

In some aspects, the UE 120 may transmit the indication of the preferred waveform (e.g., the second waveform), in a MsgA PUSCH communication during a two-step RACH procedure. In this case, the MsgA PUSCH communication may be scheduled with the first waveform, and MsgB any subsequent messages during the RACH procedure may be scheduled with indicated preferred waveform (e.g., the second waveform).

In some aspects, the UE 120 may transmit the indication of the preferred waveform (e.g., the second waveform) to the base station 110 based at least in part on establishing an RRC connection with the base station 110 (e.g., via the RACH procedure). For example, once the UE 120 has established the RRC connection with the base station 110 via communications using the first waveform (e.g., during the RACH procedure), the UE 120 may transmit the indication of the preferred waveform (e.g., the second waveform) to the base station 110 in at least one of an RRC message or a MAC-CE. In this case, the RRC message or the MAC-CE that includes the indication may be scheduled and transmitted using the first waveform.

As further shown in FIG. 10, and by reference number 1020, one or more communications between the base station 110 and the UE 120 may be scheduled and transmitted with the preferred waveform (e.g., the second waveform). For example, based at least in part on receiving the indication that the second waveform is the preferred waveform for the UE 120, the base station 110 may schedule one or more subsequent downlink communications and/or one or more subsequent uplink communications with the second waveform. The base station 110 may transmit, and the UE 120 may receive, the one or more downlink communications with the second waveform. The UE 120 may transmit, and the base station 110 may receive, the one or more uplink communications with the second waveform.

In some aspects, the UE 120 may transmit the indication of the preferred waveform (e.g., the second waveform) to the base station 110 during the RACH procedure. In this case, subsequent communications during the RACH procedure may be scheduled and transmitted using the preferred waveform (e.g., the second waveform), and communications subsequent to the RACH procedure may also be scheduled and transmitted using the preferred waveform (e.g., the second waveform). For example, based at least in part on the UE 120 transmitting the indication that the second waveform is the preferred waveform during the RACH procedure, the UE 120 and the base station 110 may complete the RACH procedure using communications with the second waveform. The UE 120 and base station 110 may then continue communicating using the second waveform once the RACH procedure is completed.

In some aspects, the UE 120 may indicate the preferred waveform (e.g., the second waveform) using the random access preamble communication (e.g., Msg1 or MsgA) in the RACH procedure. In this case, communications subsequent to the random access preamble communication in the RACH procedure (and after completion of the RACH procedure) may be scheduled and transmitted using the preferred waveform (e.g., the second waveform). For example, in a case in which the Msg1 communication is used to indicate that the second waveform is the preferred waveform, Msg2 (e.g., the RAR), Msg3 (e.g., the PUSCH communication scheduled by Msg2), Msg4 (e.g., the contention resolution PDCCH/PDSCH), and any other subsequent messages during the RACH procedure may be scheduled and transmitted using the second waveform. In a case in which the MsgA random access preamble communication is used to indicate that the second waveform is the preferred waveform, MsgB and any other subsequent messages during the RACH procedure may be scheduled and transmitted using the second waveform.

In some aspects, the UE 120 may transmit the indication of the preferred waveform (e.g., the second waveform) in the Msg3 communication during a four-step RACH procedure. In this case, Msg4 and any subsequent messages during the RACH procedure may be scheduled and transmitted using the indicated preferred waveform (e.g., the second waveform). In some aspects, the UE 120 may transmit the indication of the preferred waveform (e.g., the second waveform) in the MsgA PUSCH communication during a two-step RACH procedure. In this case, MsgB and any subsequent messages during the RACH procedure may be scheduled and transmitted using the indicated preferred waveform (e.g., the second waveform).

In some aspects, the UE 120 may transmit the indication of the preferred waveform (e.g., the second waveform) to the base station 110 via an RRC message or a MAC-CE. In this case, communications between the base station 110 and the UE 120 subsequent to the RRC message or MAC-CE that includes the indication may be scheduled and transmitted with the indicated preferred waveform (e.g., the second waveform).

As described above in connection with FIG. 10, the base station 110 may transmit SSBs using a single waveform, and as part of an initial access procedure, the UE 120 may transmit, to the base station 110, an indication of a preferred waveform for the UE 120. As a result, the UE 120 may complete the initial access procedure with the preferred waveform. This may improve spectral efficiency, for UEs, such as ATG UEs in an ATG cell, which may lead to decreased latency and increased throughput of network traffic.

As indicated above, FIG. 10 is provided as an example. Other examples may differ from what is described with respect to FIG. 10.

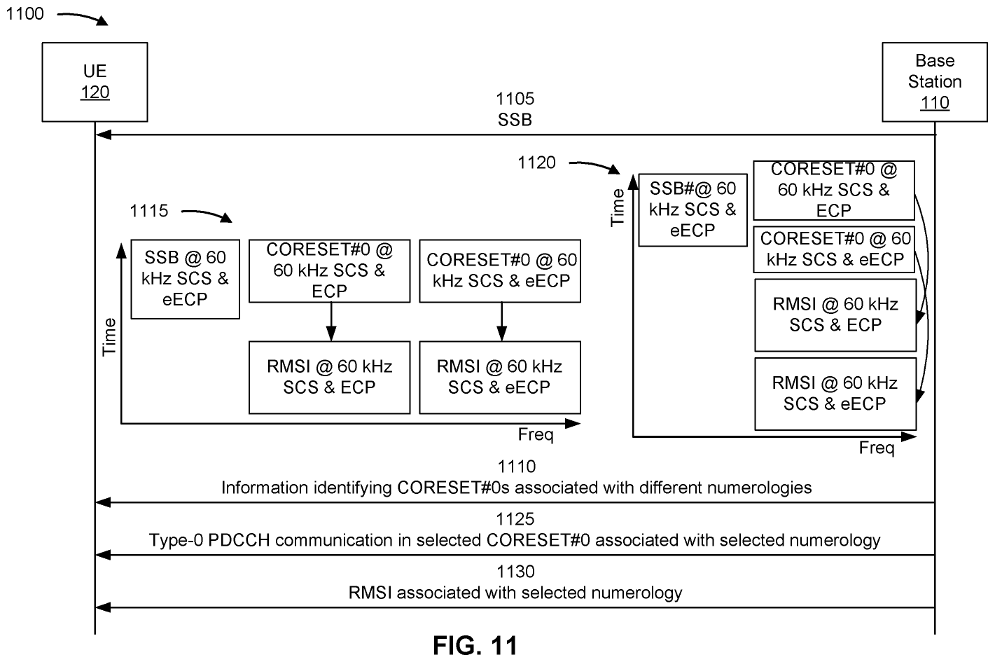

FIG. 11 is a diagram illustrating an example 1100 associated with ATG signaling enhancement for initial access with multiple numerologies, in accordance with the present disclosure. As shown in FIG. 11, example 1100 includes communication between a base station 110 and a UE 120. In some aspects, the base station 110 and the UE 120 may be included in a wireless network, such as wireless network 100. The base station 110 and the UE 120 may communicate via a wireless access link, which may include an uplink and a downlink. In some aspects, the UE 120 may be an ATG UE (e.g., ATG UE 305), and the base station 110 may be an ATG base station (e.g., ATG base station 110). In some aspects, the UE 120 may be a terrestrial UE (e.g., non-ATG UE) and the base station may be a terrestrial base station (e.g., non-ATG base station).

As shown in FIG. 11, and by reference number 1105, the UE 120 may receive an SSB transmitted by the base station 110. In some aspects, the base station 110 may transmit SSBs associated with a single numerology (e.g., a first numerology). For example, the base station 110 may transmit multiple SSBs associated with the first numerology on multiple beams in an SSB burst set. The UE 120 may search for SSBs and detect the SSB with the strongest signal strength for the UE 120.

As further shown in FIG. 11, and by reference number 1110, the UE 120 may receive, from the base station 110, information identifying multiple CORESET #0s associated with different numerologies. In some aspects, the UE 120 may receive the information identifying the CORESET #0s based at least in part on the SSB. For example, the information identifying the CORESET #0s may be included in an MIB associated with the detected SSB. The base station 110 may transmit the MIB including the information identifying the CORESET #0s, and the UE 120 may receive the MIB including the information identifying the CORESET #0s based at least in part on receiving the SSB.

In some aspects, the information may include configuration information for a set of CORESET #0s associated with the SSB. For example, the set of CORESET #0s may include multiple CORESET #0s that are associated with an index of the SSB. In some aspects, each CORESET #0 in set of the CORESET #0s may be associated with a respective numerology. For example, the information may identify multiple CORESET #0s associated with the index of the SSB, that are associated with different numerologies. The information may also indicate a mapping between each CORESET #O and the respective numerology associated with that CORESET #0.

In some aspects, the multiple CORESET #0s associated with the detected SSB may be frequency division multiplexed. For example, as shown by reference number 1115, multiple CORESET #0s associated with an index of an SSB may be frequency division multiplexed. As shown by reference number 1115, the SSB may be associated with a first numerology (e.g., SCS=60 kHz and eECP), and the multiple CORESET #0s associated with the index of the SSB may include a CORESET #0 associated with the first numerology and a CORESET #0 associated with a second numerology (e.g., SCS=60 kHz and ECP). The CORESET #0 associated with the first numerology may be used to receive and decode RMSI associated with the first numerology, and the CORESET #0 associated with the second numerology may be used to receive and decode RMSI associated with the second numerology. In some aspects, an FDM pattern for the multiple CORESET #0s associated with the SSB may be indicated in the MIB (e.g., using reserved or invalid bit-points). In some aspects, the FDM pattern for the multiple CORESET #0s associated with the SSB may be predefined, for example, in a wireless communication standard.

In some aspects, the multiple CORESET #0s associated with the detected SSB may be time division multiplexed. For example, as shown by reference number 1120, multiple CORESET #0s associated with an index of an SSB may be time division multiplexed. As shown by reference number 1120, the SSB may be associated with a first numerology (e.g., SCS=60 kHz and eECP), and the multiple CORESET #0s associated with the index of the SSB may include a CORESET #0 associated with the first numerology and a CORESET #0 associated with a second numerology (e.g., SCS=60 kHz and ECP). The CORESET #0 associated with the first numerology may be used to receive and decode RMSI associated with the first numerology, and the CORESET #0 associated with the second numerology may be used to receive and decode RMSI associated with the second numerology. In some aspects, a time division multiplexing (TDM) pattern for the multiple CORESET #0s associated with the SSB may be indicated in the MIB (e.g., using reserved or invalid bit-points). In some aspects, the TDM pattern for the multiple CORESET #0s associated with the SSB may be predefined, for example, in a wireless communication standard.

In some aspects, the information may identify multiple type 0 search spaces associated with different numerologies. “Type 0 search spaces” may refer to time domain occasions for a UE to monitor a CORESET #0 to receive type 0 PDCCH communications. In some aspects, the information may identify CORESET #0s and/or type 0 search spaces associated with different numerologies. For example, the information may identify multiple CORESET #0s associated with different numerologies, multiple type 0 search spaces (e.g. in a single CORESET #0 associated with the SSB index), or different combinations of CORESET #0s and type 0 search spaces that are associated with different numerologies.

As further shown in FIG. 11, and by reference number 1125, the UE 120 may receive, from the base station 110, a type 0 PDCCH communication in a selected CORESET #0 associated with a selected numerology. Based at least in part on the information identifying the multiple CORESET #0s associated with different numerologies, the UE 120 may select to monitor a CORESET #0 that is associated with a selected numerology (e.g., a preferred numerology for the UE 120). For example, the UE 120 may select to monitor a CORESET #0 associated with the selected numerology from the set of CORESET #0s associated with the index of the detected SSB.

In some aspects, the base station 110 may transmit, in each CORESET #0 in the set of CORESET #0s, a respective type 0 PDCCH communication that schedules (e.g., includes scheduling information for) transmission of RMSI for the respective numerology associated with that CORESET #0. The UE 120 may monitor the selected CORESET #0 and receive the type 0 PDCCH communication that includes scheduling information for the RMSI associated with the selected numerology.

In some aspects, in a case in which the information identifies multiple type 0 search spaces associated with different numerologies, the base station 110 may transmit, in each type 0 search space, a respective type 0 PDCCH communication that schedules (e.g., includes scheduling information for) transmission of RMSI for the respective numerology associated with that type 0 search space. In this case, the UE 120 may monitor a selected type 0 search space associated with the selected numerology and receive the type 0 PDCCH communication that includes scheduling information for the RMSI associated with the selected numerology.

In some aspects, the SSB may be transmitted using a first numerology and selected numerology may be a second numerology that is different from the first numerology. For example, the second numerology may have at least one of a different SCS, a different CP length, a different OFDM symbol duration, a different total symbol duration, or a different number of symbols per slot from the first numerology.

As further shown in FIG. 11, and by reference number 1130, UE 120 may receive, from the base station 110, RMSI associated with the selected numerology. In some aspects, for each numerology for which a respective CORESET #0 (and/or a respective type 0 search space) is configured, the base station 110 may transmit respective RMSI associated with that numerology in a respective scheduled SIB1 transmission. Based at least in part on the scheduling information in the type 0 PDCCH communication received in the selected CORESET #0 (and/or the selected type 0 search space), the UE 120 may receive and decode the SIB1 including the RMSI associated with the selected numerology. In some aspects, the UE 120 may receive OSI associated with the selected numerology based at least in part on scheduling information included in the RMSI, and/or perform a RACH procedure to establish an RRC connection with the base station 110 using communications associated with the selected numerology based at least in part on the RMSI and/or the OSI.

As described above in connection with FIG. 11, the base station 110 may transmit SSBs using a single numerology, and based at least in part on receiving an SSB, the UE 120 may receive, from the base station 110, information identifying multiple CORESET #0s associated with different numerologies. The UE 120 may monitor a selected CORESET #0 associated with a selected numerology, and the UE 120 may receive, in the selected CORESET #0, a type 0 PDCCH communication that schedules transmission of system information associated with the selected numerology. As a result, the UE 120 may perform initial access using a preferred numerology. This may improve spectral efficiency, for UEs, such as ATG UEs in an ATG cell, which may lead to decreased latency and increased throughput of network traffic.

As indicated above, FIG. 11 is provided as an example. Other examples may differ from what is described with respect to FIG. 11.

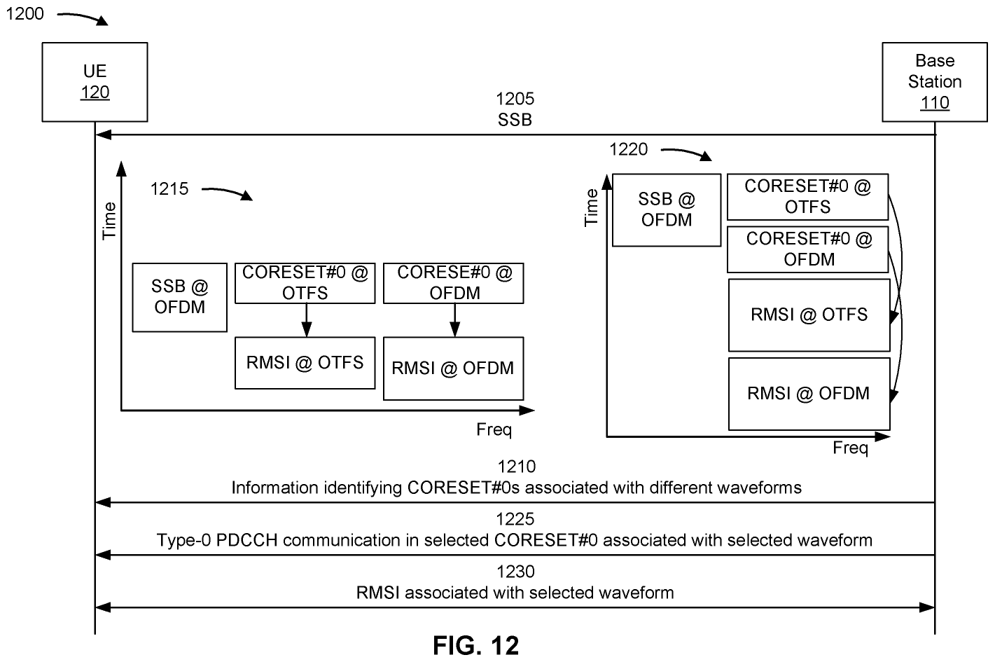

FIG. 12 is a diagram illustrating an example 1200 associated with ATG signaling enhancement for initial access with multiple waveforms, in accordance with the present disclosure. As shown in FIG. 12, example 1200 includes communication between a base station 110 and a UE 120. In some aspects, the base station 110 and the UE 120 may be included in a wireless network, such as wireless network 100. The base station 110 and the UE 120 may communicate via a wireless access link, which may include an uplink and a downlink. In some aspects, the UE 120 may be an ATG UE (e.g., ATG UE 305), and the base station 110 may be an ATG base station (e.g., ATG base station 110). In some aspects, the UE 120 may be a terrestrial UE (e.g., non-ATG UE), and the base station may be a terrestrial base station (e.g., non-ATG base station).

As shown in FIG. 12, and by reference number 1205, the UE 120 may receive an SSB transmitted by the base station 110. In some aspects, the base station 110 may transmit SSBs associated with a single waveform (e.g., a first waveform). For example, the base station 110 may transmit multiple SSBs associated with the first waveform on multiple beams in an SSB burst set. The UE 120 may search for SSBs and detect the SSB with the strongest signal strength for the UE 120.

As further shown in FIG. 12, and by reference number 1210, the UE 120 may receive, from the base station 110, information identifying multiple CORESET #0s associated with different waveforms. In some aspects, the UE 120 may receive the information identifying the CORESET #0s based at least in part on the SSB. For example, the information identifying the CORESET #0s may be included in an MIB associated with the detected SSB. The base station 110 may transmit the MIB including the information identifying the CORESET #0s, and the UE 120 may receive the MIB including the information identifying the CORESET #0s based at least in part on receiving the SSB.

In some aspects, the information may include configuration information for a set of CORESET #0s associated with the detected SSB. For example, the set of CORESET #0s may include multiple CORESET #0s that are associated with an index of the SSB. In some aspects, each CORESET #0 in set of the CORESET #0s may be associated with a respective waveform. For example, the information may identify multiple CORESET #0s associated with the index of the SSB, that are associated with different waveforms. The information may also indicate a mapping between each CORESET #0 and the respective waveform associated with that CORESET #0.

In some aspects, the multiple CORESET #0s associated with the detected SSB may be frequency division multiplexed. For example, as shown by reference number 1215, multiple CORESET #0s associated with an index of an SSB may be frequency division multiplexed. As shown by reference number 1215, the SSB may be associated with a first waveform (e.g., OFDM), and the multiple CORESET #0s associated with the index of the SSB may include a CORESET #0 associated with the first waveform and a CORESET #0 associated with a second waveform (e.g., OTFS). The CORESET #0 associated with the first waveform may be used to receive and decode RMSI associated with the first waveform, and the CORESET #0 associated with the second waveform may be used to receive and decode RMSI associated with the second waveform. In some aspects, an FDM pattern for the multiple CORESET #0s associated with the SSB may be indicated in the MIB (e.g., using reserved or invalid bit-points). In some aspects, the FDM pattern for the multiple CORESET #0s associated with the SSB may be predefined, for example, in a wireless communication standard.

In some aspects, the multiple CORESET #0s associated with the detected SSB may be time division multiplexed. For example, as shown by reference number 1220, multiple CORESET #0s associated with an index of an SSB may be time division multiplexed. As shown by reference number 1220, the SSB may be associated with a first waveform (e.g., OFDM), and the multiple CORESET #0s associated with the index of the SSB may include a CORESET #0 associated with the first waveform and a CORESET #0 associated with a second waveform (e.g., OTFS). The CORESET #0 associated with the first waveform may be used to receive and decode RMSI associated with the first waveform, and the CORESET #0 associated with the second waveform may be used to receive and decode RMSI associated with the second waveform. In some aspects, a TDM pattern for the multiple CORESET #0s associated with the SSB may be indicated in the MIB (e.g., using reserved or invalid bit-points). In some aspects, the TDM pattern for the multiple CORESET #0s associated with the SSB may be predefined, for example, in a wireless communication standard.

In some aspects, the information may identify multiple type 0 search spaces associated with different waveforms. In some aspects, the information may identify CORESET #0s and/or type 0 search spaces associated with different waveforms. For example, the information may identify multiple CORESET #0s associated with different waveforms, multiple type 0 search spaces (e.g. in a single CORESET #0 associated with the SSB index), or different combinations of CORESET #0s and type 0 search spaces that are associated with different waveforms.

As further shown in FIG. 12, and by reference number 1225, the UE 120 may receive, from the base station 110, a type 0 PDCCH communication in a selected CORESET #0 associated with a selected waveform. Based at least in part on the information identifying the multiple CORESET #0s associated with different waveforms, the UE 120 may select to monitor a CORESET #0 that is associated with a selected waveform (e.g., a preferred waveform for the UE 120). For example, the UE 120 may select to monitor a CORESET #0 associated with the selected waveform from the set of CORESET #0s associated with the index of the detected SSB.

In some aspects, the base station 110 may transmit, in each CORESET #0 in the set of CORESET #0s, a respective type 0 PDCCH communication that schedules (e.g., includes scheduling information for) transmission of RMSI for the respective waveform associated with that CORESET #0. The UE 120 may monitor the selected CORESET #0 and receive the type 0 PDCCH communication that includes scheduling information for the RMSI associated with the selected waveform.

In some aspects, in a case in which the information identifies multiple type 0 search spaces associated with different waveforms, the base station 110 may transmit, in each type 0 search space, a respective type 0 PDCCH communication that schedules (e.g., includes scheduling information for) transmission of RMSI for the respective waveform associated with that type 0 search space. In this case, the UE 120 may monitor a selected type 0 search space associated with the selected waveform and receive the type 0 PDCCH communication that includes scheduling information for the RMSI associated with the selected waveform.

In some aspects, the SSB may be transmitted using a first waveform and selected waveform may be a second waveform that is different from the first waveform. For example, the first waveform may be an OFDM waveform, and the second waveform may be an OTFS waveform. Alternatively, the first waveform may be an OTFS waveform, and the second waveform may be an OFDM waveform.

As further shown in FIG. 12, and by reference number 1230, UE 120 may receive, from the base station 110, RMSI associated with the selected waveform. In some aspects, for each waveform for which a respective CORESET #0 (and/or a respective type 0 search space) is configured, the base station 110 may transmit respective RMSI associated with that waveform in a respective scheduled SIB1 transmission. Based at least in part on the scheduling information in the type 0 PDCCH communication received in the selected CORESET #0 (and/or the selected type 0 search space), the UE 120 may receive and decode the SIB1 including the RMSI associated with the selected waveform. In some aspects, the UE 120 may receive OSI associated with the selected waveform based at least in part on scheduling information included in the RMSI, and/or perform a RACH procedure to establish an RRC connection with the base station 110 using communications associated with the selected waveform based at least in part on the RMSI and/or the OSI.

As described above in connection with FIG. 12, the base station 110 may transmit SSBs using a single waveform, and based at least in part on receiving an SSB, the UE 120 may receive, from the base station 110, information identifying multiple CORESET #0s associated with different waveforms. The UE 120 may monitor a selected CORESET #0 associated with a selected waveform, and the UE 120 may receive, in the selected CORESET #0, a type 0 PDCCH communication that schedules transmission of system information associated with the selected waveform. As a result, the UE 120 may perform initial access using a preferred waveform. This may improve spectral efficiency, for UEs, such as ATG UEs in an ATG cell, which may lead to decreased latency and increased throughput of network traffic.

As indicated above, FIG. 12 is provided as an example. Other examples may differ from what is described with respect to FIG. 12.

FIG. 13 is a diagram illustrating an example process 1300 performed, for example, by a UE, in accordance with the present disclosure. Example process 1300 is an example where the UE (e.g., UE 120) performs operations associated with ATG signaling enhancement for initial access with multiple numerologies.

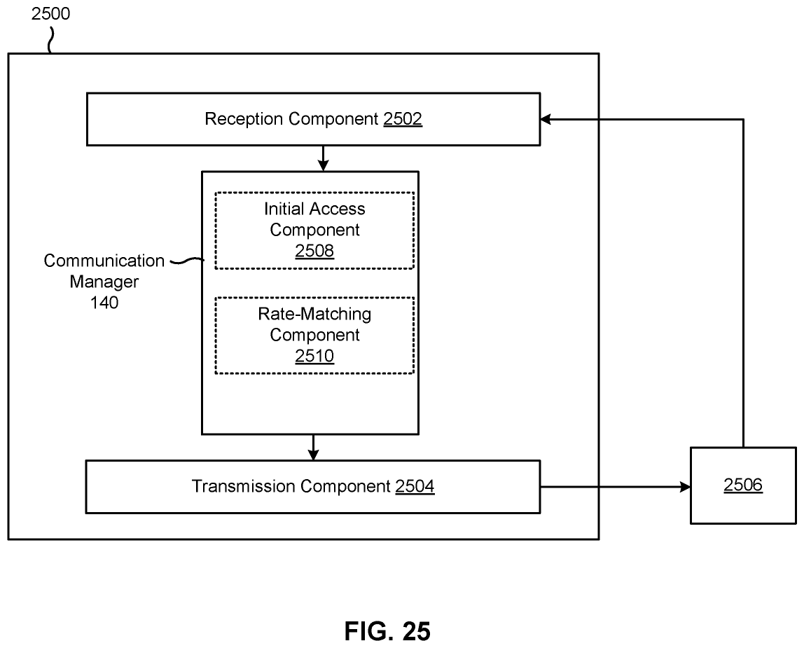

As shown in FIG. 13, in some aspects, process 1300 may include receiving an SSB associated with a first numerology (block 1310). For example, the UE (e.g., using communication manager 140 and/or reception component 2502, depicted in FIG. 25) may receive an SSB associated with a first numerology, as described above.

As further shown in FIG. 13, in some aspects, process 1300 may include receiving, from a base station and based at least in part on the SSB associated with the first numerology, information identifying time domain and frequency domain locations of one or more SSBs associated with a second numerology (block 1320). For example, the UE (e.g., using communication manager 140 and/or reception component 2502, depicted in FIG. 25) may receive, from a base station and based at least in part on the SSB associated with the first numerology, information identifying time domain and frequency domain locations of one or more SSBs associated with a second numerology, as described above.

Process 1300 may include additional aspects, such as any single aspect or any combination of aspects described below and/or in connection with one or more other processes described elsewhere herein.

In a first aspect, process 1300 includes performing an initial access procedure using an SSB of the one or more SSBs associated with the second numerology based at least in part on the information identifying the time domain and frequency domain locations of the one or more SSBs associated with the second numerology.

In a second aspect, alone or in combination with the first aspect, receiving the information identifying the time domain and frequency domain locations of the one or more SSBs associated with the second numerology includes receiving the information identifying the time domain and frequency domain locations of the one or more SSBs associated with the second numerology in system information included in an SIB transmitted using the first numerology.

In a third aspect, alone or in combination with one or more of the first and second aspects, the system information is at least one of RMSI or OSI.

In a fourth aspect, alone or in combination with one or more of the first through third aspects, receiving the information identifying the time domain and frequency domain locations of the one or more SSBs associated with the second numerology includes receiving, during a RACH procedure initiated based at least in part on the SSB associated with the first numerology, a message that includes the information identifying the time domain and frequency domain locations of the one or more SSBs associated with the second numerology.

In a fifth aspect, alone or in combination with one or more of the first through fourth aspects, the message is at least one of a Msg2 communication or a MsgB communication.

In a sixth aspect, alone or in combination with one or more of the first through fifth aspects, receiving the information identifying the time domain and frequency domain locations of the one or more SSBs associated with the second numerology includes receiving the information identifying the time domain and frequency domain locations of the one or more SSBs associated with the second numerology in at least one of an RRC message transmitted using the first numerology or a MAC-CE transmitted using the first numerology.

In a seventh aspect, alone or in combination with one or more of the first through sixth aspects, the information identifies the time domain and frequency domain locations of one or more nearest available SSBs associated with the second numerology.

In an eighth aspect, alone or in combination with one or more of the first through seventh aspects, process 1300 includes performing rate matching for a PDSCH communication associated with the first numerology using a rate matching pattern determined based at least in part on the time domain and frequency domain locations of the one or more SSBs associated with the second numerology.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a UE, in accordance with the present disclosure. Example process 1400 is an example where the UE (e.g., UE 120) performs operations associated with ATG signaling enhancement for initial access with multiple numerologies.

As shown in FIG. 14, in some aspects, process 1400 may include receiving an SSB associated with a first numerology (block 1410). For example, the UE (e.g., using communication manager 140 and/or reception component 2502, depicted in FIG. 25) may receive an SSB associated with a first numerology, as described above.

As further shown in FIG. 14, in some aspects, process 1400 may include receiving, from a base station and based at least in part on the SSB, system information transmitted using the first numerology (block 1420). For example, the UE (e.g., using communication manager 140 and/or reception component 2502, depicted in FIG. 25) may receive, from a base station and based at least in part on the SSB, system information transmitted using the first numerology, as described above.

As further shown in FIG. 14, in some aspects, process 1400 may include transmitting, to the base station, an indication of a second numerology that is a preferred numerology for the UE (block 1430). For example, the UE (e.g., using communication manager 140 and/or transmission component 2504, depicted in FIG. 25) may transmit, to the base station, an indication of a second numerology that is a preferred numerology for the UE, as described above.

Process 1400 may include additional aspects, such as any single aspect or any combination of aspects described below and/or in connection with one or more other processes described elsewhere herein.

In a first aspect, transmitting the indication of the second numerology includes transmitting, during a RACH procedure, a random access preamble communication that provides the indication of the second numerology.

In a second aspect, alone or in combination with the first aspect, the system information configures one or more dedicated RACH occasions associated with respective numerologies and transmitting the random access preamble communication that provides the indication of the second numerology includes transmitting the random access preamble communication in a dedicated RACH occasion associated with the second numerology.

In a third aspect, alone or in combination with one or more of the first and second aspects, the system information configures one or more dedicated random access preambles associated with respective numerologies and transmitting the random access preamble communication that provides the indication of the second numerology includes transmitting, in the random access preamble communication, a dedicated random access preamble associated with the second numerology.

In a fourth aspect, alone or in combination with one or more of the first through third aspects, communications subsequent to the random access preamble communication during the RACH procedure are scheduled with the second numerology.

In a fifth aspect, alone or in combination with one or more of the first through fourth aspects, transmitting the indication of the second numerology includes transmitting the indication of the second numerology, during a RACH procedure, in a Msg3 communication that is scheduled with the first numerology.

In a sixth aspect, alone or in combination with one or more of the first through fifth aspects, process 1400 includes receiving, during the RACH procedure and based at least in part on transmitting the indication of the second numerology in the Msg3 communication, a Msg4 communication that is scheduled with the second numerology.

In a seventh aspect, alone or in combination with one or more of the first through sixth aspects, transmitting the indication of the second numerology includes transmitting the indication of the second numerology, during a RACH procedure, in a MsgA PUSCH communication that is scheduled with the first numerology.

In an eighth aspect, alone or in combination with one or more of the first through seventh aspects, process 1400 includes receiving, during the RACH procedure and based at least in part on transmitting the indication of the second numerology in the MsgA PUSCH communication, a MsgB communication that is scheduled with the second numerology.

In a ninth aspect, alone or in combination with one or more of the first through eighth aspects, transmitting the indication of the second numerology includes transmitting, based at least in part on establishing an RRC connection with the base station via communications using the first numerology, the indication of the second numerology in at least one of an RRC message or a MAC-CE.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, by a UE, in accordance with the present disclosure. Example process 1500 is an example where the UE (e.g., UE 120) performs operations associated with ATG signaling enhancement for initial access with multiple numerologies.

As shown in FIG. 15, in some aspects, process 1500 may include receiving an SSB (block 1510). For example, the UE (e.g., using communication manager 140 and/or reception component 2502, depicted in FIG. 25) may receive an SSB, as described above.

As further shown in FIG. 15, in some aspects, process 1500 may include receiving, from a base station and based at least in part on the SSB, information identifying multiple CORESET #0s and/or type 0 search spaces associated with different numerologies (block 1520). For example, the UE (e.g., using communication manager 140 and/or reception component 2502, depicted in FIG. 25) may receive, from a base station and based at least in part on the SSB, information identifying multiple CORESET #0s and/or type 0 search spaces associated with different numerologies, as described above.

As further shown in FIG. 15, in some aspects, process 1500 may include receiving, from the base station, a type 0 PDCCH communication in a selected CORESET #0 and/or type 0 search space from the multiple CORESET #0s and/or type 0 search spaces, wherein the selected CORESET #0 and/or type 0 search space is associated with a selected numerology for the UE (block 1530). For example, the UE (e.g., using communication manager 140 and/or reception component 2502, depicted in FIG. 25) may receive, from the base station, a type 0 PDCCH communication in a selected CORESET #0 and/or type 0 search space from the multiple CORESET #0s and/or type 0 search spaces, wherein the selected CORESET #0 and/or type 0 search space is associated with a selected numerology for the UE, as described above.

Process 1500 may include additional aspects, such as any single aspect or any combination of aspects described below and/or in connection with one or more other processes described elsewhere herein.

In a first aspect, the SSB is associated with a first numerology and the selected CORESET #0 and/or type 0 search space is associated with a second numerology that is different from the first numerology.

In a second aspect, alone or in combination with the first aspect, receiving the information identifying the multiple CORESET #0s and/or type 0 search spaces includes receiving, based at least in part on the SSB, a master information block including the information identifying the multiple CORESET #0s and/or type 0 search spaces associated with the different numerologies.

In a third aspect, alone or in combination with one or more of the first and second aspects, the information includes information identifying multiple CORESET #0s, associated with an index of the SSB, that are associated with different numerologies.

In a fourth aspect, alone or in combination with one or more of the first through third aspects, receiving the type 0 PDCCH communication includes receiving the type 0 PDCCH communication in a selected CORESET #0 from the multiple CORESET #0s associated with the index of the SSB, and the selected CORESET #0 is associated with the selected numerology for the UE.

In a fifth aspect, alone or in combination with one or more of the first through fourth aspects, the multiple CORESET #0s associated with the index of the SSB are time division multiplexed.

In a sixth aspect, alone or in combination with one or more of the first through fifth aspects, the information is included in a master information block, and the information includes an indication of a time division multiplexing pattern for the multiple CORESET #0s associated with the index of the SSB.

In a seventh aspect, alone or in combination with one or more of the first through sixth aspects, the multiple CORESET #0s associated with the index of the SSB are frequency division multiplexed.

In an eighth aspect, alone or in combination with one or more of the first through seventh aspects, the information is included in a master information block, and the information includes an indication of a frequency division multiplexing pattern for the multiple CORESET #0s associated with the index of the SSB.

In a ninth aspect, alone or in combination with one or more of the first through eighth aspects, the information identifies multiple type 0 search spaces for a CORESET #0 associated with an index of the SSB.

In a tenth aspect, alone or in combination with one or more of the first through ninth aspects, process 1500 includes receiving, from the base station, an SIB scheduled by the type 0 PDCCH communication, and the SIB includes RMSI associated with the selected numerology.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram illustrating an example process 1600 performed, for example, by a base station, in accordance with the present disclosure. Example process 1600 is an example where the base station (e.g., base station 110) performs operations associated with ATG signaling enhancement for initial access with multiple numerologies.

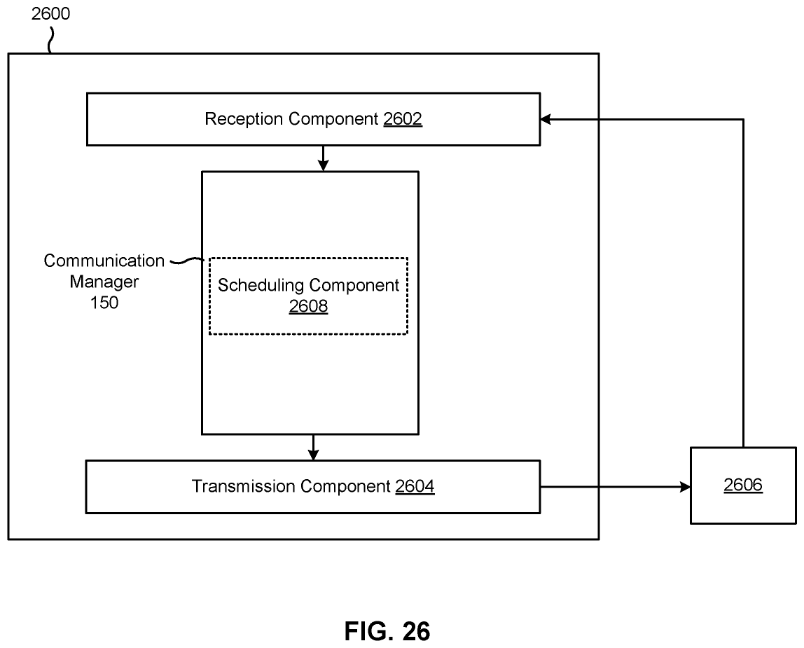

As shown in FIG. 16, in some aspects, process 1600 may include transmitting first SSBs associated with a first numerology and second SSBs associated with a second numerology (block 1610). For example, the base station (e.g., using communication manager 150 and/or transmission component 2604, depicted in FIG. 26) may transmit first SSBs associated with a first numerology and second SSBs associated with a second numerology, as described above.

As further shown in FIG. 16, in some aspects, process 1600 may include transmitting information associated with the first SSBs that identifies time domain and frequency domain locations of one or more of the second SSBs (block 1620). For example, the base station (e.g., using communication manager 150 and/or transmission component 2604, depicted in FIG. 26) may transmit information associated with the first SSBs that identifies time domain and frequency domain locations of one or more of the second SSBs, as described above.

Process 1600 may include additional aspects, such as any single aspect or any combination of aspects described below and/or in connection with one or more other processes described elsewhere herein.

In a first aspect, process 1600 includes transmitting information associated with the second SSBs that identifies locations of one or more of the first SSBs.

In a second aspect, alone or in combination with the first aspect, transmitting the information associated with the first SSBs that identifies the time domain and frequency domain locations of the one or more of the second SSBs includes transmitting the information that identifies the time domain and frequency domain locations of the one or more second SSBs in system information included in an SIB associated with the first numerology.

In a third aspect, alone or in combination with one or more of the first and second aspects, the system information is at least one of RMSI or OSI.

In a fourth aspect, alone or in combination with one or more of the first through third aspects, transmitting the information associated with the first SSBs that identifies the time domain and frequency domain locations of the one or more of the second SSBs includes transmitting, during a RACH procedure, a message that includes the information that identifies the time domain and frequency domain locations of the one or more second SSBs.

In a fifth aspect, alone or in combination with one or more of the first through fourth aspects, the message is at least one of a Msg2 communication or a MsgB communication.

In a sixth aspect, alone or in combination with one or more of the first through fifth aspects, transmitting the information associated with the first SSBs that identifies the time domain and frequency domain locations of the one or more of the second SSBs includes transmitting the information that identifies the time domain and frequency domain locations of the one or more second SSBs in at least one of an RRC message or a MAC-CE.

In a seventh aspect, alone or in combination with one or more of the first through sixth aspects, the information identifies the time domain and frequency domain locations of one or more nearest available second SSBs.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram illustrating an example process 1700 performed, for example, by a base station, in accordance with the present disclosure. Example process 1700 is an example where the base station (e.g., base station 110) performs operations associated with ATG signaling enhancement for initial access with multiple numerologies.

As shown in FIG. 17, in some aspects, process 1700 may include transmitting an SSB associated with a first numerology (block 1710). For example, the base station (e.g., using communication manager 150 and/or transmission component 2604, depicted in FIG. 26) may transmit an SSB associated with a first numerology, as described above.

As further shown in FIG. 17, in some aspects, process 1700 may include transmitting system information using the first numerology (block 1720). For example, the base station (e.g., using communication manager 150 and/or transmission component 2604, depicted in FIG. 26) may transmit system information using the first numerology, as described above.

As further shown in FIG. 17, in some aspects, process 1700 may include receiving, from a UE, an indication of a second numerology that is a preferred numerology for the UE (block 1730). For example, the base station (e.g., using communication manager 150 and/or reception component 2602, depicted in FIG. 26) may receive, from a UE, an indication of a second numerology that is a preferred numerology for the UE, as described above.

Process 1700 may include additional aspects, such as any single aspect or any combination of aspects described below and/or in connection with one or more other processes described elsewhere herein.

In a first aspect, receiving the indication of the second numerology includes receiving, during a RACH procedure, a random access preamble communication that provides the indication of the second numerology.

In a second aspect, alone or in combination with the first aspect, the system information configures one or more dedicated RACH occasions associated with respective numerologies and receiving the random access preamble communication that provides the indication of the second numerology includes receiving the random access preamble communication in a dedicated RACH occasion associated with the second numerology.

In a third aspect, alone or in combination with one or more of the first and second aspects, the system information configures one or more dedicated random access preambles associated with respective numerologies and receiving the random access preamble communication that provides the indication of the second numerology includes receiving, in the random access preamble communication, a dedicated random access preamble associated with the second numerology.

In a fourth aspect, alone or in combination with one or more of the first through third aspects, process 1700 includes scheduling, during the RACH procedure, communications subsequent to the random access preamble communication with the second numerology.

In a fifth aspect, alone or in combination with one or more of the first through fourth aspects, receiving the indication of the second numerology includes receiving the indication of the second numerology, during a RACH procedure, in a Msg3 communication that is scheduled with the first numerology.

In a sixth aspect, alone or in combination with one or more of the first through fifth aspects, process 1700 includes transmitting, to the UE, during the RACH procedure and based at least in part on receiving the indication of the second numerology in the Msg3 communication, a Msg4 communication that is scheduled with the second numerology.

In a seventh aspect, alone or in combination with one or more of the first through sixth aspects, receiving the indication of the second numerology includes receiving the indication of the second numerology, during a RACH procedure, in a MsgA PUSCH communication that is scheduled with the first numerology.

In an eighth aspect, alone or in combination with one or more of the first through seventh aspects, process 1700 includes transmitting, to the UE, during the RACH procedure and based at least in part on receiving the indication of the second numerology in the MsgA PUSCH communication, a MsgB communication that is scheduled with the second numerology.

In a ninth aspect, alone or in combination with one or more of the first through eighth aspects, receiving the indication of the second numerology includes receiving, based at least in part on establishing an RRC connection with the UE via communications using the first numerology, the indication of the second numerology in at least one of an RRC message or a MAC-CE.

Although FIG. 17 shows example blocks of process 1700, in some aspects, process 1700 may include additional blocks, fewer blocks, different blocks, or differently arranged blocks than those depicted in FIG. 17. Additionally, or alternatively, two or more of the blocks of process 1700 may be performed in parallel.

FIG. 18 is a diagram illustrating an example process 1800 performed, for example, by a base station, in accordance with the present disclosure. Example process 1800 is an example where the base station (e.g., base station 110) performs operations associated with ATG signaling enhancement for initial access with multiple numerologies.

As shown in FIG. 18, in some aspects, process 1800 may include transmitting an SSB (block 1810). For example, the base station (e.g., using communication manager 150 and/or transmission component 2604, depicted in FIG. 26) may transmit an SSB, as described above.

As further shown in FIG. 18, in some aspects, process 1800 may include transmitting information associated with the SSB that identifies multiple CORESET #0s and/or type 0 search spaces associated with different numerologies (block 1820). For example, the base station (e.g., using communication manager 150 and/or transmission component 2604, depicted in FIG. 26) may transmit information associated with the SSB that identifies multiple CORESET #0s and/or type 0 search spaces associated with different numerologies, as described above.

As further shown in FIG. 18, in some aspects, process 1800 may include transmitting, in each CORESET #0 and/or type 0 search space of the multiple CORESET #0s and/or type 0 search spaces, a respective type 0 PDCCH communication that schedules transmission of system information based at least in part on a numerology associated with that CORESET #0 and/or type 0 search space (block 1830). For example, the base station (e.g., using communication manager 150 and/or transmission component 2604, depicted in FIG. 26) may transmit, in each CORESET #0 and/or type 0 search space of the multiple CORESET #0s and/or type 0 search spaces, a respective type 0 PDCCH communication that schedules transmission of system information based at least in part on a numerology associated with that CORESET #0 and/or type 0 search space, as described above.

Process 1800 may include additional aspects, such as any single aspect or any combination of aspects described below and/or in connection with one or more other processes described elsewhere herein.

In a first aspect, transmitting the information identifying the multiple CORESET #0s and/or type 0 search spaces includes transmitting the information identifying the multiple CORESET #0s and/or type 0 search spaces associated with the different numerologies in a master information block associated with the SSB.

In a second aspect, alone or in combination with the first aspect, the information includes information identifying multiple CORESET #0s, associated with an index of the SSB, that are associated with different numerologies.

In a third aspect, alone or in combination with one or more of the first and second aspects, the multiple CORESET #0s associated with the index of the SSB are time division multiplexed.

In a fourth aspect, alone or in combination with one or more of the first through third aspects, the information is included in a master information block, and the information includes an indication of a time division multiplexing pattern for the multiple CORESET #0s associated with the index of the SSB.

In a fifth aspect, alone or in combination with one or more of the first through fourth aspects, the multiple CORESET #0s associated with the index of the SSB are frequency division multiplexed.

In a sixth aspect, alone or in combination with one or more of the first through fifth aspects, the information is included in a master information block, and the information includes an indication of a frequency division multiplexing pattern for the multiple CORESET #0s associated with the index of the SSB.

In a seventh aspect, alone or in combination with one or more of the first through sixth aspects, the information identifies multiple type 0 search spaces for a CORESET #0 associated with an index of the SSB.

Although FIG. 18 shows example blocks of process 1800, in some aspects, process 1800 may include additional blocks, fewer blocks, different blocks, or differently arranged blocks than those depicted in FIG. 18. Additionally, or alternatively, two or more of the blocks of process 1800 may be performed in parallel.

FIG. 19 is a diagram illustrating an example process 1900 performed, for example, by a UE, in accordance with the present disclosure. Example process 1900 is an example where the UE (e.g., UE 120) performs operations associated with ATG signaling enhancement for initial access with multiple waveforms.

As shown in FIG. 19, in some aspects, process 1900 may include receiving an SSB associated with a first waveform (block 1910). For example, the UE (e.g., using communication manager 140 and/or reception component 2502, depicted in FIG. 25) may receive an SSB associated with a first waveform, as described above.

As further shown in FIG. 19, in some aspects, process 1900 may include receiving, from a base station and based at least in part on the SSB associated with the first waveform, information identifying time domain and frequency domain locations of one or more SSBs associated with a second waveform (block 1920). For example, the UE (e.g., using communication manager 140 and/or reception component 2502, depicted in FIG. 25) may receive, from a base station and based at least in part on the SSB associated with the first waveform, information identifying time domain and frequency domain locations of one or more SSBs associated with a second waveform, as described above.

Process 1900 may include additional aspects, such as any single aspect or any combination of aspects described below and/or in connection with one or more other processes described elsewhere herein.

In a first aspect, process 1900 includes performing an initial access procedure using an SSB of the one or more SSBs associated with the second waveform based at least in part on the information identifying the time domain and frequency domain locations of the one or more SSBs associated with the second waveform.

In a second aspect, alone or in combination with the first aspect, receiving the information identifying the time domain and frequency domain locations of the one or more SSBs associated with the second waveform includes receiving the information identifying the time domain and frequency domain locations of the one or more SSBs associated with the second waveform in system information included in an SIB transmitted using the first waveform.

In a third aspect, alone or in combination with one or more of the first and second aspects, the system information is at least one of RMSI or OSI.

In a fourth aspect, alone or in combination with one or more of the first through third aspects, receiving the information identifying the time domain and frequency domain locations of the one or more SSBs associated with the second waveform includes receiving, during a RACH procedure initiated based at least in part on the SSB associated with the first waveform, a message that includes the information identifying the time domain and frequency domain locations of the one or more SSBs associated with the second waveform.

In a fifth aspect, alone or in combination with one or more of the first through fourth aspects, the message is at least one of a Msg2 communication or a MsgB communication.

In a sixth aspect, alone or in combination with one or more of the first through fifth aspects, receiving the information identifying the time domain and frequency domain locations of the one or more SSBs associated with the second waveform includes receiving the information identifying the time domain and frequency domain locations of the one or more SSBs associated with the second waveform in at least one of an RRC message transmitted using the first waveform or a MAC-CE transmitted using the first waveform.

In a seventh aspect, alone or in combination with one or more of the first through sixth aspects, the information identifies the time domain and frequency domain locations of one or more nearest available SSBs associated with the second waveform.

In an eighth aspect, alone or in combination with one or more of the first through seventh aspects, process 1900 includes performing rate matching for a PDSCH communication associated with the first waveform using a rate matching pattern determined based at least in part on the time domain and frequency domain locations of the one or more SSBs associated with the second waveform.

Although FIG. 19 shows example blocks of process 1900, in some aspects, process 1900 may include additional blocks, fewer blocks, different blocks, or differently arranged blocks than those depicted in FIG. 19. Additionally, or alternatively, two or more of the blocks of process 1900 may be performed in parallel.

FIG. 20 is a diagram illustrating an example process 2000 performed, for example, by a UE, in accordance with the present disclosure. Example process 2000 is an example where the UE (e.g., UE 120) performs operations associated with ATG signaling enhancement for initial access with multiple waveforms.

As shown in FIG. 20, in some aspects, process 2000 may include receiving an SSB associated with a first waveform (block 2010). For example, the UE (e.g., using communication manager 140 and/or reception component 2502, depicted in FIG. 25) may receive an SSB associated with a first waveform, as described above.

As further shown in FIG. 20, in some aspects, process 2000 may include receiving, from a base station and based at least in part on the SSB, system information transmitted using the first waveform (block 2020). For example, the UE (e.g., using communication manager 140 and/or reception component 2502, depicted in FIG. 25) may receive, from a base station and based at least in part on the SSB, system information transmitted using the first waveform, as described above.

As further shown in FIG. 20, in some aspects, process 2000 may include transmitting, to the base station, an indication of a second waveform that is a preferred waveform for the UE (block 2030). For example, the UE (e.g., using communication manager 140 and/or transmission component 2504, depicted in FIG. 25) may transmit, to the base station, an indication of a second waveform that is a preferred waveform for the UE, as described above.

Process 2000 may include additional aspects, such as any single aspect or any combination of aspects described below and/or in connection with one or more other processes described elsewhere herein.

In a first aspect, transmitting the indication of the second waveform includes transmitting, during a RACH procedure, a random access preamble communication that provides the indication of the second waveform.

In a second aspect, alone or in combination with the first aspect, the system information configures one or more dedicated RACH occasions associated with respective waveforms and transmitting the random access preamble communication that provides the indication of the second waveform includes transmitting the random access preamble communication in a dedicated RACH occasion associated with the second waveform.

In a third aspect, alone or in combination with one or more of the first and second aspects, the system information configures one or more dedicated random access preambles associated with respective waveforms and transmitting the random access preamble communication that provides the indication of the second waveform includes transmitting, in the random access preamble communication, a dedicated random access preamble associated with the second waveform.

In a fourth aspect, alone or in combination with one or more of the first through third aspects, communications subsequent to the random access preamble communication during the RACH procedure are scheduled with the second waveform.

In a fifth aspect, alone or in combination with one or more of the first through fourth aspects, transmitting the indication of the second waveform includes transmitting the indication of the second waveform, during a RACH procedure, in a Msg3 communication that is scheduled with the first waveform.

In a sixth aspect, alone or in combination with one or more of the first through fifth aspects, process 2000 includes receiving, during the RACH procedure and based at least in part on transmitting the indication of the second waveform in the Msg3 communication, a Msg4 communication that is scheduled with the second waveform.

In a seventh aspect, alone or in combination with one or more of the first through sixth aspects, transmitting the indication of the second waveform includes transmitting the indication of the second waveform, during a RACH procedure, in a MsgA PUSCH communication that is scheduled with the first waveform.

In an eighth aspect, alone or in combination with one or more of the first through seventh aspects, process 2000 includes receiving, during the RACH procedure and based at least in part on transmitting the indication of the second waveform in the MsgA PUSCH communication, a MsgB communication that is scheduled with the second waveform.

In a ninth aspect, alone or in combination with one or more of the first through eighth aspects, transmitting the indication of the second waveform includes transmitting, based at least in part on establishing an RRC connection with the base station via communications using the first waveform, the indication of the second waveform in at least one of an RRC message or a MAC-CE.

Although FIG. 20 shows example blocks of process 2000, in some aspects, process 2000 may include additional blocks, fewer blocks, different blocks, or differently arranged blocks than those depicted in FIG. 20. Additionally, or alternatively, two or more of the blocks of process 2000 may be performed in parallel.

FIG. 21 is a diagram illustrating an example process 2100 performed, for example, by a UE, in accordance with the present disclosure. Example process 2100 is an example where the UE (e.g., UE 120) performs operations associated with ATG signaling enhancement for initial access with multiple waveforms.

As shown in FIG. 21, in some aspects, process 2100 may include receiving an SSB (block 2110). For example, the UE (e.g., using communication manager 140 and/or reception component 2508, depicted in FIG. 25) may receive an SSB, as described above.

As further shown in FIG. 21, in some aspects, process 2100 may include receiving, from a base station and based at least in part on the SSB, information identifying multiple CORESET #0s and/or type 0 search spaces associated with different waveforms (block 2120). For example, the UE (e.g., using communication manager 140 and/or reception component 2502, depicted in FIG. 25) may receive, from a base station and based at least in part on the SSB, information identifying multiple CORESET #0s and/or type 0 search spaces associated with different waveforms, as described above.

As further shown in FIG. 21, in some aspects, process 2100 may include receiving, from the base station, a type 0 PDCCH communication in a selected CORESET #0 and/or type 0 search space from the multiple CORESET #0s and/or type 0 search spaces, wherein the selected CORESET #0 and/or type 0 search space is associated with a selected waveform for the UE (block 2130). For example, the UE (e.g., using communication manager 140 and/or reception component 2502, depicted in FIG. 25) may receive, from the base station, a type 0 PDCCH communication in a selected CORESET #0 and/or type 0 search space from the multiple CORESET #0s and/or type 0 search spaces, wherein the selected CORESET #0 and/or type 0 search space is associated with a selected waveform for the UE, as described above.

Process 2100 may include additional aspects, such as any single aspect or any combination of aspects described below and/or in connection with one or more other processes described elsewhere herein.

In a first aspect, the SSB is associated with a first waveform and the selected CORESET #0 and/or type 0 search space is associated with a second waveform that is different from the first waveform.

In a second aspect, alone or in combination with the first aspect, receiving the information identifying the multiple CORESET #0s and/or type 0 search spaces includes receiving, based at least in part on the SSB, a master information block including the information identifying the multiple CORESET #0s and/or type 0 search spaces associated with the different waveforms.

In a third aspect, alone or in combination with one or more of the first and second aspects, the information includes information identifying multiple CORESET #0s, associated with an index of the SSB, that are associated with different waveforms.

In a fourth aspect, alone or in combination with one or more of the first through third aspects, receiving the type 0 PDCCH communication includes receiving the type 0 PDCCH communication in a selected CORESET #0 from the multiple CORESET #0s associated with the index of the SSB, and the selected CORESET #0 is associated with the selected waveform for the UE.

In a fifth aspect, alone or in combination with one or more of the first through fourth aspects, the multiple CORESET #0s associated with the index of the SSB are time division multiplexed.

In a sixth aspect, alone or in combination with one or more of the first through fifth aspects, the information is included in a master information block, and the information includes an indication of a time division multiplexing pattern for the multiple CORESET #0s associated with the index of the SSB.

In a seventh aspect, alone or in combination with one or more of the first through sixth aspects, the multiple CORESET #0s associated with the index of the SSB are frequency division multiplexed.

In an eighth aspect, alone or in combination with one or more of the first through seventh aspects, the information is included in a master information block, and the information includes an indication of a frequency division multiplexing pattern for the multiple CORESET #0s associated with the index of the SSB.

In a ninth aspect, alone or in combination with one or more of the first through eighth aspects, the information identifies multiple type 0 search spaces for a CORESET #0 associated with an index of the SSB.

In a tenth aspect, alone or in combination with one or more of the first through ninth aspects, process 2100 includes receiving, from the base station, an SIB scheduled by the type 0 PDCCH communication, and the SIB includes RMSI associated with the selected waveform.

Although FIG. 21 shows example blocks of process 2100, in some aspects, process 2100 may include additional blocks, fewer blocks, different blocks, or differently arranged blocks than those depicted in FIG. 21. Additionally, or alternatively, two or more of the blocks of process 2100 may be performed in parallel.

FIG. 22 is a diagram illustrating an example process 2200 performed, for example, by a base station, in accordance with the present disclosure. Example process 2200 is an example where the base station (e.g., base station 110) performs operations associated with ATG signaling enhancement for initial access with multiple waveforms.

As shown in FIG. 22, in some aspects, process 2200 may include transmitting first SSBs associated with a first waveform and second SSBs associated with a second waveform (block 2210). For example, the base station (e.g., using communication manager 150 and/or transmission component 2604, depicted in FIG. 26) may transmit first SSBs associated with a first waveform and second SSBs associated with a second waveform, as described above.

As further shown in FIG. 22, in some aspects, process 2200 may include transmitting information associated with the first SSBs that identifies time domain and frequency domain locations of one or more of the second SSBs (block 2220). For example, the base station (e.g., using communication manager 150 and/or transmission component 2604, depicted in FIG. 26) may transmit information associated with the first SSBs that identifies time domain and frequency domain locations of one or more of the second SSBs, as described above.

Process 2200 may include additional aspects, such as any single aspect or any combination of aspects described below and/or in connection with one or more other processes described elsewhere herein.

In a first aspect, process 2200 includes transmitting information associated with the second SSBs that identifies locations of one or more of the first SSBs.

In a second aspect, alone or in combination with the first aspect, transmitting the information associated with the first SSBs that identifies the time domain and frequency domain locations of the one or more of the second SSBs includes transmitting the information that identifies the time domain and frequency domain locations of the one or more second SSBs in system information included in an SIB associated with the first waveform.

In a third aspect, alone or in combination with one or more of the first and second aspects, the system information is at least one of RMSI or OSI.

In a fourth aspect, alone or in combination with one or more of the first through third aspects, transmitting the information associated with the first SSBs that identifies the time domain and frequency domain locations of the one or more of the second SSBs includes transmitting, during a RACH procedure, a message that includes the information that identifies the time domain and frequency domain locations of the one or more second SSBs.

In a fifth aspect, alone or in combination with one or more of the first through fourth aspects, the message is at least one of a Msg2 communication or a MsgB communication.

In a sixth aspect, alone or in combination with one or more of the first through fifth aspects, transmitting the information associated with the first SSBs that identifies the time domain and frequency domain locations of the one or more of the second SSBs includes transmitting the information that identifies the time domain and frequency domain locations of the one or more second SSBs in at least one of an RRC message or a MAC-CE.

In a seventh aspect, alone or in combination with one or more of the first through sixth aspects, the information identifies the time domain and frequency domain locations of one or more nearest available second SSBs.

Although FIG. 22 shows example blocks of process 2200, in some aspects, process 2200 may include additional blocks, fewer blocks, different blocks, or differently arranged blocks than those depicted in FIG. 22. Additionally, or alternatively, two or more of the blocks of process 2200 may be performed in parallel.

FIG. 23 is a diagram illustrating an example process 2300 performed, for example, by a base station, in accordance with the present disclosure. Example process 2300 is an example where the base station (e.g., base station 110) performs operations associated with ATG signaling enhancement for initial access with multiple waveforms.

As shown in FIG. 23, in some aspects, process 2300 may include transmitting an SSB associated with a first waveform (block 2310). For example, the base station (e.g., using communication manager 150 and/or transmission component 2604, depicted in FIG. 26) may transmit an SSB associated with a first waveform, as described above.

As further shown in FIG. 23, in some aspects, process 2300 may include transmitting system information using the first waveform (block 2320). For example, the base station (e.g., using communication manager 150 and/or transmission component 2604, depicted in FIG. 26) may transmit system information using the first waveform, as described above.

As further shown in FIG. 23, in some aspects, process 2300 may include receiving, from a UE, an indication of a second waveform that is a preferred waveform for the UE (block 2330). For example, the base station (e.g., using communication manager 150 and/or reception component 2602, depicted in FIG. 26) may receive, from a UE, an indication of a second waveform that is a preferred waveform for the UE, as described above.

Process 2300 may include additional aspects, such as any single aspect or any combination of aspects described below and/or in connection with one or more other processes described elsewhere herein.

In a first aspect, receiving the indication of the second waveform includes receiving, during a RACH procedure, a random access preamble communication that provides the indication of the second waveform.

In a second aspect, alone or in combination with the first aspect, the system information configures one or more dedicated RACH occasions associated with respective waveforms and receiving the random access preamble communication that provides the indication of the second waveform includes receiving the random access preamble communication in a dedicated RACH occasion associated with the second waveform.

In a third aspect, alone or in combination with one or more of the first and second aspects, the system information configures one or more dedicated random access preambles associated with respective waveforms and receiving the random access preamble communication that provides the indication of the second waveform includes receiving, in the random access preamble communication, a dedicated random access preamble associated with the second waveform.

In a fourth aspect, alone or in combination with one or more of the first through third aspects, process 2300 includes scheduling, during the RACH procedure, communications subsequent to the random access preamble communication with the second waveform.

In a fifth aspect, alone or in combination with one or more of the first through fourth aspects, receiving the indication of the second waveform includes receiving the indication of the second waveform, during a RACH procedure, in a Msg3 communication that is scheduled with the first waveform.

In a sixth aspect, alone or in combination with one or more of the first through fifth aspects, process 2300 includes transmitting, to the UE, during the RACH procedure and based at least in part on receiving the indication of the second waveform in the Msg3 communication, a Msg4 communication that is scheduled with the second waveform.

In a seventh aspect, alone or in combination with one or more of the first through sixth aspects, receiving the indication of the second waveform includes receiving the indication of the second waveform, during a RACH procedure, in a MsgA PUSCH communication that is scheduled with the first waveform.

In an eighth aspect, alone or in combination with one or more of the first through seventh aspects, process 2300 includes transmitting, to the UE, during the RACH procedure and based at least in part on receiving the indication of the second waveform in the MsgA PUSCH communication, a MsgB communication that is scheduled with the second waveform.

In a ninth aspect, alone or in combination with one or more of the first through eighth aspects, receiving the indication of the second waveform includes receiving, based at least in part on establishing an RRC connection with the UE via communications using the first waveform, the indication of the second waveform in at least one of an RRC message or a MAC-CE.

Although FIG. 23 shows example blocks of process 2300, in some aspects, process 2300 may include additional blocks, fewer blocks, different blocks, or differently arranged blocks than those depicted in FIG. 23. Additionally, or alternatively, two or more of the blocks of process 2300 may be performed in parallel.

FIG. 24 is a diagram illustrating an example process 2400 performed, for example, by a base station, in accordance with the present disclosure. Example process 2400 is an example where the base station (e.g., base station 110) performs operations associated with ATG signaling enhancement for initial access with multiple waveforms.

As shown in FIG. 24, in some aspects, process 2400 may include transmitting an SSB (block 2410). For example, the base station (e.g., using communication manager 150 and/or transmission component 2604, depicted in FIG. 26) may transmit an SSB, as described above.

As further shown in FIG. 24, in some aspects, process 2400 may include transmitting information associated with the SSB that identifies multiple CORESET #0s and/or type 0 search spaces associated with different waveforms (block 2420). For example, the base station (e.g., using communication manager 150 and/or transmission component 2604, depicted in FIG. 26) may transmit information associated with the SSB that identifies multiple CORESET #0s and/or type 0 search spaces associated with different waveforms, as described above.

As further shown in FIG. 24, in some aspects, process 2400 may include transmitting, in each CORESET #0 and/or type 0 search space of the multiple CORESET #0s and/or type 0 search spaces, a respective type 0 PDCCH communication that schedules transmission of system information based at least in part on a waveform associated with that CORESET #0 and/or type 0 search space (block 2430). For example, the base station (e.g., using communication manager 150 and/or transmission component 2604, depicted in FIG. 26) may transmit, in each CORESET #0 and/or type 0 search space of the multiple CORESET #0s and/or type 0 search spaces, a respective type 0 PDCCH communication that schedules transmission of system information based at least in part on a waveform associated with that CORESET #0 and/or type 0 search space, as described above.

Process 2400 may include additional aspects, such as any single aspect or any combination of aspects described below and/or in connection with one or more other processes described elsewhere herein.

In a first aspect, transmitting the information identifying the multiple CORESET #0s and/or type 0 search spaces includes transmitting the information identifying the multiple CORESET #0s and/or type 0 search spaces associated with the different numerologies in a master information block associated with the SSB.

In a second aspect, alone or in combination with the first aspect, the information includes information identifying multiple CORESET #0s, associated with an index of the SSB, that are associated with different numerologies.

In a third aspect, alone or in combination with one or more of the first and second aspects, the multiple CORESET #0s associated with the index of the SSB are time division multiplexed.

In a fourth aspect, alone or in combination with one or more of the first through third aspects, the information is included in a master information block, and the information includes an indication of a time division multiplexing pattern for the multiple CORESET #0s associated with the index of the SSB.

In a fifth aspect, alone or in combination with one or more of the first through fourth aspects, the multiple CORESET #0s associated with the index of the SSB are frequency division multiplexed.

In a sixth aspect, alone or in combination with one or more of the first through fifth aspects, the information is included in a master information block, and the information includes an indication of a frequency division multiplexing pattern for the multiple CORESET #0s associated with the index of the SSB.

In a seventh aspect, alone or in combination with one or more of the first through sixth aspects, the information identifies multiple type 0 search spaces for a CORESET #0 associated with an index of the SSB.

Although FIG. 24 shows example blocks of process 2400, in some aspects, process 2400 may include additional blocks, fewer blocks, different blocks, or differently arranged blocks than those depicted in FIG. 24. Additionally, or alternatively, two or more of the blocks of process 2400 may be performed in parallel.

FIG. 25 is a block diagram of an example apparatus 2500 for wireless communication. The apparatus 2500 may be a UE, or a UE may include the apparatus 2500. In some aspects, the apparatus 2500 includes a reception component 2502 and a transmission component 2504, which may be in communication with one another (for example, via one or more buses and/or one or more other components). As shown, the apparatus 2500 may communicate with another apparatus 2506 (such as a UE, a base station, or another wireless communication device) using the reception component 2502 and the transmission component 2504. As further shown, the apparatus 2500 may include the communication manager 140. The communication manager 140 may include one or more of an initial access component 2508 or a rate-matching component 2510, among other examples.

In some aspects, the apparatus 2500 may be configured to perform one or more operations described herein in connection with FIGS. 5-12. Additionally, or alternatively, the apparatus 2500 may be configured to perform one or more processes described herein, such as process 1300 of FIG. 13, process 1400 of FIG. 14, process 1500 of FIG. 15, process 1900 of FIG. 19, process 2000 of FIG. 20, process 2100 of FIG. 21, or a combination thereof. In some aspects, the apparatus 2500 and/or one or more components shown in FIG. 25 may include one or more components of the UE described in connection with FIG. 2. Additionally, or alternatively, one or more components shown in FIG. 25 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2502 may receive communications, such as reference signals, control information, data communications, or a combination thereof, from the apparatus 2506. The reception component 2502 may provide received communications to one or more other components of the apparatus 2500. In some aspects, the reception component 2502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2506. In some aspects, the reception component 2502 may include one or more antennas, a demodulator, a MIMO detector, a receive processor, a controller/processor, a memory, or a combination thereof, of the UE described in connection with FIG. 2.

The transmission component 2504 may transmit communications, such as reference signals, control information, data communications, or a combination thereof, to the apparatus 2506. In some aspects, one or more other components of the apparatus 2506 may generate communications and may provide the generated communications to the transmission component 2504 for transmission to the apparatus 2506. In some aspects, the transmission component 2504 may perform signal processing on the generated communications (such as filtering, amplification, modulation, digital-to-analog conversion, multiplexing, interleaving, mapping, or encoding, among other examples), and may transmit the processed signals to the apparatus 2506. In some aspects, the transmission component 2504 may include one or more antennas, a modulator, a transmit MIMO processor, a transmit processor, a controller/processor, a memory, or a combination thereof, of the UE described in connection with FIG. 2. In some aspects, the transmission component 2504 may be co-located with the reception component 2502 in a transceiver.

The reception component 2502 may receive an SSB associated with a first numerology. The reception component 2502 may receive, from a base station and based at least in part on the SSB associated with the first numerology, information identifying time domain and frequency domain locations of one or more SSBs associated with a second numerology.

The initial access component 2508 may perform an initial access procedure using an SSB of the one or more SSBs associated with the second numerology based at least in part on the information identifying the time domain and frequency domain locations of the one or more SSBs associated with the second numerology.

The rate-matching component 2510 may perform rate matching for a PDSCH communication associated with the first numerology using a rate matching pattern determined based at least in part on the time domain and frequency domain locations of the one or more SSBs associated with the second numerology.

The reception component 2502 may receive an SSB associated with a first numerology. The reception component 2502 may receive, from a base station and based at least in part on the SSB, system information transmitted using the first numerology. The transmission component 2504 may transmit, to the base station, an indication of a second numerology that is a preferred numerology for the UE.

The reception component 2502 may receive, during the RACH procedure and based at least in part on transmitting the indication of the second numerology in the Msg3 communication, a Msg4 communication that is scheduled with the second numerology.

The reception component 2502 may receive, during the RACH procedure and based at least in part on transmitting the indication of the second numerology in the MsgA PUSCH communication, a MsgB communication that is scheduled with the second numerology.

The reception component 2502 may receive an SSB. The reception component 2502 may receive, from a base station and based at least in part on the SSB, information identifying multiple CORESET #0s and/or type 0 search spaces associated with different numerologies. The reception component 2502 may receive, from the base station, a type 0 PDCCH communication in a selected CORESET #0 and/or type 0 search space from the multiple CORESET #0s and/or type 0 search spaces, wherein the selected CORESET #0 and/or type 0 search space is associated with a selected numerology for the UE.

The reception component 2502 may receive, from the base station, an SIB scheduled by the type 0 PDCCH communication, wherein the SIB includes RMSI associated with the selected numerology.

The reception component 2502 may receive an SSB associated with a first waveform. The reception component 2502 may receive, from a base station and based at least in part on the SSB associated with the first waveform, information identifying time domain and frequency domain locations of one or more SSBs associated with a second waveform.

The initial access component 2508 may perform an initial access procedure using an SSB of the one or more SSBs associated with the second waveform based at least in part on the information identifying the time domain and frequency domain locations of the one or more SSBs associated with the second waveform.

The rate-matching component 2510 may perform rate matching for a PDSCH communication associated with the first waveform using a rate matching pattern determined based at least in part on the time domain and frequency domain locations of the one or more SSBs associated with the second waveform.

The number and arrangement of components shown in FIG. 25 are provided as an example. In practice, there may be additional components, fewer components, different components, or differently arranged components than those shown in FIG. 25. Furthermore, two or more components shown in FIG. 25 may be implemented within a single component, or a single component shown in FIG. 25 may be implemented as multiple, distributed components. Additionally, or alternatively, a set of (one or more) components shown in FIG. 25 may perform one or more functions described as being performed by another set of components shown in FIG. 25.

FIG. 26 is a block diagram of an example apparatus 2600 for wireless communication. The apparatus 2600 may be a base station, or a base station may include the apparatus 2600. In some aspects, the apparatus 2600 includes a reception component 2602 and a transmission component 2604, which may be in communication with one another (for example, via one or more buses and/or one or more other components). As shown, the apparatus 2600 may communicate with another apparatus 2606 (such as a UE, a base station, or another wireless communication device) using the reception component 2602 and the transmission component 2604. As further shown, the apparatus 2600 may include the communication manager 150. The communication manager 150 may include a scheduling component 2608, among other examples.

In some aspects, the apparatus 2600 may be configured to perform one or more operations described herein in connection with FIGS. 5-12. Additionally, or alternatively, the apparatus 2600 may be configured to perform one or more processes described herein, such as process 1600 of FIG. 16, process 1700 of FIG. 17, process 1800 of FIG. 18, process 2200 of FIG. 22, process 2300 of FIG. 23, process 2400 of FIG. 24, or a combination thereof. In some aspects, the apparatus 2600 and/or one or more components shown in FIG. 26 may include one or more components of the base station described in connection with FIG. 2. Additionally, or alternatively, one or more components shown in FIG. 26 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2602 may receive communications, such as reference signals, control information, data communications, or a combination thereof, from the apparatus 2606. The reception component 2602 may provide received communications to one or more other components of the apparatus 2600. In some aspects, the reception component 2602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2606. In some aspects, the reception component 2602 may include one or more antennas, a demodulator, a MIMO detector, a receive processor, a controller/processor, a memory, or a combination thereof, of the base station described in connection with FIG. 2.

The transmission component 2604 may transmit communications, such as reference signals, control information, data communications, or a combination thereof, to the apparatus 2606. In some aspects, one or more other components of the apparatus 2606 may generate communications and may provide the generated communications to the transmission component 2604 for transmission to the apparatus 2606. In some aspects, the transmission component 2604 may perform signal processing on the generated communications (such as filtering, amplification, modulation, digital-to-analog conversion, multiplexing, interleaving, mapping, or encoding, among other examples), and may transmit the processed signals to the apparatus 2606. In some aspects, the transmission component 2604 may include one or more antennas, a modulator, a transmit MIMO processor, a transmit processor, a controller/processor, a memory, or a combination thereof, of the base station described in connection with FIG. 2. In some aspects, the transmission component 2604 may be co-located with the reception component 2602 in a transceiver.

The transmission component 2604 may transmit first SSBs associated with a first numerology and second SSBs associated with a second numerology. The transmission component 2604 may transmit information associated with the first SSBs that identifies time domain and frequency domain locations of one or more of the second SSBs.

The transmission component 2604 may transmit information associated with the second SSBs that identifies locations of one or more of the first SSBs.

The transmission component 2604 may transmit an SSB associated with a first numerology. The transmission component 2604 may transmit system information using the first numerology. The reception component 2602 may receive, from a UE, an indication of a second numerology that is a preferred numerology for the UE.

The scheduling component 2608 may schedule, during the RACH procedure, communications subsequent to the random access preamble communication that provides the indication with the second numerology.

The transmission component 2604 may transmit, to the UE, during the RACH procedure and based at least in part on receiving the indication of the second numerology in the Msg3 communication, a Msg4 communication that is scheduled with the second numerology.

The transmission component 2604 may transmit, to the UE, during the RACH procedure and based at least in part on receiving the indication of the second numerology in the MsgA PUSCH communication, a MsgB communication that is scheduled with the second numerology.

The transmission component 2604 may transmit an SSB. The transmission component 2604 may transmit information associated with the SSB that identifies multiple CORESET #0s and/or type 0 search spaces associated with different numerologies. The transmission component 2604 may transmit, in each CORESET #0 and/or type 0 search space of the multiple CORESET #0s and/or type 0 search spaces, a respective type 0 PDCCH communication that schedules transmission of system information based at least in part on a numerology associated with that CORESET #0 and/or type 0 search space.

The transmission component 2604 may transmit first SSBs associated with a first waveform and second SSBs associated with a second waveform. The transmission component 2604 may transmit information associated with the first SSBs that identifies time domain and frequency domain locations of one or more of the second SSBs.

The transmission component 2604 may transmit information associated with the second SSBs that identifies locations of one or more of the first SSBs.

The transmission component 2604 may transmit an SSB associated with a first waveform. The transmission component 2604 may transmit system information using the first waveform. The reception component 2602 may receive, from a UE, an indication of a second waveform that is a preferred waveform for the UE.

The scheduling component 2608 may schedule, during the RACH procedure, communications subsequent to the random access preamble communication that provides the indication with the second waveform.

The transmission component 2604 may transmit, to the UE, during the RACH procedure and based at least in part on receiving the indication of the second waveform in the Msg3 communication, a Msg4 communication that is scheduled with the second waveform.

The transmission component 2604 may transmit, to the UE, during the RACH procedure and based at least in part on receiving the indication of the second waveform in the MsgA PUSCH communication, a MsgB communication that is scheduled with the second waveform.

The transmission component 2604 may transmit an SSB. The transmission component 2604 may transmit information associated with the SSB that identifies multiple CORESET #0s and/or type 0 search spaces associated with different waveforms. The transmission component 2604 may transmit, in each CORESET #0 and/or type 0 search space of the multiple CORESET #0s and/or type 0 search spaces, a respective type 0 PDCCH communication that schedules transmission of system information based at least in part on a waveform associated with that CORESET #0 and/or type 0 search space.

The number and arrangement of components shown in FIG. 26 are provided as an example. In practice, there may be additional components, fewer components, different components, or differently arranged components than those shown in FIG. 26. Furthermore, two or more components shown in FIG. 26 may be implemented within a single component, or a single component shown in FIG. 26 may be implemented as multiple, distributed components. Additionally, or alternatively, a set of (one or more) components shown in FIG. 26 may perform one or more functions described as being performed by another set of components shown in FIG. 26.

The following provides an overview of some Aspects of the present disclosure:

Aspect 1: A method of wireless communication performed by a user equipment (UE), comprising: receiving a synchronization signal block (SSB) associated with a first numerology; and receiving, from a base station and based at least in part on the SSB associated with the first numerology, information identifying time domain and frequency domain locations of one or more SSBs associated with a second numerology.

Aspect 2: The method of Aspect 1, further comprising: performing an initial access procedure using an SSB of the one or more SSBs associated with the second numerology based at least in part on the information identifying the time domain and frequency domain locations of the one or more SSBs associated with the second numerology.

Aspect 3: The method of any of Aspects 1-2, wherein receiving the information identifying the time domain and frequency domain locations of the one or more SSBs associated with the second numerology comprises: receiving the information identifying the time domain and frequency domain locations of the one or more SSBs associated with the second numerology in system information included in a system information block (SIB) transmitted using the first numerology.

Aspect 4: The method of Aspect 3, wherein the system information is at least one of remaining minimum system information (RMSI) or other system information (OSI).

Aspect 5: The method of any of Aspects 1-2, wherein receiving the information identifying the time domain and frequency domain locations of the one or more SSBs associated with the second numerology comprises: receiving, during a random access channel (RACH) procedure initiated based at least in part on the SSB associated with the first numerology, a message that includes the information identifying the time domain and frequency domain locations of the one or more SSBs associated with the second numerology.

Aspect 6: The method of Aspect 5, wherein the message is at least one of a Msg2 communication or a MsgB communication.

Aspect 7: The method of any of Aspects 1-2, wherein receiving the information identifying the time domain and frequency domain locations of the one or more SSBs associated with the second numerology comprises: receiving the information identifying the time domain and frequency domain locations of the one or more SSBs associated with the second numerology in at least one of a radio resource control message transmitted using the first numerology or a medium access control (MAC) control element transmitted using the first numerology.

Aspect 8: The method of any of Aspects 1-7, wherein the information identifies the time domain and frequency domain locations of one or more nearest available SSBs associated with the second numerology.

Aspect 9: The method of any of Aspects 1-8, further comprising: performing rate matching for a physical downlink shared channel (PDSCH) communication associated with the first numerology using a rate matching pattern determined based at least in part on the time domain and frequency domain locations of the one or more SSBs associated with the second numerology.

Aspect 10: A method of wireless communication performed by a user equipment (UE), comprising: receiving a synchronization signal block (SSB) associated with a first numerology; receiving, from a base station and based at least in part on the SSB, system information transmitted using the first numerology; and transmitting, to the base station, an indication of a second numerology that is a preferred numerology for the UE.

Aspect 11: The method of Aspect 10, wherein transmitting the indication of the second numerology comprises: transmitting, during a random access channel (RACH) procedure, a random access preamble communication that provides the indication of the second numerology.

Aspect 12: The method of Aspect 11, wherein the system information configures one or more dedicated RACH occasions associated with respective numerologies and transmitting the random access preamble communication that provides the indication of the second numerology comprises: transmitting the random access preamble communication in a dedicated RACH occasion associated with the second numerology.

Aspect 13: The method of any of Aspects 11-12, wherein the system information configures one or more dedicated random access preambles associated with respective numerologies and transmitting the random access preamble communication that provides the indication of the second numerology comprises: transmitting, in the random access preamble communication, a dedicated random access preamble associated with the second numerology.

Aspect 14: The method of any of Aspects 11-13, wherein communications subsequent to the random access preamble communication during the RACH procedure are scheduled with the second numerology.

Aspect 15: The method of Aspect 10, wherein transmitting the indication of the second numerology comprises: transmitting the indication of the second numerology, during a random access channel (RACH) procedure, in a Msg3 communication that is scheduled with the first numerology.

Aspect 16: The method of Aspect 15, further comprising: receiving, during the RACH procedure and based at least in part on transmitting the indication of the second numerology in the Msg3 communication, a Msg4 communication that is scheduled with the second numerology.

Aspect 17: The method of Aspect 10, wherein transmitting the indication of the second numerology comprises: transmitting the indication of the second numerology, during a random access channel (RACH) procedure, in a MsgA physical uplink shared channel (PUSCH) communication that is scheduled with the first numerology.

Aspect 18: The method of Aspect 17, further comprising: receiving, during the RACH procedure and based at least in part on transmitting the indication of the second numerology in the MsgA PUSCH communication, a MsgB communication that is scheduled with the second numerology.

Aspect 19: The method of Aspect 10, wherein transmitting the indication of the second numerology comprises: transmitting, based at least in part on establishing a radio resource control (RRC) connection with the base station via communications using the first numerology, the indication of the second numerology in at least one of an RRC message or a medium access control (MAC) control element.

Aspect 20: A method of wireless communication performed by a user equipment (UE), comprising: receiving a synchronization signal block (SSB); receiving, from a base station and based at least in part on the SSB, information identifying multiple CORESET #0s and/or type 0 search spaces associated with different numerologies; and receiving, from the base station, a type 0 physical downlink control channel (PDCCH) communication in a selected CORESET #0 and/or type 0 search space from the multiple CORESET #0s and/or type 0 search spaces, wherein the selected CORESET #0 and/or type 0 search space is associated with a selected numerology for the UE.

Aspect 21: The method of Aspect 20, wherein the SSB is associated with a first numerology and the selected CORESET #0 and/or type 0 search space is associated with a second numerology that is different from the first numerology.

Aspect 22: The method of any of Aspects 20-21, wherein receiving the information identifying the multiple CORESET #0s and/or type 0 search spaces comprises: receiving, based at least in part on the SSB, a master information block including the information identifying the multiple CORESET #0s and/or type 0 search spaces associated with the different numerologies.

Aspect 23: The method of any of Aspects 20-22, wherein the information includes information identifying multiple CORESET #0s, associated with an index of the SSB, that are associated with different numerologies.

Aspect 24: The method of Aspect 23, wherein receiving the type 0 PDCCH communication comprises: receiving the type 0 PDCCH communication in a selected CORESET #0 from the multiple CORESET #0s associated with the index of the SSB, wherein the selected CORESET #0 is associated with the selected numerology for the UE.

Aspect 25: The method of any of Aspects 23-24, wherein the multiple CORESET #0s associated with the index of the SSB are time division multiplexed.

Aspect 26: The method of Aspect 25, wherein the information is included in a master information block, and the information includes an indication of a time division multiplexing pattern for the multiple CORESET #0s associated with the index of the SSB.

Aspect 27: The method of any of Aspects 23-24, wherein the multiple CORESET #0s associated with the index of the SSB are frequency division multiplexed.

Aspect 28: The method of Aspect 27, wherein the information is included in a master information block, and the information includes an indication of a frequency division multiplexing pattern for the multiple CORESET #0s associated with the index of the SSB.

Aspect 29: The method of Aspect 20, wherein the information identifies multiple type 0 search spaces for a CORESET #0 associated with an index of the SSB.

Aspect 30: The method of any of Aspects 20-29, further comprising: receiving, from the base station, a system information block (SIB) scheduled by the type 0 PDCCH communication, wherein the SIB includes remaining minimum system information (RMSI) associated with the selected numerology.

Aspect 31: A method of wireless communication performed by a base station, comprising: transmitting first synchronization signal blocks (SSBs) associated with a first numerology and second SSBs associated with a second numerology; and transmitting information associated with the first SSBs that identifies time domain and frequency domain locations of one or more of the second SSBs.

Aspect 32: The method of Aspect 31, further comprising: transmitting information associated with the second SSBs that identifies locations of one or more of the first SSBs.

Aspect 33: The method of any of Aspects 31-32, wherein transmitting the information associated with the first SSBs that identifies the time domain and frequency domain locations of the one or more of the second SSBs comprises: transmitting the information that identifies the time domain and frequency domain locations of the one or more second SSBs in system information included in a system information block (SIB) associated with the first numerology.

Aspect 34: The method of Aspect 33, wherein the system information is at least one of remaining minimum system information (RMSI) or other system information (OSI).

Aspect 35: The method of any of Aspects 31-32, wherein transmitting the information associated with the first SSBs that identifies the time domain and frequency domain locations of the one or more of the second SSBs comprises: transmitting, during a random access channel (RACH) procedure, a message that includes the information that identifies the time domain and frequency domain locations of the one or more second SSBs.

Aspect 36: The method of Aspect 35, wherein the message is at least one of a Msg2 communication or a MsgB communication.

Aspect 37: The method of any of Aspects 31-32, wherein transmitting the information associated with the first SSBs that identifies the time domain and frequency domain locations of the one or more of the second SSBs comprises: transmitting the information that identifies the time domain and frequency domain locations of the one or more second SSBs in at least one of a radio resource control message or a medium access control (MAC) control element.

Aspect 38: The method of any of Aspects 31-37, wherein the information identifies the time domain and frequency domain locations of one or more nearest available second SSBs.

Aspect 39: A method of wireless communication performed by a base station, comprising: transmitting a synchronization signal block (SSB) associated with a first numerology; transmitting system information using the first numerology; and receiving, from a user equipment (UE), an indication of a second numerology that is a preferred numerology for the UE.

Aspect 40: The method of Aspect 39, wherein receiving the indication of the second numerology comprises: receiving, during a random access channel (RACH) procedure, a random access preamble communication that provides the indication of the second numerology.

Aspect 41: The method of Aspect 40, wherein the system information configures one or more dedicated RACH occasions associated with respective numerologies and receiving the random access preamble communication that provides the indication of the second numerology comprises: receiving the random access preamble communication in a dedicated RACH occasion associated with the second numerology.

Aspect 42: The method of any of Aspects 40-41, wherein the system information configures one or more dedicated random access preambles associated with respective numerologies and receiving the random access preamble communication that provides the indication of the second numerology comprises: receiving, in the random access preamble communication, a dedicated random access preamble associated with the second numerology.

Aspect 43: The method of any of Aspects 40-42, further comprising: scheduling, during the RACH procedure, communications subsequent to the random access preamble communication with the second numerology.

Aspect 44: The method of Aspect 39, wherein receiving the indication of the second numerology comprises: receiving the indication of the second numerology, during a random access channel (RACH) procedure, in a Msg3 communication that is scheduled with the first numerology.

Aspect 45: The method of Aspect 44, further comprising: transmitting, to the UE, during the RACH procedure and based at least in part on receiving the indication of the second numerology in the Msg3 communication, a Msg4 communication that is scheduled with the second numerology.

Aspect 46: The method of Aspect 39, wherein receiving the indication of the second numerology comprises: receiving the indication of the second numerology, during a random access channel (RACH) procedure, in a MsgA physical uplink shared channel (PUSCH) communication that is scheduled with the first numerology.

Aspect 47: The method of Aspect 46, further comprising: transmitting, to the UE, during the RACH procedure and based at least in part on receiving the indication of the second numerology in the MsgA PUSCH communication, a MsgB communication that is scheduled with the second numerology.

Aspect 48: The method of Aspect 39, wherein receiving the indication of the second numerology comprises: receiving, based at least in part on establishing a radio resource control (RRC) connection with the UE via communications using the first numerology, the indication of the second numerology in at least one of an RRC message or a medium access control (MAC) control element.

Aspect 49: A method of wireless communication performed by a base station, comprising: transmitting a synchronization signal block (SSB); transmitting information associated with the SSB that identifies multiple CORESET #0s and/or type 0 search spaces associated with different numerologies; and transmitting, in each CORESET #0 and/or type 0 search space of the multiple CORESET #0s and/or type 0 search spaces, a respective type 0 physical downlink control channel (PDCCH) communication that schedules transmission of system information based at least in part on a numerology associated with that CORESET #0 and/or type 0 search space.

Aspect 50: The method of Aspect 49, wherein transmitting the information identifying the multiple CORESET #0s and/or type 0 search spaces comprises: transmitting the information identifying the multiple CORESET #0s and/or type 0 search spaces associated with the different numerologies in a master information block associated with the SSB.

Aspect 51: The method of any of Aspects 49-50, wherein the information includes information identifying multiple CORESET #0s, associated with an index of the SSB, that are associated with different numerologies.

Aspect 52: The method of Aspect 51, wherein the multiple CORESET #0s associated with the index of the SSB are time division multiplexed.

Aspect 53: The method of Aspect 52, wherein the information is included in a master information block, and the information includes an indication of a time division multiplexing pattern for the multiple CORESET #0s associated with the index of the SSB.

Aspect 54: The method of Aspect 51, wherein the multiple CORESET #0s associated with the index of the SSB are frequency division multiplexed.

Aspect 55: The method of Aspect 54, wherein the information is included in a master information block, and the information includes an indication of a frequency division multiplexing pattern for the multiple CORESET #0s associated with the index of the SSB.

Aspect 56: The method of Aspect 49, wherein the information identifies multiple type 0 search spaces for a CORESET #0 associated with an index of the SSB.

Aspect 57: A method of wireless communication performed by a user equipment (UE), comprising: receiving a synchronization signal block (SSB) associated with a first waveform; and receiving, from a base station and based at least in part on the SSB associated with the first waveform, information identifying time domain and frequency domain locations of one or more SSBs associated with a second waveform.

Aspect 58: The method of Aspect 57, further comprising: performing an initial access procedure using an SSB of the one or more SSBs associated with the second waveform based at least in part on the information identifying the time domain and frequency domain locations of the one or more SSBs associated with the second waveform.

Aspect 59: The method of any of Aspects 57-58, wherein receiving the information identifying the time domain and frequency domain locations of the one or more SSBs associated with the second waveform comprises: receiving the information identifying the time domain and frequency domain locations of the one or more SSBs associated with the second waveform in system information included in a system information block (SIB) transmitted using the first waveform.

Aspect 60: The method of Aspect 59, wherein the system information is at least one of remaining minimum system information (RMSI) or other system information (OSI).

Aspect 61: The method of any of Aspects 57-58, wherein receiving the information identifying the time domain and frequency domain locations of the one or more SSBs associated with the second waveform comprises: receiving, during a random access channel (RACH) procedure initiated based at least in part on the SSB associated with the first waveform, a message that includes the information identifying the time domain and frequency domain locations of the one or more SSBs associated with the second waveform.

Aspect 62: The method of Aspect 61, wherein the message is at least one of a Msg2 communication or a MsgB communication.

Aspect 63: The method of any of Aspects 57-58, wherein receiving the information identifying the time domain and frequency domain locations of the one or more SSBs associated with the second waveform comprises: receiving the information identifying the time domain and frequency domain locations of the one or more SSBs associated with the second waveform in at least one of a radio resource control message transmitted using the first waveform or a medium access control (MAC) control element transmitted using the first waveform.

Aspect 64: The method of any of Aspects 57-63, wherein the information identifies the time domain and frequency domain locations of one or more nearest available SSBs associated with the second waveform.

Aspect 65: The method of any of Aspects 57-64, further comprising: performing rate matching for a physical downlink shared channel (PDSCH) communication associated with the first waveform using a rate matching pattern determined based at least in part on the time domain and frequency domain locations of the one or more SSBs associated with the second waveform.

Aspect 66: A method of wireless communication performed by a user equipment (UE), comprising: receiving a synchronization signal block (SSB) associated with a first waveform; receiving, from a base station and based at least in part on the SSB, system information transmitted using the first waveform; and transmitting, to the base station, an indication of a second waveform that is a preferred waveform for the UE.

Aspect 67: The method of Aspect 66, wherein transmitting the indication of the second waveform comprises: transmitting, during a random access channel (RACH) procedure, a random access preamble communication that provides the indication of the second waveform.

Aspect 68: The method of Aspect 67, wherein the system information configures one or more dedicated RACH occasions associated with respective waveforms and transmitting the random access preamble communication that provides the indication of the second waveform comprises: transmitting the random access preamble communication in a dedicated RACH occasion associated with the second waveform.

Aspect 69: The method of any of Aspects 67-68, wherein the system information configures one or more dedicated random access preambles associated with respective waveforms and transmitting the random access preamble communication that provides the indication of the second waveform comprises: transmitting, in the random access preamble communication, a dedicated random access preamble associated with the second waveform.

Aspect 70: The method of any of Aspects 67-69, wherein communications subsequent to the random access preamble communication during the RACH procedure are scheduled with the second waveform.

Aspect 71: The method of Aspect 66, wherein transmitting the indication of the second waveform comprises: transmitting the indication of the second waveform, during a random access channel (RACH) procedure, in a Msg3 communication that is scheduled with the first waveform.

Aspect 72: The method of Aspect 71, further comprising: receiving, during the RACH procedure and based at least in part on transmitting the indication of the second waveform in the Msg3 communication, a Msg4 communication that is scheduled with the second waveform.

Aspect 73: The method of Aspect 66, wherein transmitting the indication of the second waveform comprises: transmitting the indication of the second waveform, during a random access channel (RACH) procedure, in a MsgA physical uplink shared channel (PUSCH) communication that is scheduled with the first waveform.

Aspect 74: The method of Aspect 73, further comprising: receiving, during the RACH procedure and based at least in part on transmitting the indication of the second waveform in the MsgA PUSCH communication, a MsgB communication that is scheduled with the second waveform.

Aspect 75: The method of Aspect 66, wherein transmitting the indication of the second waveform comprises: transmitting, based at least in part on establishing a radio resource control (RRC) connection with the base station via communications using the first waveform, the indication of the second waveform in at least one of an RRC message or a medium access control (MAC) control element.

Aspect 76: A method of wireless communication performed by a user equipment (UE), comprising: receiving a synchronization signal block (SSB); receiving, from a base station and based at least in part on the SSB, information identifying multiple CORESET #0s and/or type 0 search spaces associated with different waveforms; and receiving, from the base station, a type 0 physical downlink control channel (PDCCH) communication in a selected CORESET #0 and/or type 0 search space from the multiple CORESET #0s and/or type 0 search spaces, wherein the selected CORESET #0 and/or type 0 search space is associated with a selected waveform for the UE.

Aspect 77: The method of Aspect 76, wherein the SSB is associated with a first waveform and the selected CORESET #0 and/or type 0 search space is associated with a second waveform that is different from the first waveform.

Aspect 78: The method of any of Aspects 76-77, wherein receiving the information identifying the multiple CORESET #0s and/or type 0 search spaces comprises: receiving, based at least in part on the SSB, a master information block including the information identifying the multiple CORESET #0s and/or type 0 search spaces associated with the different waveforms.

Aspect 79: The method of any of Aspects 76-78, wherein the information includes information identifying multiple CORESET #0s, associated with an index of the SSB, that are associated with different waveforms.

Aspect 80: The method of Aspect 79, wherein receiving the type 0 PDCCH communication comprises: receiving the type 0 PDCCH communication in a selected CORESET #0 from the multiple CORESET #0s associated with the index of the SSB, wherein the selected CORESET #0 is associated with the selected waveform for the UE.

Aspect 81: The method of any of Aspects 79-80, wherein the multiple CORESET #0s associated with the index of the SSB are time division multiplexed.

Aspect 82: The method of Aspect 81, wherein the information is included in a master information block, and the information includes an indication of a time division multiplexing pattern for the multiple CORESET #0s associated with the index of the SSB.

Aspect 83: The method of any of Aspects 79-80, wherein the multiple CORESET #0s associated with the index of the SSB are frequency division multiplexed.

Aspect 84: The method of Aspect 83, wherein the information is included in a master information block, and the information includes an indication of a frequency division multiplexing pattern for the multiple CORESET #0s associated with the index of the SSB.

Aspect 85: The method of Aspect 76, wherein the information identifies multiple type 0 search spaces for a CORESET #0 associated with an index of the SSB.

Aspect 86: The method of any of Aspects 76-85, further comprising: receiving, from the base station, a system information block (SIB) scheduled by the type 0 PDCCH communication, wherein the SIB includes remaining minimum system information (RMSI) associated with the selected waveform.

Aspect 87: A method of wireless communication performed by a base station, comprising: transmitting first synchronization signal blocks (SSBs) associated with a first waveform and second SSBs associated with a second waveform; and transmitting information associated with the first SSBs that identifies time domain and frequency domain locations of one or more of the second SSBs.

Aspect 88: The method of Aspect 87, further comprising: transmitting information associated with the second SSBs that identifies locations of one or more of the first SSBs.

Aspect 89: The method of any of Aspects 87-88, wherein transmitting the information associated with the first SSBs that identifies the time domain and frequency domain locations of the one or more of the second SSBs comprises: transmitting the information that identifies the time domain and frequency domain locations of the one or more second SSBs in system information included in a system information block (SIB) associated with the first waveform.

Aspect 90: The method of Aspect 89, wherein the system information is at least one of remaining minimum system information (RMSI) or other system information (OSI).

Aspect 91: The method of any of Aspects 87-88, wherein transmitting the information associated with the first SSBs that identifies the time domain and frequency domain locations of the one or more of the second SSBs comprises: transmitting, during a random access channel (RACH) procedure, a message that includes the information that identifies the time domain and frequency domain locations of the one or more second SSBs.

Aspect 92: The method of Aspect 91, wherein the message is at least one of a Msg2 communication or a MsgB communication.

Aspect 93: The method of any of Aspects 87-88, wherein transmitting the information associated with the first SSBs that identifies the time domain and frequency domain locations of the one or more of the second SSBs comprises: transmitting the information that identifies the time domain and frequency domain locations of the one or more second SSBs in at least one of a radio resource control message or a medium access control (MAC) control element.

Aspect 94: The method of any of Aspects 87-93, wherein the information identifies the time domain and frequency domain locations of one or more nearest available second SSBs.

Aspect 95: A method of wireless communication performed by a base station, comprising: transmitting a synchronization signal block (SSB) associated with a first waveform; transmitting system information using the first waveform; and receiving, from a user equipment (UE), an indication of a second waveform that is a preferred waveform for the UE.

Aspect 96: The method of Aspect 95, wherein receiving the indication of the second waveform comprises: receiving, during a random access channel (RACH) procedure, a random access preamble communication that provides the indication of the second waveform.

Aspect 97: The method of Aspect 96, wherein the system information configures one or more dedicated RACH occasions associated with respective waveforms and receiving the random access preamble communication that provides the indication of the second waveform comprises: receiving the random access preamble communication in a dedicated RACH occasion associated with the second waveform.

Aspect 98: The method of any of Aspects 96-97, wherein the system information configures one or more dedicated random access preambles associated with respective waveforms and receiving the random access preamble communication that provides the indication of the second waveform comprises: receiving, in the random access preamble communication, a dedicated random access preamble associated with the second waveform.

Aspect 99: The method of any of Aspects 96-98, further comprising: scheduling, during the RACH procedure, communications subsequent to the random access preamble communication with the second waveform.

Aspect 100: The method of Aspect 95, wherein receiving the indication of the second waveform comprises: receiving the indication of the second waveform, during a random access channel (RACH) procedure, in a Msg3 communication that is scheduled with the first waveform.

Aspect 101: The method of Aspect 100, further comprising: transmitting, to the UE, during the RACH procedure and based at least in part on receiving the indication of the second waveform in the Msg3 communication, a Msg4 communication that is scheduled with the second waveform.

Aspect 102: The method of Aspect 95, wherein receiving the indication of the second waveform comprises: receiving the indication of the second waveform, during a random access channel (RACH) procedure, in a MsgA physical uplink shared channel (PUSCH) communication that is scheduled with the first waveform.

Aspect 103: The method of Aspect 102, further comprising: transmitting, to the UE, during the RACH procedure and based at least in part on receiving the indication of the second waveform in the MsgA PUSCH communication, a MsgB communication that is scheduled with the second waveform.

Aspect 104: The method of Aspect 95, wherein receiving the indication of the second waveform comprises: receiving, based at least in part on establishing a radio resource control (RRC) connection with the UE via communications using the first waveform, the indication of the second waveform in at least one of an RRC message or a medium access control (MAC) control element.

Aspect 105: A method of wireless communication performed by a base station, comprising: transmitting a synchronization signal block (SSB); transmitting information associated with the SSB that identifies multiple CORESET #0s and/or type 0 search spaces associated with different waveforms; and transmitting, in each CORESET #0 and/or type 0 search space of the multiple CORESET #0s and/or type 0 search spaces, a respective type 0 physical downlink control channel (PDCCH) communication that schedules transmission of system information based at least in part on a waveform associated with that CORESET #0 and/or type 0 search space.

Aspect 106: The method of Aspect 105, wherein transmitting the information identifying the multiple CORESET #0s and/or type 0 search spaces comprises: transmitting the information identifying the multiple CORESET #0s and/or type 0 search spaces associated with the different numerologies in a master information block associated with the SSB.

Aspect 107: The method of any of Aspects 105-106, wherein the information includes information identifying multiple CORESET #0s, associated with an index of the SSB, that are associated with different numerologies.

Aspect 108: The method of Aspect 107, wherein the multiple CORESET #0s associated with the index of the SSB are time division multiplexed.

Aspect 109: The method of Aspect 108, wherein the information is included in a master information block, and the information includes an indication of a time division multiplexing pattern for the multiple CORESET #0s associated with the index of the SSB.

Aspect 110: The method of Aspect 107, wherein the multiple CORESET #0s associated with the index of the SSB are frequency division multiplexed.

Aspect 111: The method of Aspect 110, wherein the information is included in a master information block, and the information includes an indication of a frequency division multiplexing pattern for the multiple CORESET #0s associated with the index of the SSB.

Aspect 112: The method of Aspect 105, wherein the information identifies multiple type 0 search spaces for a CORESET #0 associated with an index of the SSB.

Aspect 113: An apparatus for wireless communication at a device, comprising a processor; memory coupled with the processor; and instructions stored in the memory and executable by the processor to cause the apparatus to perform the method of one or more of Aspects 1-9.

Aspect 114: An apparatus for wireless communication at a device, comprising a processor; memory coupled with the processor; and instructions stored in the memory and executable by the processor to cause the apparatus to perform the method of one or more of Aspects 10-19.

Aspect 115: An apparatus for wireless communication at a device, comprising a processor; memory coupled with the processor; and instructions stored in the memory and executable by the processor to cause the apparatus to perform the method of one or more of Aspects 20-30.

Aspect 116: An apparatus for wireless communication at a device, comprising a processor; memory coupled with the processor; and instructions stored in the memory and executable by the processor to cause the apparatus to perform the method of one or more of Aspects 31-38.

Aspect 117: An apparatus for wireless communication at a device, comprising a processor; memory coupled with the processor; and instructions stored in the memory and executable by the processor to cause the apparatus to perform the method of one or more of Aspects 39-48.

Aspect 118: An apparatus for wireless communication at a device, comprising a processor; memory coupled with the processor; and instructions stored in the memory and executable by the processor to cause the apparatus to perform the method of one or more of Aspects 49-56.

Aspect 119: An apparatus for wireless communication at a device, comprising a processor; memory coupled with the processor; and instructions stored in the memory and executable by the processor to cause the apparatus to perform the method of one or more of Aspects 57-65.

Aspect 120: An apparatus for wireless communication at a device, comprising a processor; memory coupled with the processor; and instructions stored in the memory and executable by the processor to cause the apparatus to perform the method of one or more of Aspects 66-75.

Aspect 121: An apparatus for wireless communication at a device, comprising a processor; memory coupled with the processor; and instructions stored in the memory and executable by the processor to cause the apparatus to perform the method of one or more of Aspects 76-86.

Aspect 122: An apparatus for wireless communication at a device, comprising a processor; memory coupled with the processor; and instructions stored in the memory and executable by the processor to cause the apparatus to perform the method of one or more of Aspects 87-94.

Aspect 123: An apparatus for wireless communication at a device, comprising a processor; memory coupled with the processor; and instructions stored in the memory and executable by the processor to cause the apparatus to perform the method of one or more of Aspects 95-104.

Aspect 124: An apparatus for wireless communication at a device, comprising a processor; memory coupled with the processor; and instructions stored in the memory and executable by the processor to cause the apparatus to perform the method of one or more of Aspects 105-112.

Aspect 125: A device for wireless communication, comprising a memory and one or more processors coupled to the memory, the one or more processors configured to perform the method of one or more of Aspects 1-9.

Aspect 126: A device for wireless communication, comprising a memory and one or more processors coupled to the memory, the one or more processors configured to perform the method of one or more of Aspects 10-19.

Aspect 127: A device for wireless communication, comprising a memory and one or more processors coupled to the memory, the one or more processors configured to perform the method of one or more of Aspects 20-30.

Aspect 128: A device for wireless communication, comprising a memory and one or more processors coupled to the memory, the one or more processors configured to perform the method of one or more of Aspects 31-38.

Aspect 129: A device for wireless communication, comprising a memory and one or more processors coupled to the memory, the one or more processors configured to perform the method of one or more of Aspects 39-48.

Aspect 130: A device for wireless communication, comprising a memory and one or more processors coupled to the memory, the one or more processors configured to perform the method of one or more of Aspects 49-56.

Aspect 131: A device for wireless communication, comprising a memory and one or more processors coupled to the memory, the one or more processors configured to perform the method of one or more of Aspects 57-65.

Aspect 132: A device for wireless communication, comprising a memory and one or more processors coupled to the memory, the one or more processors configured to perform the method of one or more of Aspects 66-75.

Aspect 133: A device for wireless communication, comprising a memory and one or more processors coupled to the memory, the one or more processors configured to perform the method of one or more of Aspects 76-86.

Aspect 134: A device for wireless communication, comprising a memory and one or more processors coupled to the memory, the one or more processors configured to perform the method of one or more of Aspects 87-94.

Aspect 135: A device for wireless communication, comprising a memory and one or more processors coupled to the memory, the one or more processors configured to perform the method of one or more of Aspects 95-104.

Aspect 136: A device for wireless communication, comprising a memory and one or more processors coupled to the memory, the one or more processors configured to perform the method of one or more of Aspects 105-112.

Aspect 137: An apparatus for wireless communication, comprising at least one means for performing the method of one or more of Aspects 1-9.

Aspect 138: An apparatus for wireless communication, comprising at least one means for performing the method of one or more of Aspects 10-19.

Aspect 139: An apparatus for wireless communication, comprising at least one means for performing the method of one or more of Aspects 20-30.

Aspect 140: An apparatus for wireless communication, comprising at least one means for performing the method of one or more of Aspects 31-38.

Aspect 141: An apparatus for wireless communication, comprising at least one means for performing the method of one or more of Aspects 39-48.

Aspect 142: An apparatus for wireless communication, comprising at least one means for performing the method of one or more of Aspects 49-56.

Aspect 143: An apparatus for wireless communication, comprising at least one means for performing the method of one or more of Aspects 57-65.

Aspect 144: An apparatus for wireless communication, comprising at least one means for performing the method of one or more of Aspects 66-75.

Aspect 145: An apparatus for wireless communication, comprising at least one means for performing the method of one or more of Aspects 76-86.

Aspect 146: An apparatus for wireless communication, comprising at least one means for performing the method of one or more of Aspects 87-94.

Aspect 147: An apparatus for wireless communication, comprising at least one means for performing the method of one or more of Aspects 95-104.

Aspect 148: An apparatus for wireless communication, comprising at least one means for performing the method of one or more of Aspects 105-112.

Aspect 149: A non-transitory computer-readable medium storing code for wireless communication, the code comprising instructions executable by a processor to perform the method of one or more of Aspects 1-9.

Aspect 150: A non-transitory computer-readable medium storing code for wireless communication, the code comprising instructions executable by a processor to perform the method of one or more of Aspects 10-19.

Aspect 151: A non-transitory computer-readable medium storing code for wireless communication, the code comprising instructions executable by a processor to perform the method of one or more of Aspects 20-30.

Aspect 152: A non-transitory computer-readable medium storing code for wireless communication, the code comprising instructions executable by a processor to perform the method of one or more of Aspects 31-38.

Aspect 153: A non-transitory computer-readable medium storing code for wireless communication, the code comprising instructions executable by a processor to perform the method of one or more of Aspects 39-48.

Aspect 154: A non-transitory computer-readable medium storing code for wireless communication, the code comprising instructions executable by a processor to perform the method of one or more of Aspects 49-56.

Aspect 155: A non-transitory computer-readable medium storing code for wireless communication, the code comprising instructions executable by a processor to perform the method of one or more of Aspects 57-65.

Aspect 156: A non-transitory computer-readable medium storing code for wireless communication, the code comprising instructions executable by a processor to perform the method of one or more of Aspects 66-75.

Aspect 157: A non-transitory computer-readable medium storing code for wireless communication, the code comprising instructions executable by a processor to perform the method of one or more of Aspects 76-86.

Aspect 158: A non-transitory computer-readable medium storing code for wireless communication, the code comprising instructions executable by a processor to perform the method of one or more of Aspects 87-94.

Aspect 159: A non-transitory computer-readable medium storing code for wireless communication, the code comprising instructions executable by a processor to perform the method of one or more of Aspects 95-104.

Aspect 160: A non-transitory computer-readable medium storing code for wireless communication, the code comprising instructions executable by a processor to perform the method of one or more of Aspects 105-112.

Aspect 161: A non-transitory computer-readable medium storing a set of instructions for wireless communication, the set of instructions comprising one or more instructions that, when executed by one or more processors of a device, cause the device to perform the method of one or more of Aspects 1-9.

Aspect 162: A non-transitory computer-readable medium storing a set of instructions for wireless communication, the set of instructions comprising one or more instructions that, when executed by one or more processors of a device, cause the device to perform the method of one or more of Aspects 10-19.

Aspect 163: A non-transitory computer-readable medium storing a set of instructions for wireless communication, the set of instructions comprising one or more instructions that, when executed by one or more processors of a device, cause the device to perform the method of one or more of Aspects 20-30.

Aspect 164: A non-transitory computer-readable medium storing a set of instructions for wireless communication, the set of instructions comprising one or more instructions that, when executed by one or more processors of a device, cause the device to perform the method of one or more of Aspects 31-38.

Aspect 165: A non-transitory computer-readable medium storing a set of instructions for wireless communication, the set of instructions comprising one or more instructions that, when executed by one or more processors of a device, cause the device to perform the method of one or more of Aspects 39-48.

Aspect 166: A non-transitory computer-readable medium storing a set of instructions for wireless communication, the set of instructions comprising one or more instructions that, when executed by one or more processors of a device, cause the device to perform the method of one or more of Aspects 49-56.

Aspect 167: A non-transitory computer-readable medium storing a set of instructions for wireless communication, the set of instructions comprising one or more instructions that, when executed by one or more processors of a device, cause the device to perform the method of one or more of Aspects 57-65.

Aspect 168: A non-transitory computer-readable medium storing a set of instructions for wireless communication, the set of instructions comprising one or more instructions that, when executed by one or more processors of a device, cause the device to perform the method of one or more of Aspects 66-75.

Aspect 169: A non-transitory computer-readable medium storing a set of instructions for wireless communication, the set of instructions comprising one or more instructions that, when executed by one or more processors of a device, cause the device to perform the method of one or more of Aspects 76-86.

Aspect 170: A non-transitory computer-readable medium storing a set of instructions for wireless communication, the set of instructions comprising one or more instructions that, when executed by one or more processors of a device, cause the device to perform the method of one or more of Aspects 87-94.

Aspect 171: A non-transitory computer-readable medium storing a set of instructions for wireless communication, the set of instructions comprising one or more instructions that, when executed by one or more processors of a device, cause the device to perform the method of one or more of Aspects 95-104.

Aspect 172: A non-transitory computer-readable medium storing a set of instructions for wireless communication, the set of instructions comprising one or more instructions that, when executed by one or more processors of a device, cause the device to perform the method of one or more of Aspects 104-112.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive a synchronization signal block (SSB) associated with a first numerology; and
receive, from a base station and based at least in part on the SSB associated with the first numerology, information identifying time domain and frequency domain locations of one or more SSBs associated with a second numerology.

2. The UE of claim 1, wherein the one or more processors are further configured to:
perform an initial access procedure using an SSB of the one or more SSBs associated with the second numerology based at least in part on the information identifying the time domain and frequency domain locations of the one or more SSBs associated with the second numerology.

3. The UE of claim 1, wherein the one or more processors, to receive the information identifying the time domain and frequency domain locations of the one or more SSBs associated with the second numerology, are configured to:
receive the information identifying the time domain and frequency domain locations of the one or more SSBs associated with the second numerology in system information included in a system information block (SIB) transmitted using the first numerology.

4. The UE of claim 3, wherein the system information is at least one of remaining minimum system information (RMSI) or other system information (OSI).

5. The UE of claim 1, wherein the one or more processors, to receive the information identifying the time domain and frequency domain locations of the one or more SSBs associated with the second numerology, are configured to:
receive, during a random access channel (RACH) procedure initiated based at least in part on the SSB associated with the first numerology, a message that includes the information identifying the time domain and frequency domain locations of the one or more SSBs associated with the second numerology.

6. The UE of claim 5, wherein the message is at least one of a Msg2 communication or a MsgB communication.

7. The UE of claim 1, wherein the one or more processors, to receive the information identifying the time domain and frequency domain locations of the one or more SSBs associated with the second numerology, are configured to:
receive the information identifying the time domain and frequency domain locations of the one or more SSBs associated with the second numerology in at least one of a radio resource control message transmitted using the first numerology or a medium access control (MAC) control element transmitted using the first numerology.

8. The UE of claim 1, wherein the information identifies the time domain and frequency domain locations of one or more nearest available SSBs associated with the second numerology.

9. The UE of claim 1, wherein the one or more processors are further configured to:
perform rate matching for a physical downlink shared channel (PDSCH) communication associated with the first numerology using a rate matching pattern determined based at least in part on the time domain and frequency domain locations of the one or more SSBs associated with the second numerology.

10. A user equipment (UE) for wireless communication, comprising:
a memory; and
one or more processors, coupled to the memory, configured to:
receive a synchronization signal block (SSB) associated with a first numerology;
receive, from a base station and based at least in part on the SSB, system information transmitted using the first numerology; and
transmit, to the base station, an indication of a second numerology that is a preferred numerology for the UE.

11. The UE of claim 10, wherein the one or more processors, to transmit the indication of the second numerology, are configured to:
transmit, during a random access channel (RACH) procedure, a random access preamble communication that provides the indication of the second numerology.

12. The UE of claim 11, wherein the system information configures one or more dedicated RACH occasions associated with respective numerologies, and wherein the one or more processors, to transmit the random access preamble communication that provides the indication of the second numerology, are configured to:
transmit the random access preamble communication in a dedicated RACH occasion associated with the second numerology.

13. The UE of claim 11, wherein the system information configures one or more dedicated random access preambles associated with respective numerologies, and wherein the one or more processors, to transmit the random access preamble communication that provides the indication of the second numerology, are configured to:
transmit, in the random access preamble communication, a dedicated random access preamble associated with the second numerology.

14. The UE of claim 11, wherein communications subsequent to the random access preamble communication during the RACH procedure are scheduled with the second numerology.

15. The UE of claim 10, wherein the one or more processors, to transmit the indication of the second numerology, are configured to:
transmit the indication of the second numerology, during a random access channel (RACH) procedure, in a Msg3 communication that is scheduled with the first numerology.

16. The UE of claim 15, wherein the one or more processors are further configured to:
receive, during the RACH procedure and based at least in part on transmitting the indication of the second numerology in the Msg3 communication, a Msg4 communication that is scheduled with the second numerology.

17. The UE of claim 10, wherein the one or more processors, to transmit the indication of the second numerology, are configured to:
transmit the indication of the second numerology, during a random access channel (RACH) procedure, in a MsgA physical uplink shared channel (PUSCH) communication that is scheduled with the first numerology.

18. The UE of claim 17, wherein the one or more processors are further configured to:
receive, during the RACH procedure and based at least in part on transmitting the indication of the second numerology in the MsgA PUSCH communication, a MsgB communication that is scheduled with the second numerology.

19. The UE of claim 10, wherein the one or more processors, to transmit the indication of the second numerology, are configured to:
transmit, based at least in part on establishing a radio resource control (RRC) connection with the base station via communications using the first numerology, the indication of the second numerology in at least one of an RRC message or a medium access control (MAC) control element.

20. A method of wireless communication performed by a user equipment (UE), comprising:
receiving a synchronization signal block (SSB) associated with a first numerology; and
receiving, from a base station and based at least in part on the SSB associated with the first numerology, information identifying time domain and frequency domain locations of one or more SSBs associated with a second numerology.

21. The method of claim 20, further comprising:
performing an initial access procedure using an SSB of the one or more SSBs associated with the second numerology based at least in part on the information identifying the time domain and frequency domain locations of the one or more SSBs associated with the second numerology.

22. The method of claim 20, wherein receiving the information identifying the time domain and frequency domain locations of the one or more SSBs associated with the second numerology comprises:
receiving the information identifying the time domain and frequency domain locations of the one or more SSBs associated with the second numerology in system information included in a system information block (SIB) transmitted using the first numerology.

23. The method of claim 20, wherein receiving the information identifying the time domain and frequency domain locations of the one or more SSBs associated with the second numerology comprises:
receiving, during a random access channel (RACH) procedure initiated based at least in part on the SSB associated with the first numerology, a message that includes the information identifying the time domain and frequency domain locations of the one or more SSBs associated with the second numerology.

24. The method of claim 20, wherein receiving the information identifying the time domain and frequency domain locations of the one or more SSBs associated with the second numerology comprises:
receiving the information identifying the time domain and frequency domain locations of the one or more SSBs associated with the second numerology in at least one of a radio resource control message transmitted using the first numerology or a medium access control (MAC) control element transmitted using the first numerology.

25. The method of claim 20, further comprising:
performing rate matching for a physical downlink shared channel (PDSCH) communication associated with the first numerology using a rate matching pattern determined based at least in part on the time domain and frequency domain locations of the one or more SSBs associated with the second numerology.

26. A method of wireless communication performed by a user equipment (UE), comprising:
receiving a synchronization signal block (SSB) associated with a first numerology;
receiving, from a base station and based at least in part on the SSB, system information transmitted using the first numerology; and
transmitting, to the base station, an indication of a second numerology that is a preferred numerology for the UE.

27. The method of claim 26, wherein transmitting the indication of the second numerology comprises:
transmitting, during a random access channel (RACH) procedure, a random access preamble communication that provides the indication of the second numerology.

28. The method of claim 26, wherein transmitting the indication of the second numerology comprises:
transmitting the indication of the second numerology, during a random access channel (RACH) procedure, in a Msg3 communication that is scheduled with the first numerology.

29. The method of claim 26, wherein transmitting the indication of the second numerology comprises:
transmitting the indication of the second numerology, during a random access channel (RACH) procedure, in a MsgA physical uplink shared channel (PUSCH) communication that is scheduled with the first numerology.

30. The method of claim 26, wherein transmitting the indication of the second numerology comprises:
transmitting, based at least in part on establishing a radio resource control (RRC) connection with the base station via communications using the first numerology, the indication of the second numerology in at least one of an RRC message or a medium access control (MAC) control element.
